(19) United States
(12) Patent Application Publication
(10) Pub. No.: US 2024/0001791 A1
(43) Pub. Date: Jan. 4, 2024

(54) POLE BASE CABINET WITH HOUSING FOR ELECTRIC VEHICLE CHARGER

(71) Applicant: IPB Solution, Inc., Reno, NV (US)

(72) Inventors: Nathan Ross Mowery, Costa Mesa, CA (US); Steven Victor Ducros, Yorba Linda, CA (US); Jack Lovley, Lake Forest, CA (US)

(21) Appl. No.: 18/345,222

(22) Filed: Jun. 30, 2023

Related U.S. Application Data
(60) Provisional application No. 63/357,169, filed on Jun. 30, 2022.

(51) Int. Cl. B60L 53/31; H02J 7/00; B60L 53/18

(52) U.S. Cl. CPC B60L 53/31; H02J 7/0042; B60L 53/18

(57) ABSTRACT

This disclosure relates to a housing that can be coupled to a pole base cabinet. The housing can include a first end that can be coupled to the pole base cabinet. The first end can include an opening. The housing can include a second end opposite the first end that is closed. The housing can include a wall extending between the first and the second ends. The wall can include a front face and surround a cavity. The cavity can be accessible by way of the opening. The housing can include a protrusion disposed on the front face. The protrusion can include two angled surfaces for EV chargers.

### INCORPORATION BY REFERENCE TO ANY PRIORITY APPLICATIONS

This application claims the priority benefit of U.S. Provisional Application No. 63/357,169, filed Jun. 30, 2022, which is hereby incorporated by reference in its entirety herein and made a part of this specification. Any and all applications for which a foreign or domestic priority claim is identified in the Application Data Sheet as filed with the present application are hereby incorporated by reference under 37 CFR 1.57.

### FIELD

This disclosure relates to pole bases, specifically to light pole base cabinets that can house items.

### BACKGROUND

Currently, light poles are installed on footings that protrude well above grade. For example, a hole is dug into the ground to a specified depth. A rebar cage is then placed in the hole and electrical conduits routed therethrough. A tube or similar structure is placed around the rebar cage and concrete is poured in. The concrete sets to establish a concrete footing above grade. A pole supporting a light source is mounted to the top of the concrete footing and electrical wiring is routed through the electrical conduits to provide electrical power to the light source. The concrete footing has the limited purpose of providing structural support. As society continues to progress, more adaptability and utility is desirable beyond providing structural support. Accordingly, pole base solutions that address at least some of these challenges are desirable.

### SUMMARY

Neither the preceding summary nor the following detailed description purports to limit or define the scope of protection. The scope of protection is defined by the claims.

As society's needs change, it can be desirable to adapt a lighting pole and/or footing upon which the footing is mounted to include additional features or be adapted for multiple purposes. Currently, the concrete footings upon which light poles are mounted do not offer the capability to accommodate additional features and/or storage for supporting those additional features. The concrete footings cannot readily be adapted because the footing and light pole are structurally designed to meet specific demands or requirements, such as environmental, safety, load-bearing, code, and/or other requirements. In some cases, accessories, such as a camera for surveillance, are included during the installation of a lighting pole and footing. Wiring for said accessories is sometimes routed through any existing electrical conduits or externally, but due to a lack of space, connections, components, and/or supportive technology are externally mounted onto the footing and/or light pole. This configuration, however, can be unaesthetic, an inefficient use of space, fail to provide desirable protection, and/or have other deficiencies.

Various pole base cabinets are disclosed herein that address at least one or more of the problems detailed above or others. The pole base cabinets disclosed herein can be positioned between a pole base and a footing or base, such as a concrete base. The pole base cabinets disclosed herein can include a main opening allowing access to a cavity in which items can be stored. Access to the cavity can be restricted with a door that uncovers and covers the main opening. The pole base cabinets disclosed herein can include support panels, internal stiffening panels, external stiffening panels, support tabs, flanges, tabs, a peripheral wall, and/or other features to provide structural support and/or enclose the contents of the pole base cabinet.

In a configuration, a pole base cabinet for housing items can include a top plate comprising a plurality of apertures. The pole base cabinet can include a bottom plate offset from the top plate, the bottom plate can have a plurality of apertures configured to facilitate the coupling of the cabinet to a footing. The pole base cabinet can have a frame that includes a plurality of support panels extending between and connecting to the top plate and the bottom plate. The plurality of support panels can have a first support panel, a second support panel, and a third support panel. The first support panel can be offset from the second support panel and the third support panel can extend therebetween. The frame can include a plurality of internal stiffening braces extending between the plurality of support panels. The plurality of internal stiffening braces can include a first internal stiffening brace and a second internal stiffening brace. The first internal stiffening brace can extend between the first support panel and the second support panel. The second internal stiffening brace can extend between the first internal stiffening brace and the third support panel. The pole base cabinet can include a peripheral wall extending from a periphery of the top plate to a periphery of the bottom plate. The peripheral wall can have a main opening providing access into a cavity of the cabinet that is configured to house items. The pole base cabinet can include a door configured to releasably couple to the cabinet such that the main opening is covered to temporarily prevent access to the cavity through the main opening.

In a configuration, the pole base cabinet can include external stiffening planks that can extend between the top plate and the bottom plate. The external stiffening panels can extend between the plurality of support panels to the peripheral wall.

In a configuration, the external stiffening planks are positioned perpendicularly relative to the plurality of support panels.

In a configuration, the pole base cabinet can include a first flange connected to the first support panel proximate the main opening and a second flange connected to the second support panel proximate the main opening, wherein the first and second flanges engage the door.

In a configuration, the top plate can include an opening that provides access into the cavity of the cabinet such that wiring can extend into the cavity of the cabinet.

In a configuration, the periphery of the top plate and the periphery of the bottom plate are the same.

In a configuration, the periphery of the top plate and the periphery of the bottom plate are circular.

In a configuration, the pole base cabinet can include a top tab connected to the top plate and a bottom tab connected to the bottom plate, wherein the top and bottom tabs are positioned proximate the peripheral wall and the main opening such that the door interfaces with the top and bottom tabs.

In a configuration, the plurality of internal stiffening braces further can include a third internal stiffening brace and a fourth internal stiffening brace, wherein the third internal stiffening brace extends between the first support panel and the second internal stiffening brace and the fourth internal stiffening brace extends between the second support panel and the second internal stiffening brace.

In a configuration, the plurality of internal stiffening brace can be connected to the top plate and extend to a position between the top plate and the bottom plate.

In a configuration, a pole base cabinet can include a first plate that can have a plurality of apertures configured to facilitate coupling the cabinet to a pole. The pole base cabinet can include a second plate offset from the first plate. The second plate can have a plurality of apertures. The pole base cabinet can have a first support panel, second support panel, and third support panel extending between and connecting to the first plate and the second plate. The first support panel and the second support panel can be offset from each other and the third support panel can extend between proximate an end of the first support panel and proximate an end of the second support panel. The pole base cabinet can include a brace that extends between the first support panel and the second support panel. The brace can be offset from the third support panel. The pole base cabinet can include a peripheral wall extending from a periphery of the top plate to a periphery of the bottom plate. The peripheral wall can include a main opening providing access into a cavity of the cabinet.

In a configuration, the pole base cabinet can include a door configured to releasably couple to the cabinet such that the main opening is covered.

In a configuration, the brace can be connected to the top plate and extend to a position between the top plate and the bottom plate.

In a configuration, the peripheral wall can define a circular periphery of the cabinet.

In a configuration, the first plate can have one or more openings that provide access into the cavity of the cabinet.

In a configuration, the plurality of apertures of the first plate can be distributed around the one or more openings of the first plate.

In a configuration, the second plate can have a plurality of apertures that are configured to facilitate coupling the cabinet to a base.

In a configuration, the second plate can have one or more openings that provide access into the cavity of the cabinet.

In a configuration, the plurality of apertures of the second plate can be distributed around the one or more openings of the second plate.

In a configuration, the peripheral wall can be spaced away from the first support panel, second support panel, third support panel, and brace.

In a configuration, a pole base cabinet can have a top plate. The pole base cabinet can have a bottom plate. The pole base cabinet can have a first support panel and a second support panel. The first support panel and the second support panel can be offset from each other. The pole base cabinet can have a plurality of support tabs that can include a first top support tab, a second top support tab, a first bottom support tab, and a second bottom support tab. The first top support tab can be connected to the top plate and the first support panel. The second top support tab can be connected to the top plate and the second support panel. The first bottom support tab can be connected to the bottom plate and the first support panel. The second bottom support tab can be connected to the bottom plate and the second support panel. The pole base cabinet can include a peripheral wall extending from the top plate to the bottom plate. The peripheral wall can define a main opening providing access into a cavity of the cabinet.

In a configuration, the top plate can have an opening through which wiring can be extended.

In a configuration, the bottom plate can have an opening through which wiring can be extended.

In a configuration, the peripheral wall can extend from a periphery of the top plate to a periphery of the bottom plate.

In a configuration, the cabinet can have a top projection and a bottom projection. The top projection can be connected to the top plate and the bottom projection can be connected to the bottom plate. The top projection and the bottom projection can engage with the peripheral wall and extending into the main opening.

In a configuration, a pole base cabinet can have a top plate. The pole base cabinet can have a bottom plate offset from the top plate. The pole base cabinet can have a peripheral wall extending between the top plate and the bottom plate. The peripheral wall can define a main opening providing access a cavity of the cabinet. The pole base cabinet can have a first support panel, a second support panel, and a third support panel. The first support panel and the second support panel can be offset from each other and the third support panel can be perpendicular to the first and second support panels. The pole base cabinet can have a plurality of top support tabs and a plurality of bottom support tabs. One of the top support tabs and one of the bottom support tabs can be connected to each of the first support panel, the second support panel, and the third support panel. The plurality of top support tabs can be connected to the top plate and the plurality of bottom support tabs can be connected to the bottom plate. The pole base cabinet can have a plurality of planks, wherein one of the plurality of external stiffening panels extends from a side of each of the first support panel, the second support panel, and the third support panel, wherein the side is opposite another side upon which the plurality of top support tabs and bottom support tabs are connected, to the peripheral wall.

In a configuration, the top plate and the bottom plate can have notches configured to receive flanges, wherein the flanges can extend into the main opening.

In a configuration, the cabinet can have a door that couples to the flanges such that access to the cavity through the main opening is impeded.

In a configuration, the cabinet can have a secondary top plate and secondary bottom plate, wherein the secondary top plate can be positioned on the top plate and the secondary bottom plate can be positioned on the bottom plate.

In a configuration, the top plate can have an opening providing access into the cavity.

In a configuration, the bottom plate can have an opening providing access into the cavity.

In a configuration, a pole base cabinet can include a first plate that can have a plurality of apertures configured to facilitate the coupling of the cabinet to a baseplate of a pole. The cabinet can have a second plate offset from the top plate, the bottom plate can have a plurality of apertures configured to facilitate the coupling of the cabinet to a base and an opening through which wires may extend into a cavity of the cabinet. The cabinet can have a peripheral wall that can extend between the first plate and the second plate, the peripheral wall can define a main opening providing access a cavity of the cabinet. The pole base cabinet can have a plurality of top support tabs can be connected to the first plate and a plurality of bottom support tabs that can be connected to the second plate. The plurality of top support tabs can be connected to one of the plurality of bottom support tabs. The plurality of top support tabs and the plurality of bottom support tabs can be radially distributed about the opening of the first plate.

In a configuration, the plurality of top support tabs and the plurality of bottom support tabs can be equally spaced apart from each other and circumferentially distributed about the opening of the first plate.

In a configuration, the plurality of top support tabs can have four top support tabs and the plurality of bottom support tabs can have four bottom support tabs.

In a configuration, the cabinet can have a pair of flanges positioned proximate the main opening, wherein a door is configured to engage with the pair of flanges to cover and uncover the door.

In a configuration, the first plate can have an opening.

In a configuration, a pole base cabinet can have a top plate that includes a plurality of apertures configured to facilitate the coupling of the cabinet to a baseplate of a pole. The cabinet can have a bottom plate offset from the top plate, the bottom plate can have a plurality of apertures configured to facilitate the coupling of the cabinet to a base and an opening through which wires may extend into a cavity of the cabinet. The cabinet can have a wall extending between the top plate and the bottom plate, the wall can define defining a main opening providing access a cavity of the cabinet. The cabinet can have a plurality of structural supports, that can include a first structural support, second structural support, and third structural support, wherein each of the plurality of structural supports can include a center panel, a first wing panel, and a second wing panel, wherein the first wing panel and the second wing panel can extend away from the center panel at an angle. The center panel of the first structural support and the second structural support can be offset form each other, and wherein the center panel of the third structural support can extend between the center panels of the first structural support and the second structural support. The second wing panel of the first structural support can be proximate the first wing panel of the third structural support and the first wing panel of the second structural support can be proximate the second wing panel of the third structural support.

In a configuration, the first wing panel and the second wing panel extend to the wall.

In a configuration, the center panels can have apertures through which wires can be routed.

In a configuration, the wall can extend between the first wing panel of the first structural support to the second wing panel of the second structural support.

In a configuration, the pole base cabinet can have a top plate that can have a plurality of apertures configured to facilitate the coupling of the cabinet to a baseplate of a pole and one or more openings through which wires may be extending into a cavity of the cabinet. The cabinet can have a bottom plate offset from the top plate, the bottom plate can have a plurality of apertures configured to facilitate the coupling of the cabinet to a base. The cabinet can have a wall extending between the top plate and the bottom plate, the peripheral wall can define a main opening providing access a cavity of the cabinet. The cabinet can have a column extending between the bottom plate and the top plate. In a configuration, the column can be a tube.

In a configuration, a pole base cabinet can include a top plate that can have a plurality of apertures configured to facilitate the coupling of the cabinet to a baseplate of a pole and one or more openings through which wires may be extending into a cavity of the cabinet. The cabinet can have a bottom plate offset from the top plate, the bottom plate can include a plurality of apertures configured to facilitate the coupling of the cabinet to a base. The cabinet can have a peripheral wall that can extend between the top plate and the bottom plate, the peripheral wall can have a main opening providing access to a cavity of the cabinet formed by the peripheral wall. The peripheral wall can have a circular periphery. In a configuration, the peripheral wall is made of high-strength steel.

Methods of using the foregoing system(s) (including device(s), apparatus(es), assembly(ies), structure(s) or the like) included; the methods of use can include using or assembling any one or more of the features disclosed herein to achieve functions and/or features of the system(s) as discussed in this disclosure. Methods of manufacturing the foregoing system(s) are included; the methods of manufacture can include providing, making, connecting, assembling, and/or installing any one or more of the features of the system(s) disclosed herein to achieve functions and/or features of the system(s) as discussed in this disclosure. In a configuration, a method of assembling a pole base cabinet to a footing can include coupling a top plate of the cabinet to a baseplate of a pole, wherein the top plate can include a plurality of apertures. The method can include extending wires through one or more openings of the baseplate into a cavity of the cabinet. The method can include coupling a bottom plate offset from the top plate to a footing. The method can include positioning items through a main opening that provides access to the cavity of the cabinet formed by a peripheral wall extending between the top plate and the bottom plate, wherein the peripheral wall can have a circular periphery.

In a configuration, a pole base cabinet can include a first plate. The first plate can have a plurality of apertures that can facilitate coupling the cabinet to a pole. The pole base cabinet can have a second plate offset from the first plate. The second plate can have a plurality of apertures. The pole base cabinet can have a first support panel, second support panel, and third support panel extending between and connecting to the first plate and the second plate. The first support panel and the second support panel can be offset from each other and the third support panel can extend between proximate an end of the first support panel and proximate an end of the second support panel. The pole base cabinet can have a first brace, second brace, and third brace that can extend between and connect to the first support panel and the second support panel. The pole base cabinet can have a peripheral wall extending from a periphery of the first plate to a periphery of the second plate. The peripheral wall can have a main opening providing access into a cavity of the cabinet.

In a configuration, the cabinet can have a door that can selectively inhibit access to the cavity via the main opening.

In a configuration, the cabinet can have a door frame with an opening therethrough. The door frame can be positioned on an inner side of the peripheral wall and around a periphery of the main opening. The cavity of the cabinet can be accessible through the main opening of the peripheral wall and opening of the door frame. The door can be configured to interface with the door frame with the door flush with the peripheral wall.

In a configuration, the cabinet can have a hinge that can to allow the door to rotate open and closed.

In a configuration, the cabinet can have a shim that can be between the door frame and the peripheral wall. The hinge can be between the door frame and the peripheral wall. The hinge and the shim can space the door frame away from the peripheral wall. The door can interface with the door frame with the door flush with the peripheral wall.

In a configuration, the first support panel, second support panel, and third support panel can include an aperture.

In a configuration, the cabinet can have a bracket that is configured to receive a fan. In a configuration, a fan can be retained in the bracket. The fan can direct a flow of air in or through the cavity of the cabinet.

In a configuration, the first brace can extend between and be connected to proximate an end of the first support panel and an end of the second support panel.

In a configuration, the first plate can have one or more openings that provide access into the cavity of the cabinet.

In a configuration, the second plate can have one or more openings that provide access into the cavity of the cabinet.

In a configuration, the first brace, second brace, and third brace can extend from and are connected to the first plate.

In a configuration, the first brace, second brace, and third brace can extend from the first plate to a position between the first plate and second plate.

In a configuration, the second brace can extend between and be connected to a middle portion of each of the first support panel and the second support panel.

In a configuration, each of the first brace, second brace, and third brace can have a rectangular periphery.

In a configuration, the first brace, second brace, and third brace can be the same size.

In a configuration, the first brace, second brace, and third brace can have the same profile.

In a configuration, the first brace, second brace, and third brace can be the same length.

In a configuration, the first brace, second brace, and third brace can be the same height.

In a configuration, the first brace, second brace, and third brace can be the same thickness.

In a configuration, the first brace, second brace, and third brace can be at the same elevation.

In a configuration, the first brace, second brace, and third brace can be connected to the first support panel and second support panel at same elevation.

In a configuration, the first brace, second brace, and third brace can have a height that is less than one-fourth of a length of the first support panel, second support panel, and third support panel.

In a configuration, the first brace, second brace, and third brace have a height that is less than one-fourth of a distance between the top plate and the bottom plate.

In a configuration, the first brace, second brace, and third brace can extend from the top plate to a distance that is less than one-fourth of a distance between the top plate and the bottom plate.

In a configuration, the first brace, second brace, and third brace can have a length that is the same as the width of the third support panel.

In a configuration, the first brace, second brace, and third brace can be parallel to each other.

In a configuration, the first brace, second brace, and third brace can be parallel to the third support panel.

In a configuration, the first brace, second brace, and third brace can be perpendicular to the first support panel and second support panel.

In a configuration, the first brace and third brace can be equidistantly spaced away from the second brace.

In a configuration, the peripheral wall can define a circular periphery of the cabinet.

In a configuration, a pole base cabinet can have a first plate that can have a plurality of apertures that can facilitate coupling the cabinet to a pole and an opening that provides access into a cavity of the cabinet that is configured to house items. The pole base cabinet can have a second plate offset from the first plate. The second plate can have a plurality of apertures and an opening that provides access into the cavity of the cabinet that can house items. The pole base cabinet can have a first support panel, second support panel, and third support panel extending between and connecting to the first plate and the second plate. The first support panel and the second support panel can be offset from each other. The third support panel can extend between proximate an end of the first support panel and proximate an end of the second support panel. Each of the first support panel, second support panel, and third support panel can include an aperture. The pole base cabinet can have a first brace, second brace, and third brace that can extend between and connect to the first support panel and the second support panel. The second brace can be between the first and third braces. The pole base cabinet can have a peripheral wall that extends from a periphery of the first plate to a periphery of the second plate. The peripheral wall can have a main opening providing access into a cavity of the cabinet. The cabinet can have a door that can be coupled to the cabinet via a hinge. The door can rotate to inhibit access to the cavity of the cabinet.

In a configuration, the cabinet can have a bracket configured to receive a fan.

In a configuration, the plurality of apertures of the first plate form a square configuration.

In a configuration, the plurality of apertures of the second plate form a square configuration.

In a configuration, the cabinet can have a door frame with an opening therethrough. The door frame can be positioned on an inner side of the peripheral wall and around a periphery of the main opening. The cavity of the cabinet can be accessible through the main opening of the peripheral wall and opening of the door frame. The door can interface with the door frame with the door flush with the peripheral wall.

In a configuration, the first brace, second brace, and third brace extend from and are connected to the first plate.

In a configuration, the first brace, second brace, and third brace extend from the first plate to a position between the first plate and second plate.

In a configuration, the second brace extends between and is connected to a middle portion of each of the first support panel and the second support panel.

In a configuration, the each of the first brace, second brace, and third brace have a rectangular periphery.

In a configuration, the first brace, second brace, and third brace are the same size.

In a configuration, the first brace, second brace, and third brace have the same profile.

In a configuration, the first brace, second brace, and third brace are the same length.

In a configuration, the first brace, second brace, and third brace are the same height.

In a configuration, the first brace, second brace, and third brace are the same thickness.

In a configuration, the first brace, second brace, and third brace are at the same elevation.

In a configuration, the first brace, second brace, and third brace are connected to the first support panel and second support panel at same elevation.

In a configuration, the first brace, second brace, and third brace have a height that is less than one-fourth of a length of the first support panel, second support panel, and third support panel.

In a configuration, the first brace, second brace, and third brace have a height that is less than one-fourth of a distance between the top plate and the bottom plate.

In a configuration, first brace, second brace, and third brace extend from the top plate to a distance that is less than one-fourth of a distance between the top plate and the bottom plate.

In a configuration, the first brace, second brace, and third brace have a length that is the same as the width of the third support panel.

In a configuration, the first brace, second brace, and third brace are parallel to each other.

In a configuration, the first brace, second brace, and third brace are parallel to the third support panel.

In a configuration, the first brace, second brace, and third brace are perpendicular to the first support panel and second support panel.

In a configuration, the first brace and third brace are equidistantly spaced away from the second brace.

In a configuration, a method of assembling a pole base cabinet can include connecting a first support panel, second support panel, and third support panel to a top plate and bottom plate with the first and second support panels offset from each other and the third support panel perpendicularly extending between the first and second support panels. The method can include connecting a first brace to the first and second support panels proximate edges of the first and second support panels opposite the third support panel. The method can include connecting a second brace to mid-portions of the first and second support panels. The method can include connecting a third brace to the first and second support panels with the third brace positioned between and offset from the second brace and third support panel. The method can include attaching a peripheral wall to the top and bottom plates with the peripheral wall extending from a periphery of the top plate to a periphery of the bottom plate and defining a main opening that provides access into a cavity defined between the top plate, bottom plate, first support panel, second support panel, and third support panel, wherein the cavity is configured to house items.

In a configuration, the method can include coupling a door to the pole base cabinet with a hinge that is configured to allow the door to rotate to cover and uncover the main opening.

In a configuration, the method can include attaching a gasket around a periphery of the main opening. The gasket can engage with the door in a sealed interface.

In a configuration, the method can include forming an aperture in each of the first support panel, second support panel, and third support panel.

In a configuration, the method can include forming an opening in the top plate that can receive one or more wires therethrough.

In a configuration, the method can include forming an opening in the bottom plate that can receive one or more wires therethrough.

In a configuration, the method can include arranging the first brace, second brace, and third brace in parallel.

In a configuration, the method can include connecting the first brace, second brace, and third brace to the top plate.

In a configuration, the method can include positioning the first brace a distance from the second brace and positioning the third brace the same distance from the second brace.

In a configuration, the method can include positioning the first brace, second brace, and third brace perpendicular relative to the first support panel and second support panel.

In a configuration, the method can include attaching a bracket to the peripheral wall that can receive a fluid moving device that can move air within the cavity.

In a configuration, the method can include forming the first brace, second brace, and third brace to have a width that is less than one-fourth of a length of the first support panel, second support panel, and third support panel.

In a configuration, the method can include attaching the first brace, second brace, and third brace to the top plate with the first brace, second brace, and third brace extending in a direction of the bottom plate to a distance that is less than one-fourth of a length of the first support panel, second support panel, and third support panel.

In a configuration, the cabinet can include a first internal brace, second internal brace, third internal brace, fourth internal brace, fifth internal brace, and sixth internal brace. The first and second internal braces can extend between and be connected to the first brace and the second brace. The third and fourth internal braces can extend between and be connected to the second brace and the third brace. The fifth and sixth internal braces can extend between and be connected to the third brace and the third support panel.

In a configuration, the first internal brace, second internal brace, third internal brace, fourth internal brace, fifth internal brace, and sixth internal brace can be perpendicular to the third support panel and parallel to the first and second support panels.

In a configuration, the first internal brace, second internal brace, third internal brace, fourth internal brace, fifth internal brace, and sixth internal brace can be perpendicular to the first, second, and third braces.

In a configuration, the first internal brace, third internal brace, and fifth internal brace can be coplanar.

In a configuration, the second internal brace, fourth internal brace, and sixth internal can be coplanar.

In a configuration, the first internal brace and second internal brace can be parallel to and offset from each other.

In a configuration, the third internal brace and fourth internal brace can be parallel to and offset from each other.

In a configuration, the fifth internal brace and sixth internal brace can be parallel to and offset from each other.

In a configuration, the first internal brace, second internal brace, third internal brace, fourth internal brace, fifth internal brace, and sixth internal brace can extend from the first plate to a position between the first plate and the second plate.

In a configuration, the method can further include connecting a first internal brace and a second internal brace between the first brace and the second brace, connecting a third internal brace and a fourth internal brace between the second brace and the third brace, and connecting a fifth internal brace and a sixth internal brace between the third brace and the third support panel.

In some variants, an electric vehicle (EV) charging station is disclosed herein. The EV charging station can include a pole base cabinet having a cavity and a power connection disposed within the cavity. The EV charging station can include a housing that can include an interior cavity, a first end that can be coupled to the pole base cabinet, and a second end. The first end can include an opening providing access into the interior cavity. The EV charging station can include an electric vehicle (EV) charger. The EV charger can be mounted to the housing. The EV charging station can include one or more cables routed from the power connection within the cavity of the pole base cabinet, through the opening in the first end of the housing and into the interior cavity therein, and to the EV charger to supply power.

In some variants, the housing can be elongate.

In some variants, the housing can include opposing front and back surfaces that are parallel to each other and rounded sides extend between the front and back surfaces.

In some variants, the second end can be rounded.

In some variants, the housing can include one or more vertical supports therein.

In some variants, the housing can be coupled to the pole base cabinet by way of bolts or screws inserted from within the cavity and through a top surface of the pole base cabinet and first end.

In some variants, the housing can include a front face having two angled surfaces. The EV charger can be mounted on one of the two angled surfaces and another EV charger can be mounted on the other of the two angled surfaces.

In some variants, the housing can include a protrusion extending from the front face. The protrusion can have two angled surfaces. The EV charger can be mounted on one of the two angled surfaces and another EV charger can be mounted on the other of the two angled surfaces.

In some variants, the housing can include a mounting bracket that can facilitate coupling to the pole base cabinet. The mounting bracket can include an opening therethrough and two opposing vertical plates. The housing can be disposed over the opposing vertical plates and secured thereto. The one or more cables can be routed through the opening of the mounting bracket.

In some variants, a housing for an electric vehicle (EV) charging station is disclosed herein. The housing can include a first end that can be coupled to a pole base cabinet. The first end can include an opening that can receive one or more cables therethrough. The housing can include a second end that is closed. The housing can include a wall enclosing a cavity. The cavity can be accessible by way of the opening. The housing can include one or more vertical supports disposed in the cavity. The housing can include a mounting area whereon an EV charger can be mounted.

In some variants, the housing can include a front surface having a first angled surface and a second angled surface. The mounting area can be disposed on the first angled surface and another mounting area for a second EV charger that can disposed on the second angled surface.

In some variants, the housing can include a front surface a and a protrusion extending away from the front surface. The protrusion can include a first angled surface and a second angled surface, The mounting area can be disposed on the first angled surface and another mounting area for a second EV charger can be disposed on the second angled surface.

In some variants, the housing can be elongate.

In some variants, the housing can include opposing front and back surfaces that are parallel to each other and rounded sides extend between the front and back surfaces.

In some variants, the second end can be rounded.

In some variants, a housing for an electric vehicle (EV) charging station is disclosed herein. The housing can include a bracket that can be coupled to a pole base cabinet. The bracket can include a hole therethrough and two opposing vertical plates. The housing can include a mounting housing that can have a cavity and a region for mounting an EV charger. The mounting housing can be disposed over the opposing vertical plates such that the opposing vertical plates are positioned in the cavity and coupled thereto. The hole can receive one or more cables therethrough to be routed into the cavity and to the EV charger.

In some variants, the housing can be elongate.

In some variants, the housing can include a rectangular periphery.

In some aspects, the techniques described herein relate to a pole base cabinet system, the system including: a pole base cabinet having a cavity and a power connection disposed within the cavity; a housing including an interior cavity, a first end configured to be coupled to the pole base cabinet, and a second end, the first end including an opening providing access into the interior cavity; an electric vehicle (EV) charger, the EV charger configured to be mounted to the housing; and one or more cables routed from the power connection within the cavity of the pole base cabinet, through the opening in the first end of the housing and into the interior cavity therein, and to the EV charger to supply power.

In some aspects, the techniques described herein relate to a system, wherein the housing is elongate.

In some aspects, the techniques described herein relate to a system, wherein the housing includes opposing front and back surfaces that are parallel to each other and rounded sides extending between the front and back surfaces.

In some aspects, the techniques described herein relate to a system, wherein the second end is rounded.

In some aspects, the techniques described herein relate to a system, wherein the housing includes one or more vertical supports therein.

In some aspects, the techniques described herein relate to a system, wherein the housing is coupled to the pole base cabinet by way of bolts or screws inserted from within the cavity and through a top surface of the pole base cabinet and the first end.

In some aspects, the techniques described herein relate to a system, wherein the housing includes a front face having two angled surfaces, and wherein the EV charger is mounted on one of the two angled surfaces and another EV charger is mounted on the other of the two angled surfaces.

In some aspects, the techniques described herein relate to a system, wherein the housing includes a protrusion extending from a front face, the protrusion having two angled surfaces, and wherein the EV charger is mounted on one of the two angled surfaces and another EV charger is mounted on the other of the two angled surfaces.

In some aspects, the techniques described herein relate to a system, wherein the housing includes a mounting bracket that is configured to facilitate coupling to the pole base cabinet, the mounting bracket including an opening therethrough and two opposing vertical plates, wherein the housing is configured to be disposed over the opposing vertical plates and secured thereto, and wherein the one or more cables are configured to be routed through the opening of the mounting bracket.

In some aspects, the techniques described herein relate to a housing configured to be coupled to a pole base cabinet, the housing including: a first end configured to be coupled to a pole base cabinet, the first end including an opening configured to receive one or more cables therethrough; a second end that is closed; a wall enclosing a cavity, the cavity being accessible by way of the opening; one or more vertical supports disposed in the cavity; and a mounting area whereon an EV charger is configured to be mounted.

In some aspects, the techniques described herein relate to a housing, further including a front surface having a first angled surface and a second angled surface, wherein the mounting area is disposed on the first angled surface and another mounting area for a second EV charger is disposed on the second angled surface.

In some aspects, the techniques described herein relate to a housing, further including a front surface and a protrusion extending away from the front surface, the protrusion having a first angled surface and a second angled surface, wherein the mounting area is disposed on the first angled surface and another mounting area for a second EV charger is disposed on the second angled surface.

In some aspects, the techniques described herein relate to a housing, wherein a top surface of the protrusion is angled downward to facilitate water runoff.

In some aspects, the techniques described herein relate to a housing, wherein the housing is elongate.

In some aspects, the techniques described herein relate to a housing, wherein the housing includes opposing front and back surfaces that are parallel to each other and rounded sides extend between the front and back surfaces.

In some aspects, the techniques described herein relate to a housing, wherein the second end is rounded.

In some aspects, the techniques described herein relate to a housing configured to be coupled to a pole base cabinet, the housing including: a first end configured to be coupled to a pole base cabinet, the first end including an opening; a second end opposite the first end that is closed; a wall including a front face and surrounding a cavity, the cavity being accessible by way of the opening; and a protrusion disposed on the front face, the protrusion including two angled surfaces for EV chargers.

In some aspects, the techniques described herein relate to a housing, wherein the protrusion includes a top surface that is sloped downward.

In some aspects, the techniques described herein relate to a housing, wherein the protrusion includes a bottom surface that is positioned higher than the first end.

In some aspects, the techniques described herein relate to a housing, wherein the second end is rounded.

In some aspects, the techniques described herein relate to a housing for an electric vehicle (EV) charging station, the housing including: a bracket configured to be coupled to a pole base cabinet, the bracket including a hole therethrough and two opposing vertical plates; and a mounting housing having a cavity and a region for mounting an EV charger, the mounting housing configured to be disposed over the opposing vertical plates such that the opposing vertical plates are positioned in the cavity and coupled thereto; wherein the hole is configured to receive one or more cables therethrough to be routed into the cavity and to the EV charger.

In some aspects, the techniques described herein relate to a EV charging station, wherein mounting housing is elongate.

In some aspects, the techniques described herein relate to a EV charging station, wherein mounting housing includes a rectangular periphery.

In some aspects, the techniques described herein relate to a housing for an electric vehicle (EV) charging station, the housing including: a plurality of panels enclosing a cavity configured to house one or more items therein, the plurality of panels including a bottom panel configured to couple to a base cabinet and a first front panel configured to cover an opening providing access into the cavity.

In some aspects, the techniques described herein relate to a housing, wherein the housing is an elongate structure with curved longitudinal sides and a curved top side.

In some aspects, the techniques described herein relate to a housing, wherein the housing is a rectangular prism with rounded longitudinal sides and a rounded top side.

In some aspects, the techniques described herein relate to a housing, wherein the plurality of panels includes a second front panel including the opening, a frame, a first side panel forming a first longitudinal side of the housing, a second side panel forming a second longitudinal side of the housing, a top panel forming a top side of the housing, and a back panel parallel the first front panel, second front panel, and the frame,

In some aspects, the techniques described herein relate to a housing, wherein the first side panel, second side panel, and top panel include curved cross sections.

In some aspects, the techniques described herein relate to a housing, wherein the frame is configured to be attached to a periphery of the second front panel surrounding the opening and extend into the opening.

In some aspects, the techniques described herein relate to a housing, wherein the first front panel is configured to be disposed inside the opening of the second front panel to be coupled to the frame, covering the opening.

In some aspects, the techniques described herein relate to a housing, wherein the second front panel, first side panel, second side panel, top panel, and back panel are configured to be welded together.

In some aspects, the techniques described herein relate to a housing, wherein the first side panel, second side panel, and top panel include notches around peripheries thereof that are configured to receive tabs disposed around the peripheries of the second front panel and the back panel for proper orientation.

In some aspects, the techniques described herein relate to a housing, wherein the first side panel, second side panel, and top panel include tabs around peripheries thereof that are configured to receive notches disposed around the peripheries of the second front panel and the back panel for proper orientation.

In some aspects, the techniques described herein relate to a housing, wherein the first side panel, second side panel, and top panel include notches and/or tabs disposed around peripheries thereof that are configured to interface with notches and/or tabs disposed around the peripheries of the second front panel and the back panel for proper orientation.

In some aspects, the techniques described herein relate to a housing, wherein the bottom panel includes one or more slots configured to facilitate one or more bolts be inserted therethrough to couple the bottom panel to the top of the base cabinet.

In some aspects, the techniques described herein relate to a housing, wherein the bottom panel includes one or more openings configured to facilitate the routing of cables and/or wires therethrough.

In some aspects, the techniques described herein relate to a housing, wherein the bottom panel includes one or more openings configured to receive one or more beams therethrough to support the housing.

In some aspects, the techniques described herein relate to a housing, wherein the bottom panel includes rounded ends.

In some aspects, the techniques described herein relate to a housing, wherein the housing is configured to extend vertically from a top surface of the base cabinet.

In some aspects, the techniques described herein relate to a housing, further including an electric vehicle charger mounted on a front face of the housing.

In some aspects, the techniques described herein relate to a method of forming a housing for an electric vehicle charger, the method including: welding a first side panel, a second side panel, and a top panel to a periphery of a second front panel including an opening therethrough and a back panel offset and parallel from the second front panel, wherein the first side panel, second side panel, top panel, second front panel, and back panel cooperate to define an internal cavity; and welding a bottom panel to bottom peripheries of the first side panel, second side panel, second front panel, and back panel.

In some aspects, the techniques described herein relate to a method, further including attaching a frame to the second front panel such that the frame extends into the opening.

In some aspects, the techniques described herein relate to a method, further including coupling a first front panel to the frame.

In some aspects, the techniques described herein relate to a method, wherein the top panel, first side panel, and second side panel include a curved cross-section.

In some aspects, the techniques described herein relate to a method, further including inserting tabs of the second front panel and tabs of the back panel into corresponding notches found in the peripheries of the first side panel, second side panel, and top panel to properly orient the second front panel, back panel, first side panel, second side panel, and top panel.

In some aspects, the techniques described herein relate to a method, further including interfacing tabs and/or notches of the second front panel and back panel with corresponding tabs and/or notches found in the peripheries of the first side panel, second side panel, and top panel to properly orient the second front panel, back panel, first side panel, second side panel, and top panel.

In some aspects, the techniques described herein relate to a base cabinet including: a top plate; a bottom plate offset from the top plate; a plurality of support panels directly connected to and extending between the top plate and the bottom plate; a brace directly connected to and extending between at least two of the plurality of support panels; and a cavity disposed between the top plate, bottom plate, and the plurality of support panels, the cavity configured to house one or more items therein.

In some aspects, the techniques described herein relate to a base cabinet, wherein the plurality of support panels includes a first support panel and a second support panel, wherein the first support panel and the second support panel are offset and parallel relative to each other.

In some aspects, the techniques described herein relate to a base cabinet, wherein the plurality of support panels further includes a third support panel, wherein the third support panel is directly connected to and extends between the first support panel and the second support panel.

In some aspects, the techniques described herein relate to a base cabinet, wherein the third support panel is directly connected to and extends between inward facing surfaces of the first support panel and the second support panel.

In some aspects, the techniques described herein relate to a base cabinet, wherein the brace is directly connected to and extends between the first support panel and the second support panel.

In some aspects, the techniques described herein relate to a base cabinet, wherein the brace is offset from and parallel to the third support panel.

In some aspects, the techniques described herein relate to a base cabinet, wherein the plurality of support panels include openings therethrough.

In some aspects, the techniques described herein relate to a base cabinet, wherein the top plate includes an opening through which wires can be routed therethrough and/or the bottom plate includes an opening through which wires can be routed therethrough.

In some aspects, the techniques described herein relate to a base cabinet, wherein the brace extends away from the top plate a distance that is less than one-fourth of a distance between the top plate and the bottom plate.

In some aspects, the techniques described herein relate to a base cabinet, wherein the plurality of support panels include one or more protrusions extending from an edge of one or more plurality of support panels, the top plate or the bottom plate includes slots, wherein the one or more protrusions are configured to be placed in the one or more slots to orient the plurality of support panels, top plate, and bottom plate

In some aspects, the techniques described herein relate to a base cabinet, wherein the plurality of support panels include top protrusions extending from a top edge of the plurality of support panels and bottom protrusions extending from a bottom edge of the plurality of support panels, the top plate includes top slots, and the bottom plate includes bottom slots, wherein the top protrusions are configured to be placed in the top slots and the bottom protrusions are configured to be placed in the bottom slots to orient the plurality of support panels, top plate, and bottom plate.

In some aspects, the techniques described herein relate to a base cabinet, wherein the brace includes top protrusions extending from a top edge that are configured to be placed in the top slots to orient the brace, plurality of panels, and top plate relative to each other.

In some aspects, the techniques described herein relate to a base cabinet, further including a peripheral wall.

In some aspects, the techniques described herein relate to a base cabinet, wherein the peripheral wall defines a circular periphery of the base cabinet.

In some aspects, the techniques described herein relate to a base cabinet, wherein the peripheral wall includes a main opening providing access into the cavity.

In some aspects, the techniques described herein relate to a base cabinet, further including a door, the door configured to be disposed over the main opening to impede access into the cavity.

In some aspects, the techniques described herein relate to a base cabinet, further including a lock configured to lock the door covering the main opening.

In some aspects, the techniques described herein relate to a base cabinet, further including a seal configured to extend about the main opening to contact the door.

In some aspects, the techniques described herein relate to a base cabinet, further including a frame configured to be coupled to the seal and surround the main opening.

In some aspects, the techniques described herein relate to a base cabinet, wherein the brace is connected to the top plate.

In some aspects, the techniques described herein relate to a base cabinet, further including a second brace connected to and extending between the at least two panels of the plurality of support panels, a third brace connected to and extending between the brace and the second brace, and a fourth brace connected to and extending between the at least two panels of the plurality of support panels, wherein the brace, second brace, third brace, and fourth brace are connected to the top plate.

In some aspects, the techniques described herein relate to a base cabinet, further including a first bottom brace connected to and extending between the at least two panels of the plurality of panels and a second bottom brace connected to and extending between the at least two panels of the plurality of panels, the first bottom brace and the second bottom brace connected to the bottom plate and offset from and parallel to each other.

In some aspects, the techniques described herein relate to a method of forming a base cabinet, the method including: inserting protrusions on top edges of a first support panel, a second support panel, and a third support panel into slots disposed in a top plate; inserting one or more protrusions on a brace into one or more slots disposed in the top plate; inserting protrusions on bottom edges of a first support panel, a second support panel, and a third support panel into slots disposed in a bottom plate; welding the top edges of the first support panel, second support panel, third support, and brace to the top plate; and welding the bottom edges of the first support panel, second support panel, third support, and brace to the bottom plate.

In some aspects, the techniques described herein relate to a method, further including welding ends of the brace to the inward facing surfaces of the first support panel and the second support panel.

In some aspects, the techniques described herein relate to a method, further including welding ends of the third support panel to the inward facing surfaces of the first support panel and the second support panel.

In some aspects, the techniques described herein relate to a method, further including welding a peripheral wall to a periphery of the top plate and a periphery of the bottom plate.

In some aspects, the techniques described herein relate to a method of forming a base cabinet, the method including: inserting one or more protrusions on edges of at least one of a plurality of support panels into one or more slots disposed in a top plate or a bottom plate.

In some aspects, the techniques described herein relate to a method, further including inserting one or more protrusions on a brace into one or more slots disposed in the top plate

In some aspects, the techniques described herein relate to a method, further including inserting one or more protrusions on a plurality of braces into one or more slots disposed in the top plate.

In some aspects, the techniques described herein relate to a method, further including placing a notch of one of the plurality of braces into a notch of another one of the plurality of braces to cross.

In some aspects, the techniques described herein relate to the method of any of Claims 68-61, further including inserting one or more protrusions on a plurality of braces into one or more slots disposed in the bottom plate.

In some aspects, the techniques described herein relate to a method, wherein inserting the one or more protrusions includes inserting the one or more protrusions on top edges of the at least one of the plurality of support panels into one or more slots disposed in the top plate.

In some aspects, the techniques described herein relate to a method, further including inserting the one or more protrusions on bottom edges of the at least one of the plurality of support panels into one or more slots disposed in the bottom plate.

In some aspects, the techniques described herein relate to a method, wherein the plurality of support panels includes a first support panel, a second support panel, and a third support panel.

In some aspects, the techniques described herein relate to a base cabinet including: a top plate; a bottom plate offset from the top plate; and a plurality of support panels directly connected to and extending between the top plate and the bottom plate, wherein the plurality of panels include one or more protrusions extending from an edge of one or more plurality of panels, the top plate or the bottom plate includes slots, wherein the one or more protrusions are configured to be placed in the one or more slots to orient the plurality of panels, top plate, and bottom plate.

In some aspects, the techniques described herein relate to a base cabinet, wherein the plurality of support panels include top protrusions extending from a top edge of the plurality of support panels and bottom protrusions extending from a bottom edge of the plurality of support panels, the top plate includes top slots, and the bottom plate includes bottom slots, wherein the top protrusions are configured to be placed in the top slots and the bottom protrusions are configured to be placed in the bottom slots to orient the plurality of support panels, top plate, and bottom plate.

In some aspects, the techniques described herein relate to a base cabinet, further including a brace connected to and extending between at least two of the plurality of support panels, the brace including top protrusions extending from a top edge that are configured to be placed in the top slots to orient the brace, plurality of panels, and top plate relative to each other.

In some aspects, the techniques described herein relate to a base cabinet, wherein the plurality of support panels includes a first support panel and a second support panel, wherein the first support panel and the second support panel are offset from and parallel to each other.

In some aspects, the techniques described herein relate to a base cabinet, further including a first top brace, a second top brace, a third top brace, and a fourth top brace, the first top brace connected to and extending between at least two panels of the plurality of support panels, the second top brace connected to and extending between the at least two panels of the plurality of support panels, a third top brace connected to and extending between the first top brace and the second top brace, and a fourth top brace connected to and extending between the at least two panels of the plurality of support panels, wherein the first top brace, second top brace, third top brace, and fourth top brace include top protrusions extending from a top edge that are configured to be placed in the top slots to orient the first top brace, second top brace, third top brace, and fourth top brace, plurality of panels, and top plate relative to each other.

In some aspects, the techniques described herein relate to a base cabinet, wherein the third top brace includes a notch along a top edge thereof and the fourth top brace includes a notch along a bottom edge thereof, wherein the notch of the third top brace is disposed in the notch of the fourth top brace such that the third top brace and the fourth top brace cross over each other.

In some aspects, the techniques described herein relate to a base cabinet, further including a first bottom brace and a second bottom brace, the first top brace connected to and extending between at least two panels of the plurality of support panels, the second top brace connected to and extending between the at least two panels of the plurality of support panels, the first bottom brace and the second bottom brace including bottom protrusions extending from bottom edges that are configured to be placed in bottom slots of the bottom plate to orient the first bottom brace, second bottom brace, plurality of panels, and bottom plate relative to each other.

### BRIEF DESCRIPTION OF THE DRAWINGS

The abovementioned and other features of the embodiments disclosed herein are described below with reference to the drawings of the embodiments. The illustrated embodiments are intended to illustrate, but not to limit, the scope of protection. Various features of the different disclosed embodiments can be combined to form further embodiments, which are part of this disclosure. In the drawings, similar elements may have reference numerals with the same last two digits.

FIG. 1 schematically illustrates an example light pole mounted on a pole base cabinet.

FIG. 2 schematically illustrates a perspective view of an example pole base cabinet with the door removed.

FIG. 3 schematically illustrates a front view of the example pole base cabinet of FIG. 2 with the door coupled to the pole base cabinet.

FIG. 4 schematically illustrates a perspective view of the example pole base cabinet of FIG. 2 with the peripheral wall removed.

FIG. 5 schematically illustrates a front view of the example pole base cabinet of FIG. 2.

FIG. 6 schematically illustrates a section view of the example pole base cabinet of FIG. 2.

FIG. 7 schematically illustrates a top view of the top plate of the example pole base cabinet of FIG. 2.

FIG. 8 schematically illustrates a section view of the example pole base cabinet of FIG. 2.

FIG. 9 schematically illustrates a top view of the bottom plate of the example pole base cabinet of FIG. 2.

FIG. 10 schematically illustrates a disassembled view of the example pole base cabinet of FIG. 2.

FIG. 11 schematically illustrates an example pole base cabinet positioned between a footing and pole.

FIG. 12 schematically illustrates the example pole base cabinet of FIG. 11.

FIG. 13 schematically illustrates a section view of the example pole base cabinet of FIG. 11.

FIG. 14 schematically illustrates an enlarged view of the top plate of the example pole base cabinet of FIG. 11 coupled to a pole base plate.

FIG. 15 schematically illustrates a section view of the example pole base cabinet of FIG. 11.

FIG. 16 schematically illustrates an enlarged view of the example pole base cabinet of FIG. 11 coupled to the footing.

FIG. 17 schematically illustrates an enlarged view of the bottom plate of the example pole base cabinet of FIG. 11 coupled to the footing.

FIG. 18 schematically illustrates a perspective view of an example pole base cabinet with the door removed.

FIG. 19 schematically illustrates a front view of the example pole base cabinet of FIG. 18 with the door coupled to the pole base cabinet.

FIG. 20 schematically illustrates a perspective view of the example pole base cabinet of FIG. 18 with the peripheral wall removed.

FIG. 21 schematically illustrates a front view of the example pole base cabinet of FIG. 18 with the peripheral wall removed.

FIG. 22 schematically illustrates a top view of the example pole base cabinet of FIG. 18.

FIG. 23 schematically illustrates a perspective view of an example pole base cabinet.

FIG. 24 schematically illustrates a top view of the example pole base cabinet of FIG. 23.

FIG. 25 schematically illustrates a perspective view of the example pole base cabinet of FIG. 23 with the peripheral wall removed.

FIG. 26 schematically illustrates a front view of the example pole base cabinet of FIG. 23 with the peripheral wall removed.

FIG. 27 schematically illustrates a side view of the example pole base cabinet of FIG. 23 with the peripheral wall removed.

FIG. 28 schematically illustrates a view of the example pole base cabinet of FIG. 23.

FIG. 29 schematically illustrates a perspective view of an example pole base cabinet.

FIG. 30 schematically illustrates a top plate of the example pole base cabinet of FIG. 29.

FIG. 31 schematically illustrates the example pole base cabinet of FIG. 29 with the top plate removed.

FIG. 32 schematically illustrates the example pole base cabinet of FIG. 29 with the top plate and peripheral wall removed.

FIG. 33 schematically illustrates the first or second flange of the example pole base cabinet of FIG. 29.

FIG. 34 schematically illustrates an example pole base cabinet positioned between a footing and pole.

FIG. 35 schematically illustrates the example pole base cabinet of FIG. 34 with the peripheral wall removed.

FIG. 36 schematically illustrates an example pole base cabinet with the top plate removed.

FIG. 37 schematically illustrates a top view of the example pole base cabinet of FIG. 36 with the top plate removed.

FIG. 38 schematically illustrates an example pole base cabinet with the top plate removed.

FIG. 39 schematically illustrates a top view of the example pole base cabinet of FIG. 38 with the top plate removed.

FIG. 40 schematically illustrates an example pole base cabinet with the top plate removed.

FIG. 41 schematically illustrates a top view of the example pole base cabinet of FIG. 40 with the top plate removed.

FIG. 42A schematically illustrates a perspective exploded view of an example pole base cabinet.

FIG. 42B schematically illustrates a perspective exploded view of an example pole base cabinet.

FIG. 43 schematically illustrates a perspective view of the example pole base cabinet of FIGS. 42A and/or 42B with the peripheral wall and door removed.

FIG. 44 schematically illustrates a front view of the example pole base cabinet of FIG. 43.

FIG. 45 schematically illustrates a top view of a top plate of the example pole base cabinet of FIGS. 42A and/or 42B.

FIG. 46 schematically illustrates a top view of a bottom plate of the example pole base cabinet of FIGS. 42A and/or 42B.

FIG. 47 schematically illustrates a perspective view of a peripheral wall and door of the example pole base cabinet of FIGS. 42A and/or 42B.

FIG. 48 schematically illustrates a front view of a door frame of the example pole base cabinet of FIGS. 42A and/or 42B.

FIG. 49 schematically illustrates a hinge of the pole base cabinet of FIGS. 42A and/or 42B.

FIG. 50 schematically illustrates a shim of the pole base cabinet of FIGS. 42A and/or 42B.

FIG. 51 schematically illustrates a fan bracket of FIGS. 42A and/or 42B.

FIG. 52A schematically illustrates a housing on a pole base cabinet for an electric vehicle (EV) charger.

FIG. 52B schematically illustrates the housing on the pole base cabinet with the EV charger.

FIG. 52C schematically illustrates the housing on the pole base cabinet with a cable wrapped around the EV charger.

FIG. 52D schematically illustrates a side view of the housing.

FIG. 52E schematically illustrates a side view of the housing.

FIG. 52F schematically illustrates a top cross-section view of the housing.

FIG. 53A schematically illustrates a housing with a plurality of EV chargers.

FIG. 53B schematically illustrates a top view of the housing with the plurality of EV chargers.

FIG. 53C schematically illustrates a side view of the housing with the plurality of EV chargers.

FIG. 54A schematically illustrates a top view of a housing that includes a protrusion with a plurality of EV chargers disposed thereon.

FIG. 54B schematically illustrates a front view of the housing that includes the protrusion with the plurality of EV chargers disposed thereon.

FIG. 54C schematically illustrates the side view of the housing with example dimensions.

FIG. 55A schematically illustrates a housing.

FIG. 55B schematically illustrates the housing and a bracket.

FIG. 56A schematically illustrates an electric vehicle (EV) charging station mounted on a base cabinet.

FIG. 56B schematically illustrates the EV charging station mounted on the base cabinet.

FIG. 56C schematically illustrates an electric vehicle (EV) charging station mounted on a base cabinet.

FIG. 56D schematically illustrates an electric vehicle (EV) charging station mounted on a base cabinet.

FIG. 57A schematically illustrates a housing of the EV charging station.

FIG. 57B schematically illustrates the housing of the EV charging station.

FIG. 58 schematically illustrates a tab disposed in a notch to facilitate orientation of components of the housing.

FIG. 59 schematically illustrates an exploded view of the housing.

FIG. 60 schematically illustrates a section view of the housing.

FIG. 61A schematically illustrates the base cabinet.

FIG. 61B schematically illustrates the base cabinet with a door removed.

FIG. 61C schematically illustrates a lock of the base cabinet.

FIG. 62A schematically illustrates the base cabinet with a peripheral wall removed.

FIG. 62B schematically illustrates the base cabinet with the peripheral wall removed.

FIG. 63A schematically illustrates a frame of the base cabinet with the top and bottom plates removed.

FIG. 63B schematically illustrates the frame of the base cabinet with the top and bottom plates removed.

FIG. 64 schematically illustrates a sectioned view of the housing mounted on the base cabinet.

FIG. 65 schematically illustrates a sectioned view of the base cabinet with the housing mounted on the base cabinet.

FIG. 66 schematically illustrates a base portion of a pole that can be mounted on the base cabinet.

FIG. 67A schematically illustrates a perspective view of a base cabinet.

FIG. 67B schematically illustrates another view of the base cabinet.

FIG. 68 schematically illustrates an exploded view of the base cabinet.

FIG. 69A schematically illustrates the base cabinet with the peripheral wall removed.

FIG. 69B schematically illustrates another view of the base cabinet with the peripheral wall removed.

FIG. 70A schematically illustrates the base cabinet with a top plate and a bottom plate removed.

FIG. 70B schematically illustrates another view of the base cabinet with the top plate and the bottom plate removed.

FIG. 70C schematically illustrates another view if the base cabinet with two braces thereof disassembled.

FIG. 71 schematically illustrates a lock of the base cabinet.

FIGS. 72A-79 illustrate various views of a housing.

FIGS. 80A-80E illustrate various views of a housing and base cabinet with example dimensions.

FIGS. 81A-81D illustrate example dimensions and views for a mount, housing, and EV chargers.

FIGS. 82A-82E illustrate various views of a mount with example dimensions.

### DETAILED DESCRIPTION

Although certain embodiments and examples are described below, this disclosure extends beyond the specifically disclosed embodiments and/or uses and obvious modifications and equivalents thereof. Thus, it is intended that the scope of this disclosure should not be limited by any particular embodiments described below. Furthermore, this disclosure describes many embodiments in reference to light poles but any embodiment and modifications or equivalents thereof should not be limited to lighting fixtures. For example, embodiments disclosed herein may be used with stoplight poles, traffic sign poles, billboard poles, electricity poles, etc.

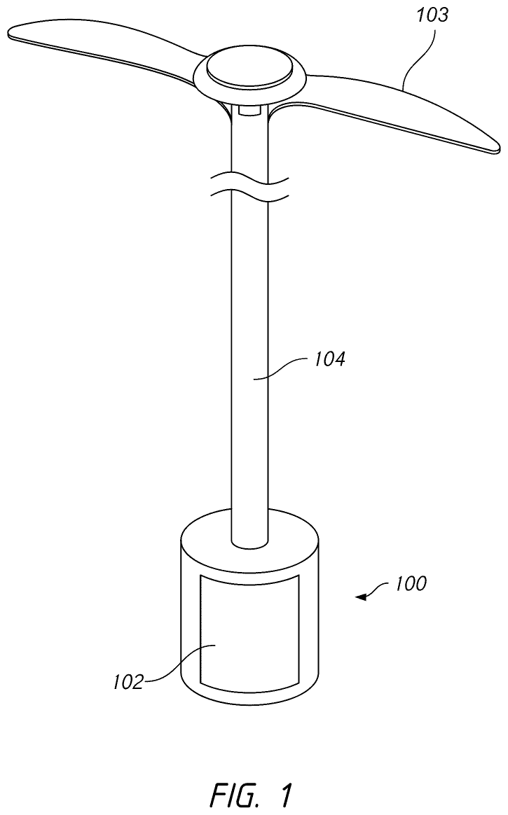

FIG. 1 schematically illustrates an example of a pole base cabinet 100. A pole 104 is mounted onto the pole base cabinet, casing, housing, enclosure, locker 100 to support a light source 103 at an elevated height. The pole base cabinet 100 can have a cavity, lumen, chamber in which items can be positioned in, housed, stored. A door 102 can be opened and/or closed to obstruct or provide access to the cavity. The door 102 can be locked or unlocked. The pole base cabinet 100 can store components relating to a variety of applications, which can include at least electrical vehicle charging (which can include wireless EV charging), antennas, cameras (such as a camera switch), 50 AMP service, receptacle, transformers, high or low voltage system, surveillance, digital signage, Wi-Fi communication (such as extenders, 5G communication, mass notification (such as Blue Phone), emergency equipment, electrical outlets (which can be for holiday or temporary power), lighting control (such as switches, timers, relay, transformers, ballast, drivers, invertors, or other equipment), beacons, batteries or battery storage, solar power generation, broadcasting, speaker systems (which can include at least amplifiers, controllers, speakers, and/or other components), electrical charging (which can be for scooters, bikes, phones, and/or other electrically charged devices), drone technology, security, fiber optics (which can include splicing and terminating optical fibers), music reproduction, networks (which can include switches, routers, modems, patch panels, or other equipment), shelving, switch for converting signal from copper to fiber optics, disconnects, access points, wire mesh repeaters, emergency phone systems, general storage, house splice points, and/or other applications. The pole base cabinet 100 can be used for a variety of applications while still also functioning as a base for a light pole. Pole base cabinet 100 can include the same or similar features described or shown herein in reference to other configurations of pole base cabinets.

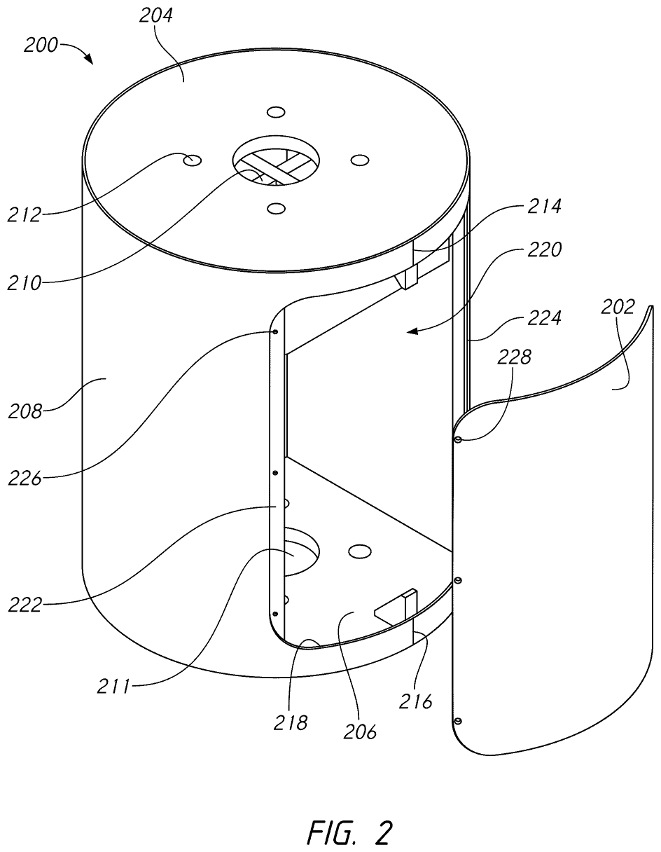

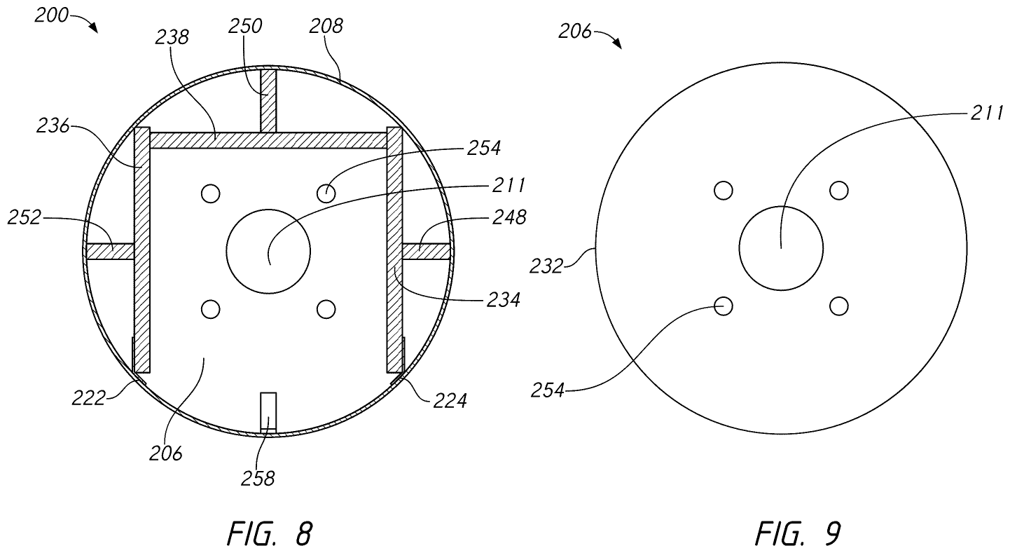

With reference to FIGS. 2-10, a pole base cabinet, casing, housing, enclosure, locker 200 is described. Pole base cabinet 200 can include substantially the same or similar features described or shown herein in reference to other configurations of pole base cabinets. Similarly numbered features can be the same or similar.

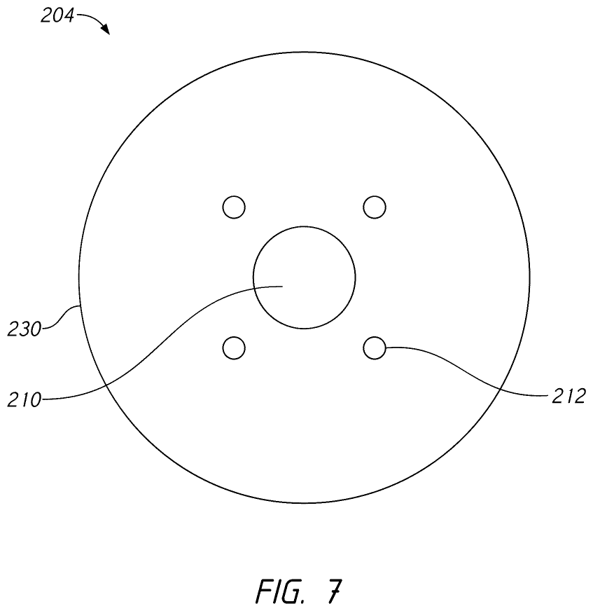

As shown in FIG. 2, the pole base cabinet 200 can have a top or first plate, disc, sheet 204. The top plate 204 can have a periphery, perimeter 230 that is circular, as shown in FIG. 7, or polygonal, irregular, and/or others. The top plate 204 can have a plurality of apertures 212, which can include two, three, four, five, six, or more apertures 212. The apertures 212 can be used to secure the top plate 204 to a pole base, such as a pole base plate. For example, bolts attached to a pole base can extend through the apertures 212 and be secured with nuts, washers, and/or other similar devices, coupling the top plate 204 and pole base cabinet 200 to the pole base and pole. The apertures 212 can have a circular, polygonal, irregular, and/or other shape. The apertures 212 can all be the same or have varying shapes and/or sizes. The apertures 212 can be arranged in different configurations. For example, the apertures 212 can cooperate to form a square with each aperture 212 forming a corner thereof. The apertures 212 can cooperate to form a circular, polygonal, irregular, and/or other shape depending on what configuration is required or desired to couple to a corresponding pole base and/or is needed for structural integrity.

The top plate 204 can have an opening 210. The opening 210 can used to allow wiring, cords, optical fibers, and/or other devices through the top plate 204 and into and/or out of a cavity 220 of the pole base cabinet 200. The opening 210 can be centrally located. In a configuration, the opening 210 can be located at any position on the top plate 204. The opening 210 can have a circular, polygonal, irregular, and/or other shape. In a configuration, a periphery defining the opening 210 can be rounded to reduce abrasion on devices extending therethrough. In a configuration, a periphery defining the opening 210 can be coated or covered with a non-abrasive material to reduce abrasion on devices extending therethrough. In a configuration, the apertures 212 can be distributed around the opening 210, which can include circumferentially or radially distributed. In a configuration, the opening 210 can be located centered relative to the plurality of apertures 212. The opening 210 can be larger than each of the apertures 212.

The pole base cabinet 200 can have a bottom or second plate, disc, sheet 206. The bottom plate 206 can have a periphery 232 that is circular, as shown in FIG. 9, or polygonal, irregular, and/or others. The periphery 232 of the bottom plate 206 can be the same as the periphery 230 of the top plate 204. The periphery 232 of the bottom plate 206 can be different than the periphery 230 of the top plate 204. The bottom plate 206 can have a plurality of apertures 254, which can include two, three, four, five, six, or more apertures 254. The apertures 254 can be used to secure the bottom plate 206 to a footing or base, such as a concrete base or other support or structure, which can include a footing above grade or below grade. For example, bolts or an anchor attached to the footing and/or rebar can extend through the apertures 254 and be secured with nuts, washers, and/or other similar devices, coupling the bottom plate 206 ad the pole base cabinet 200 to the footing. The plurality of apertures 254 can be the same as the plurality of apertures 212. The apertures 254 can have a circular, polygonal, irregular, and/or other shape. The apertures 254 can all be the same or have varying shapes and/or sizes. The apertures 254 can be arranged in different configurations. The apertures 254 can cooperate to form a square with each aperture 254 forming a corner thereof. The apertures 254 can cooperate to form a circular, polygonal, irregular, and/or other shape depending on what configuration is require to couple to a corresponding footing or bolt arrangement. In a configuration, the top plate 204 can be the same as the bottom plate 206.

The bottom plate 206 can have an opening 211. The opening 211 can used to allow wiring, cords, optical fibers, and/or other devices through the bottom plate 206 and into and/or out of the cavity 220 of the pole base cabinet 200. For example, wiring and/or cables can be routed through conduits in a footing or base upon which the pole base cabinet 200 is mounted and extend through the opening 211 and into the cavity 220. The wiring and/or cables can be used to supply electrical power to components/items stored in the cavity 220, components/items stored outside the cavity 220, and/or a light source mounted on a pole that is coupled to the pole base cabinet 200. The opening 211 can be centrally located. In a configuration, the opening 211 can be located at any position on the bottom plate 206. The opening 211 can have a circular, polygonal, irregular, and/or other shape. In a configuration, a periphery defining the opening 211 can be rounded to reduce abrasion on devices extending therethrough. In a configuration, a periphery defining the opening 211 can be coated or covered with a non-abrasive material to reduce abrasion on devices extending therethrough. In a configuration, the apertures 254 can be distributed around the opening 211, which can include circumferentially or radially distributed. In a configuration, the opening 211 can be located centered relative to the plurality of apertures 254. The opening 211 can be larger than each of the apertures 254. The opening 211 can be the same as or different than the opening 210. In a configuration, the opening 211 is larger than the opening 210.

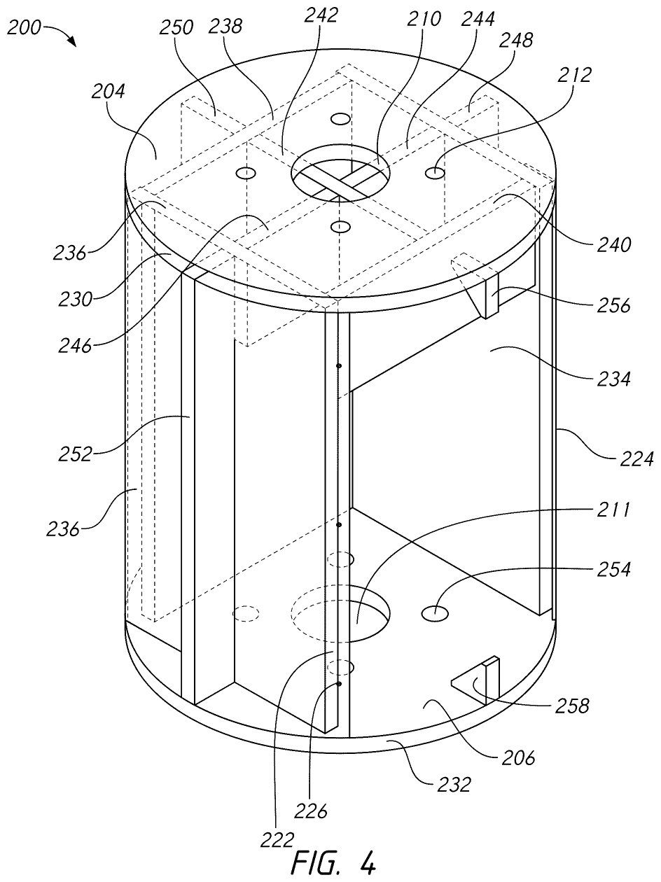

The top plate 204 and the bottom plate 206 can be offset and/or parallel from each other, as shown in FIG. 4. The top plate 204 and the bottom plate 206 can define ends and/or opposing ends of the pole base cabinet 200. The top plate 204 and the bottom plate 206 can be flat. In a configuration, the top plate 204 and the bottom plate 206 can include recesses, curves, and/or contours. The top plate 204 and the bottom plate 206 can be positioned on a center-longitudinal axis of the pole base cabinet 200. The top plate and the bottom plate 206 can be centered on a center-longitudinal axis of the pole base cabinet 200. In a configuration, the top plate 204 can be the same as the bottom plate 206. This can be advantageous when more wiring or cables are directed into the cavity 220 through the bottom plate 206 than out of the cavity 220 through the top plate 204. In a configuration, the top plate 204 does not have an opening 210 and/or the bottom plate 206 does not have an opening 211.

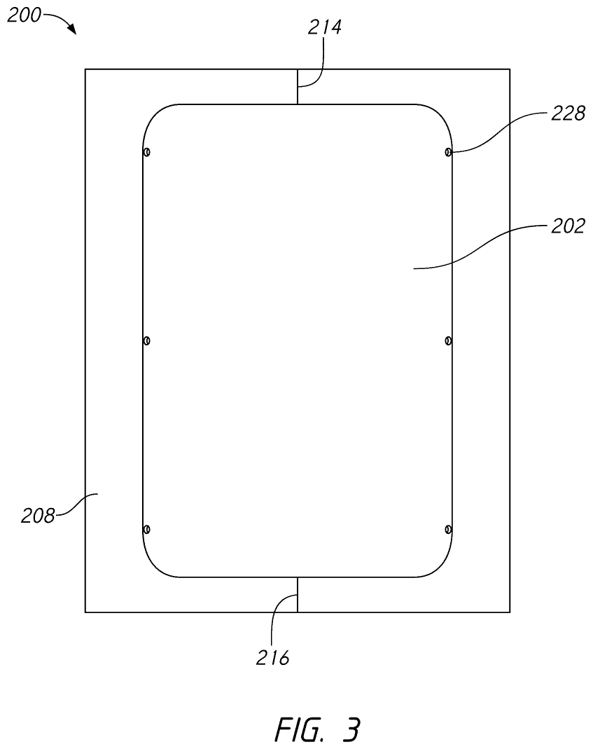

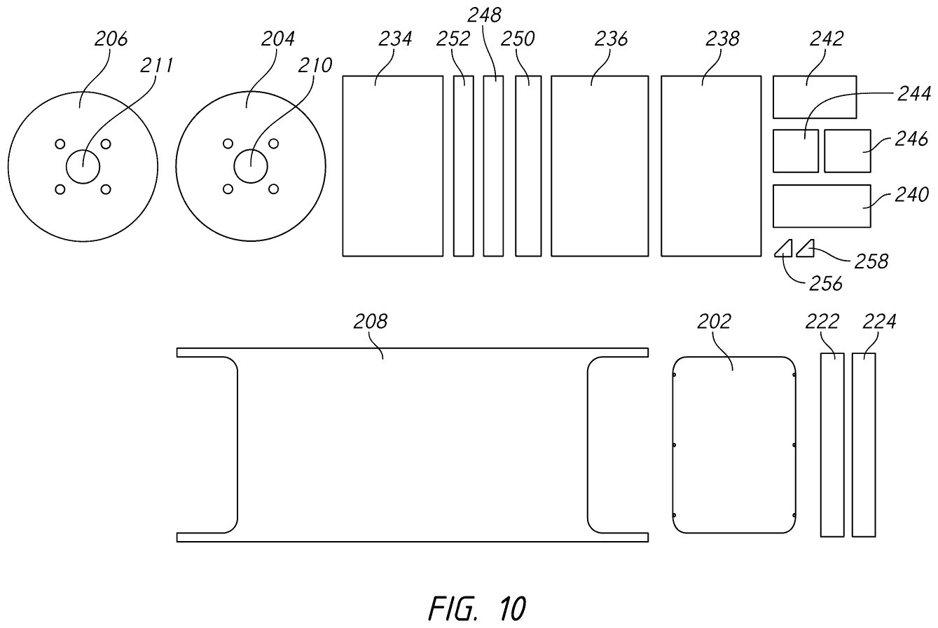

The pole base cabinet 200 can have a peripheral wall, side, surface 208, which can also be referred to as a skin and/or wall 208, as illustrated in FIGS. 2 and 3. The peripheral wall 208 can extend from and/or be coupled, which can include directly, rigidly, or fixedly connected, to the top plate 204 to the bottom plate 206. The peripheral wall 208 can extend from and/or be coupled, which can include directly, rigidly, or fixedly connected, to the periphery 230 of the top plate 204 to and/or proximate a periphery 232 of the bottom plate 206. The peripheral wall 208 can extend and/or be coupled, which can include directly, rigidly, or fixedly connected, around the periphery 230 of the top plate 204 and/or periphery 232 of the bottom plate 206. The peripheral wall 208 can define a periphery of the pole base cabinet 200, which can be circular, polygonal, irregular, and/or other shapes. The peripheral wall 208 can define a periphery of the pole base cabinet 200 that can be the same as or similar to the shape of the periphery 230 of the top plate 204 and/or periphery 232 of the bottom plate 206. The peripheral wall 208 can define a rounded or circular periphery of the pole base cabinet 200, which can be similar to a tube. In a configuration, the peripheral wall 208 can be manipulated from a disassembled configuration, shown in FIG. 10, to the configuration shown in FIG. 2 by forming the peripheral wall 208 into the rounded tube-like configuration such that the peripheral wall 208 can be coupled to or proximate itself at the top joint, abutment, seam, junction, connection 214 and the bottom joint, abutment, seam, junction, connection 216. In a configuration, the peripheral wall 208 can be manufactured in the configuration illustrated in FIG. 2 such that there is no top joint 214 and/or bottom joint 216.

The peripheral wall 208 can define a main opening 218, as shown in FIG. 2. The main opening 218 can provide access into a cavity 220 of the pole base cabinet 200. The cavity 220 can be centrally located in the pole base cabinet 200. The cavity 220 can house items and/or components, which can include the items and/or components detailed herein. The main opening 218 can be varying sizes and shapes, which can include circular, polygonal, irregular, and/or others. In a configuration, the main opening 218 can be rectangular in shape with rounded corners. The main opening 218 can extend to proximate the top plate 204 and proximate the bottom plate 206.

The main opening 218 can be covered with a door 202, as shown in FIG. 3, permanently or temporarily preventing and/or restricting access to the cavity 220. The door 202 can releasably coupled to the pole base cabinet 200, periphery of the main opening 218, and/or first flange 224 and/or second flange 222. The main opening 218 can be uncovered with the door 202 removed, as shown in FIG. 2, to allow access to the cavity 220. The door 202 can be locked and/or unlocked. The door 202 can include vents. In a configuration, the peripheral wall 208 can include vents. The door 202 can include a plurality of door apertures 228, which can include two, three, four, five, six, seven, eight, or more door apertures 228. The door apertures 228 can be used to couple the door 202 to the pole base cabinet 200. The door apertures 228 can correspond to flange apertures 226 positioned on a first flange, rim, border, frame, lip 224 and/or second flange, rim, border, frame, lip 222 of the pole base cabinet 200. The door 202 can be coupled to the pole base cabinet 200 by placing the door 202 over the main opening 218 such that the door apertures 228 are aligned with the flange apertures 226 and inserting a bolt, screw, rivet, and/or other similar device through the door apertures 228 and the flange apertures 226. In a configuration, the door 202 can be coupled to the pole base cabinet 200 with a hinge allowing the door 202 to be swung open and closed while remaining coupled to the pole base cabinet 200, which can include a hinge positioned on the first flange 224 and/or second flange 222. The door 202 can have a curvature matching a curvature of the peripheral wall 208. The door 202 can have a perimeter or periphery that matches the main opening 218 such that the door 202 can cover the main opening 218. The door 202 can be a thickness matching that of the peripheral wall 208.

As shown in FIGS. 4, 6, and 8, the pole base cabinet 200 can include a frame providing structural support and/or integrity, wherein the frame can have a plurality of support panels, plurality of internal stiffening panels, and/or a plurality of external stiffening panels. The peripheral wall 208 can be coupled, which can include directly, rigidly, or fixedly connected, to portions of the frame, which can include welded.

The plurality of support panels can include a first support panel, plank, girder, joist, pillar, plank, brace, beam 234, second support panel, plank, girder, joist, pillar, plank, brace, beam 236, and/or a third support panel, plank, girder, joist, pillar, plank, brace, beam 238. As shown in FIG. 4, the first support panel 234, second support panel 236, and/or a third support panel 238 can at least partially define the cavity 220. The first support panel 234, second support panel 236, and/or a third support panel 238 can extend between and/or be coupled, which can include directly, rigidly, or fixedly connected, to the top plate 204 and the bottom plate 206. The first support panel 234, second support panel 236, and/or a third support panel 238 can form three sides of a rectangular-like structure surrounding or at least partially surrounding the cavity 220. The first support panel 234, second support panel 236, and/or a third support panel 238 can be the same, similar, or different size and shape. The first support panel 234, second support panel 236, and/or a third support panel 238 can be rectangular panels. The first support panel 234, second support panel 236, and/or a third support panel 238 can be straight or curved. The first support panel 234 can be offset from and/or parallel to the second support panel 236. The third support panel 238 can extend between and/or be coupled, which can include directly, rigidly, or fixedly connected, to the first support panel 234 and the second support panel 236. The third support panel 238 can extend between and/or be coupled to, which can include directly, rigidly, or fixedly connected, ends or proximate ends of the first support panel 234 and second support panel 236. The third support panel 238 can extend between and/or be coupled, which can include directly, rigidly, or fixedly connected, to ends or proximate ends of the first support panel 234 and second support panel 236 that are opposite the main opening 218 and/or first flange 224 and/or second flange 222. The third support panel 238 can be positioned opposite the main opening 218. The third support panel 238 can be perpendicular to the first support panel 234 and/or second support panel 236.

The pole base cabinet 200 can include a plurality of internal stiffening panels, planks, girders, joists, pillars, planks, braces, beams, which can include the first internal stiffening panel 240, second internal stiffening panel 242, third internal stiffening panel 244, and/or fourth internal stiffening panel 246. The first internal stiffening panel 240, second internal stiffening panel 242, third internal stiffening panel 244, and/or fourth internal stiffening panel 246 can be coupled, which can include directly, rigidly, or fixedly connected, to the top plate 204. The first internal stiffening panel 240, second internal stiffening panel 242, third internal stiffening panel 244, and/or fourth internal stiffening panel 246 can extend equidistantly or to different distances away from the top plate 204. The first internal stiffening panel 240, second internal stiffening panel 242, third internal stiffening panel 244, and/or fourth internal stiffening panel 246 can extend to a position between the top plate 204 and the bottom plate 206, providing room for items to be store in the cavity 220. The first internal stiffening panel 240, second internal stiffening panel 242, third internal stiffening panel 244, and/or fourth internal stiffening panel 246 can be rectangular, square, and/or other shaped panels. The first internal stiffening panel 240, second internal stiffening panel 242, third internal stiffening panel 244, and/or fourth internal stiffening panel 246 can be straight or curved.

The first internal stiffening panel 240 can extend between and/or be coupled to, which can include directly, rigidly, or fixedly connected, the first support panel 234 and the second support panel 236. The first internal stiffening panel 240 can extend between and/or be coupled to, which can include directly, rigidly, or fixedly connected, ends or proximate ends of the first support panel 234 and the second support panel 236. The first internal stiffening panel 240 can be positioned proximate the main opening 218. The first internal stiffening panel 240 can be positioned opposite the third support panel 238. The first internal stiffening panel 240 can be offset from and/or parallel to the third support panel 238. The first internal stiffening panel 240 can be parallel to the third support panel 238. The opening 210 and/or plurality of apertures 212 can be positioned between the first internal stiffening panel 240 and the third support panel 238. The first internal stiffening panel 240 can be a length that can be longer than that of the second internal stiffening panel 242, third internal stiffening panel 244, and/or fourth internal stiffening panel 246.

The second internal stiffening panel 242 can extend between and/or be coupled to, which can include directly, rigidly, or fixedly connected, the first internal stiffening panel 240 and the third support panel 238. The second internal stiffening panel 242 can extend from and/or be coupled, which can include directly, rigidly, or fixedly connected, to a middle portion of the first internal stiffening panel 240 to a middle portion of the third support panel 238. The second internal stiffening panel 242 can extend through a central longitudinal axis of the pole base cabinet 200. The second internal stiffening panel 242 can extend across the opening 210 of the top plate 204. The second internal stiffening panel 242 can extend between the plurality of apertures 212. The second internal stiffening panel 242 can extend between the plurality of apertures 212, such that two of the plurality of apertures 212 are on one side of the second internal stiffening panel 242 and two of the plurality of apertures 212 are on another side of the second internal stiffening panel 242. The second internal stiffening panel 242 can be positioned between the first support panel 234 and the second support panel 236. The second internal stiffening panel 242 can be offset from and/or parallel to the first support panel 234 and the second support panel 236. The second internal stiffening panel 242 can be equidistantly spaced away from the first support panel 234 and the second support panel 236. The second internal stiffening panel 242 can have a length that can be smaller than that of the first internal stiffening panel 240 and/or longer than that of the third internal stiffening panel 244 and/or fourth internal stiffening panel 246.

The third internal stiffening panel 244 can extend between and/or be coupled to, which can include directly, rigidly, or fixedly connected, the first support panel 234 and the second internal stiffening panel 242. The third internal stiffening panel 244 can extend between and/or be coupled to, which can include directly, rigidly, or fixedly connected, a middle portion of the first support panel 234 and a middle portion of the second internal stiffening panel 242. The third internal stiffening panel 244 can be positioned between the first internal stiffening panel 240 and the third support panel 238. The third internal stiffening panel 244 can be offset from and/or parallel to the first internal stiffening panel 240 and the third support panel 238. The third internal stiffening panel 244 can be equidistantly spaced from the first internal stiffening panel 240 and the third support panel 238. The third internal stiffening panel 244 can couple to the second internal stiffening panel 242 at a position below and/or proximate the opening 210. The third internal stiffening panel 244 can extend between the plurality of apertures 212. The third internal stiffening panel 244 can extend between the plurality of apertures 212, such that one of the plurality of apertures 212 is on one side of the third internal stiffening panel 244 and another of the plurality of apertures 212 is on another side of the third internal stiffening panel 244.

The fourth internal stiffening panel 246 can extend between and/or be coupled to, which can include directly, rigidly, or fixedly connected, the second support panel 236 and the second internal stiffening panel 242. The fourth internal stiffening panel 246 can extend between and/or be coupled to, which can include directly, rigidly, or fixedly connected, a middle portion of the second support panel 236 and a middle portion of the second internal stiffening panel 242. The fourth internal stiffening panel 246 can be positioned between the first internal stiffening panel 240 and the third support panel 238. The fourth internal stiffening panel 246 can be offset from and/or parallel to the first internal stiffening panel 240 and the third support panel 238. The fourth internal stiffening panel 246 can be equidistantly spaced from the first internal stiffening panel 240 and the third support panel 238. The fourth internal stiffening panel 246 can be coupled to, which can include directly, rigidly, or fixedly connected, the second internal stiffening panel 242 at a position below and/or proximate the opening 210. The fourth internal stiffening panel 246 can extend between the plurality of apertures 212. The fourth internal stiffening panel 246 can extend between the plurality of apertures 212, such that one of the plurality of apertures 212 is on one side of the fourth internal stiffening panel 246 and another of the plurality of apertures 212 is on another side of the fourth internal stiffening panel 246. The fourth internal stiffening panel 246 can be positioned on an opposing side of the second internal stiffening panel, relative to the third internal stiffening panel 244. The fourth internal stiffening panel 246 can be the same size and/or shape as the third internal stiffening panel 244.

The pole base cabinet 200 can include a plurality of external stiffening panels, planks, girders, joists, pillars, planks, braces, beams, which can include a first external stiffening panel 248, second external stiffening panel 252, and/or a third external stiffening panel 250. The first external stiffening panel 248, second external stiffening panel 252, and/or a third external stiffening panel 250 can extend between and/or be coupled to, which can include directly, rigidly, or fixedly connected, the top plate 204 and the bottom plate 206. The first external stiffening panel 248, second external stiffening panel 252, and/or a third external stiffening panel 250 can be positioned outside the cavity 220. The first external stiffening panel 248, second external stiffening panel 252, and/or a third external stiffening panel 250 can be the same, similar, or different size and shape. In a configuration, the first external stiffening panel 248, second external stiffening panel 252, and/or a third external stiffening panel 250 can be rectangular panels. In a configuration, the first external stiffening panel 248, second external stiffening panel 252, and/or a third external stiffening panel 250 can be the same length. In a configuration, the first external stiffening panel 248 and second external stiffening panel 252 can be the same size and shape. In a configuration, the third external stiffening panel 250 has a width that can be greater than a width of the first external stiffening panel 248 and/or second external stiffening panel 252.

The first external stiffening panel 248 can extend from and/or be coupled to, which can include directly, rigidly, or fixedly connected, the first support panel 234 to the periphery 230 of the top plate 204 and/or the periphery 232 of the bottom plate 206. The first external stiffening panel 248 can extend between and/or be coupled to, which can include directly, rigidly, or fixedly connected, the first support panel 234 and the peripheral wall 208. The first external stiffening panel 248 can be positioned at and/or be coupled to, which can include directly, rigidly, or fixedly connected, a middle portion of the first support panel 234. The first external stiffening panel 248 can be positioned on and/or be coupled to, which can include directly, rigidly, or fixedly connected, an opposing side of the first support panel 234, relative to the third internal stiffening panel 244.

The second external stiffening panel 252 can extend from and/or be coupled to, which can include directly, rigidly, or fixedly connected, the second support panel 236 to the periphery 230 of the top plate 204 and/or the periphery 232 of the bottom plate 206. The second external stiffening panel 252 can extend between and/or be coupled to, which can include directly, rigidly, or fixedly connected, the second support panel 236 and the peripheral wall 208. The second external stiffening panel 252 can be positioned at and/or be coupled to, which can include directly, rigidly, or fixedly connected, a middle portion of the second support panel 236. The second external stiffening panel 252 can be positioned on and/or be coupled to, which can include directly, rigidly, or fixedly connected, an opposing side of the second support panel 236, relative to the fourth internal stiffening panel 246.

The third external stiffening panel 250 can extend from and/or be coupled to, which can include directly, rigidly, or fixedly connected, the third support panel 238 to the periphery 230 of the top plate 204 and/or the periphery 232 of the bottom plate 206. The third external stiffening panel 250 can extend between the third support panel 238 and the peripheral wall 208. The third external stiffening panel 250 can be positioned at and/or be coupled to, which can include directly, rigidly, or fixedly connected, a middle portion of the third support panel 238. The third external stiffening panel 250 can be positioned on and/or be coupled to, which can include directly, rigidly, or fixedly connected, an opposing side of the third support panel 238, relative to the second internal stiffening panel 242.

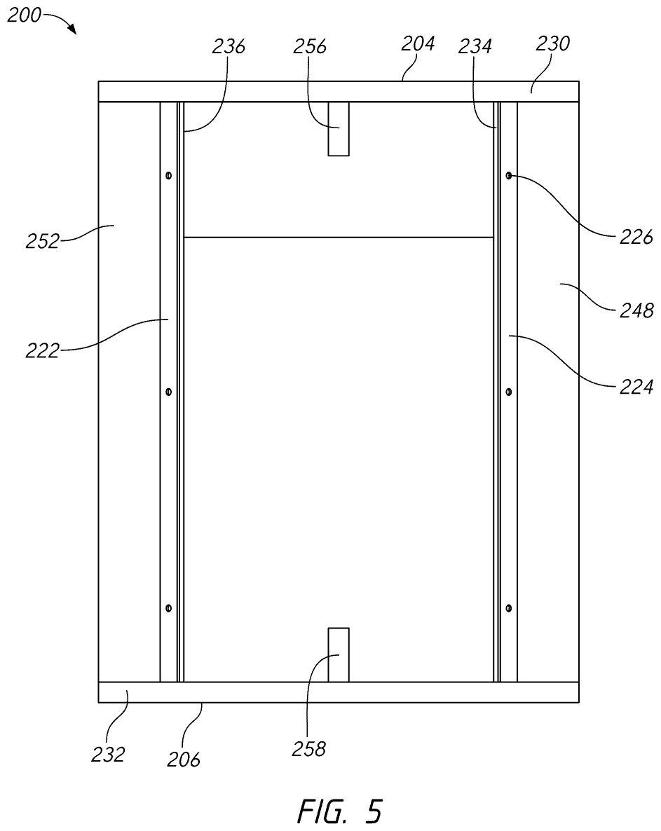

The pole base cabinet 200 can have a top tab, projection, protrusion, boss, stiffener 256 and/or a bottom tab, projection, protrusion, boss, stiffener 258, as shown in FIG. 4. The top tab 256 and bottom tab 258 can be the same or different size and/or shape. The top tab 256 and/or bottom tab 258 can be triangular in shape. The top tab 256 can be coupled to, which can include directly, rigidly, or fixedly connected, the top plate 204. The bottom tab 258 can be coupled to, which can include directly, rigidly, or fixedly connected, the bottom plate 206. As illustrated in FIG. 5, the top tab 256 and/or bottom tab 258 can be equidistantly spaced relative to the first support panel 234 and/or the second support panel 236. The top tab 256 and/or bottom tab 258 can extend to and/or be coupled to, which can include directly, rigidly, or fixedly connected, the peripheral wall 208. The top tab 256 can extend to the periphery 230 of the top plate 204. The bottom tab 258 can extend to the periphery 232 of the bottom plate 206. The top tab 256 can extend into the main opening 218 such that the top tab 256 can engage with the door 202. The bottom tab 258 can extend into the main opening 218 such that the bottom tab 28 can engage with the door 202. The top tab 256 and/or bottom tab 258 can extend to and/or be couple to the peripheral wall 208.

As detailed above, the pole base cabinet can have a first flange 224 and/or second flange 222. The first flange 224 and/or second flange 222 can extend between and/or be coupled to, which can include directly, rigidly, or fixedly connected, the top plate 204 and the bottom plate 206. The first flange 224 and/or second flange 222 be positioned proximate the main opening 218 such that at least a portion of the first flange 224 and/or second flange 222 extends into the main opening 218. The first flange 224 and/or second flange 222 can have flange apertures 226 that correspond to door apertures 228 of the door 202. The first flange 224 and/or the second flange 222 can each have one, two, three, four, five, six, or more flange apertures 226. The first flange 224 can be coupled to, which can include directly, rigidly, or fixedly connected, the first support panel 234. The first flange 224 can be coupled to, which can include directly, rigidly, or fixedly connected, an end or proximate an end of the first support panel 234. The second flange 222 can be coupled to, which can include directly, rigidly, or fixedly connected, the second support panel 236. The second flange 222 can be coupled to, which can include directly, rigidly, or fixedly connected, an end or proximate an end of the second support panel 236. In a configuration, the first flange 224 and/or second flange 222 can be coupled to—such as directly, rigidly, or fixedly connected, proximate, and/or engaging with the peripheral wall 208. In a configuration, the first flange 224 and/or second flange 222 can be coupled to, which can include directly, rigidly, or fixedly connected, external surfaces of the first support panel 434 and the second support panel 436.

The top tab 256, bottom tab 258, second internal stiffening panel 242, and/or third external stiffening panel 250 can be coplanar with a central plane of the pole base cabinet 200. The second external stiffening panel 252, fourth internal stiffening panel 246, third internal stiffening panel 244, and/or first external stiffening panel 248 can be coplanar with another central plane of the pole base cabinet 200. In a configuration, any one or multiple of the first support panel 234, second support panel 236, third support panel 238, first internal stiffening panel 240, second internal stiffening panel 242, third internal stiffening panel 244, fourth internal stiffening panel 246, first external stiffening panel 248, second external stiffening panel 252, third external stiffening panel 250, top tab 256, and/or bottom tab can be omitted from the pole base cabinet 200.

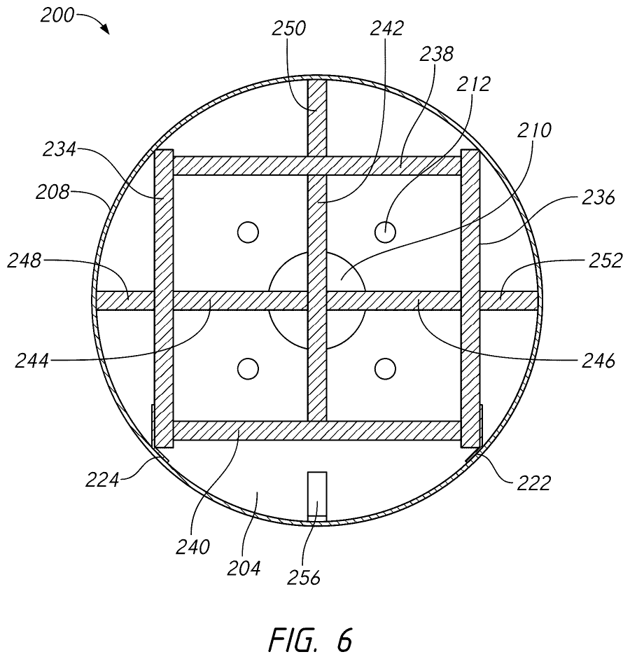

As shown in FIG. 6, the first support panel 234 and second support panel 236 can be positioned such that the ends or a portion of the ends of the first support panel 234 and second support panel 236 engage with, are proximate to, and/or are coupled to, which can include directly, rigidly, or fixedly connected, the peripheral wall 208. The first support panel 234 and second support panel 236 can be positioned such that the ends or a portion of the ends of the first support panel 234 and second support panel 236 extend to the periphery 230 of the top plate 204 and/or bottom plate 206. In a configuration, the first support panel 234 and second support panel 236 can be coupled to, which can include directly, rigidly, or fixedly connected, the peripheral wall 208. The third support panel 238 and/or first internal stiffening panel 240 can be proximate the ends of, which can include inset from the ends, and coupled to, which can include directly, rigidly, or fixedly connected, the first support panel 234 and second support panel 236.

FIG. 10 shows the pole base cabinet 200 in a disassembled state. To manufacture and/or assemble the pole base cabinet 200, the components of the pole base cabinet 200 can be positioned and/or coupled, which can include directly, rigidly, or fixedly connected, together in a configuration described herein. For example, the first support panel 234, second support panel 236, and/or third support panel 238 can be positioned between and/or coupled to, which can include directly, rigidly, or fixedly connected, the top plate 204 and bottom plate 206 in a configuration detailed herein. The first internal stiffening panel 240 can be positioned between and/or coupled to, which can include directly, rigidly, or fixedly connected, the first support panel 234 and second support panel 236 in a configuration detailed herein. The second internal stiffening panel 242 can be positioned between and/or coupled to, which can include directly, rigidly, or fixedly connected, the first internal stiffening panel 240 and the third support panel 238 in a configuration detailed herein. The third internal stiffening panel 244 can be positioned between and/or coupled to the first support panel 234 and the second internal stiffening panel 242 in a configuration detailed herein. The fourth internal stiffening panel 246 can be positioned between and/or coupled to, which can include directly, rigidly, or fixedly connected, the second support panel 236 and the second internal stiffening panel 242 in a configuration detailed herein. The first internal stiffening panel 240, second internal stiffening panel 242, third internal stiffening panel 244, and fourth internal stiffening panel 246 can be coupled to, which can include directly, rigidly, or fixedly connected, the top plate 204 and positioned between the top plate 204 and the bottom plate 206 in a configuration detailed herein.

The first external stiffening panel 248, second external stiffening panel 252, and third external stiffening panel 250 can be positioned between and/or coupled to, which can include directly, rigidly, or fixedly connected, the top plate 204 and the bottom plate 206 in a configuration detailed herein. The first external stiffening panel 248 can be coupled to, which can include directly, rigidly, or fixedly connected, the first support panel 234 in a configuration detailed herein. The second external stiffening panel 252 can be coupled to, which can include directly, rigidly, or fixedly connected, the second support panel 236. The third external stiffening panel 250 can be coupled to, which can include directly, rigidly, or fixedly connected, the third support panel 238 in a configuration detailed herein. The top tab 256 can be coupled to, which can include directly, rigidly, or fixedly connected, the top plate 204 in a configuration detailed herein. The bottom tab 258 can be coupled to, which can include directly, rigidly, or fixedly connected, the bottom plate 206 in a configuration detailed herein. The peripheral wall 208 can be formed, bent, curved, manipulated, deformed, and/or otherwise treated to wrap around the periphery 230 of the top plate 204 and the periphery 232 of the bottom plate 206. The peripheral wall 208 can be fixed in the formed, bent, curved, manipulated, deformed, and/or otherwise treated state by coupling the peripheral wall 208 to itself at top joint 214 and bottom joint 216, as shown in FIG. 2. In a configuration, the peripheral wall 208 can be fixed in the formed, bent, curved, manipulated, deformed, and/or otherwise treated state by coupling the peripheral wall 208 to the top plate 204 and bottom plate 206 such that the peripheral wall can be joined, which can include directly, rigidly, or fixedly connected, or proximate its opposite end at the top joint 214 and/or bottom joint 216. The door 202 can placed over the opening 218. The door 202 can be coupled into place using methods described herein. The coupling, which can include directly, rigidly, or fixedly connected, of the components of the pole base cabinet 200 or other pole base cabinets disclosed herein can be accomplished with welding, adhesion, riveting, threaded connections, press fits, snap fits, and/or other similar methods.

The thickness and/or material of the varying components of the pole base cabinet 200 can vary depending on the desired structural integrity. For example, materials such as metals (such as steel, high strength steel, aluminum, and/or others), metal alloys, polymers (such as plastic), ceramics, and/or others can be used. For example, each of the plurality of support panels can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Each of the plurality of internal stiffening panels can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Each of the plurality of external stiffening panels can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The peripheral wall can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Each of the plurality of tabs can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The top plate and/or bottom plate can have thicknesses of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Relatedly, the components listed above can have varying widths, heights, and/or lengths to provide a desired size. For example, the pole base cabinet 200 can have an overall diameter or width of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches and/or height or length of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches. These are example ranges, such that other dimensions can be employed that are not explicitly listed herein.

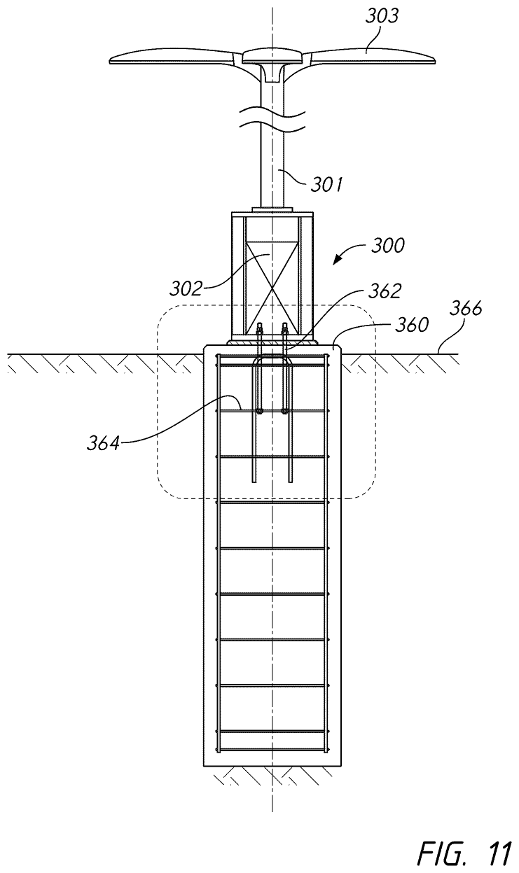

With reference to FIGS. 11-17, a pole base cabinet, casing, housing, enclosure, locker 300 is described. Pole base cabinet 300 can include substantially the same or similar features described or shown herein in reference to other configurations of pole base cabinets. Similarly numbered features can be the same or similar.

As shown in FIG. 11, a pole 301 can be mounted onto the pole base cabinet 300 to support a light source 303 at an elevated height. The pole base cabinet 300 can have a cavity in which items can be stored. A door 302 can be opened and/or closed, such as releasably coupled, to obstruct or provide access to the cavity. The pole base cabinet 300 can be secured to a footing, base 360. Specifically, the pole base cabinet 300 can be coupled to anchors 362 extending into the footing 360. In a configuration, the anchors 362 can be coupled to or retained by rebar 364 in the footing 360. The footing 360 can be positioned at, proximate, above, and/or below grade 366.

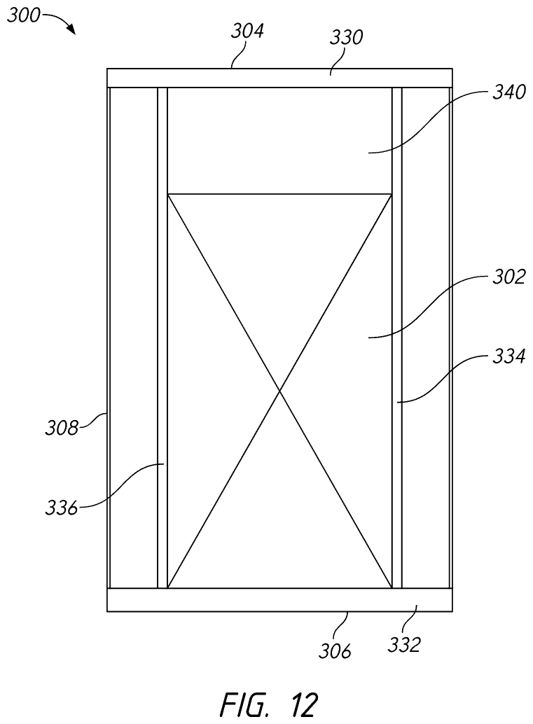

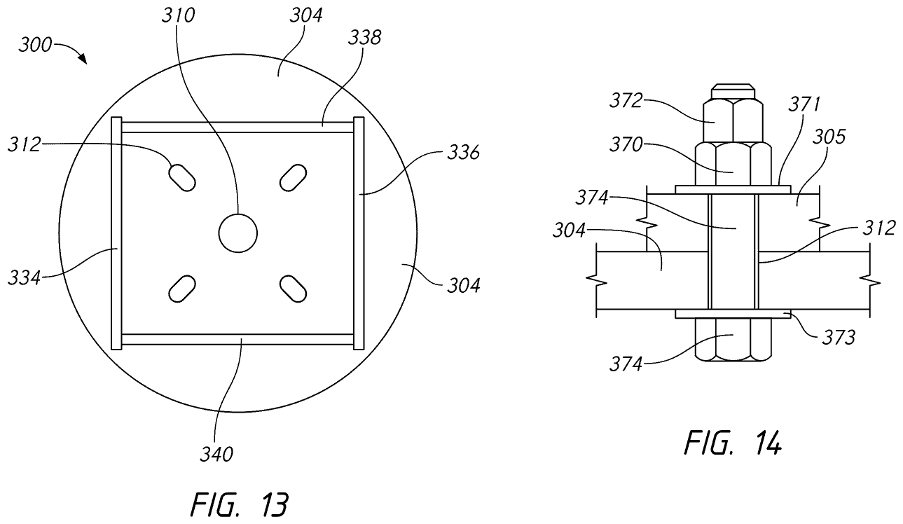

As shown in FIG. 12, the pole base cabinet 300 can have a top or first plate, disc, sheet 304. The top plate 304 can have a periphery 330 that is circular, as shown in FIG. 13, or polygonal, irregular, and/or others. The top plate 304 can have a plurality of apertures 312, which can include two, three, four, five, six, or more apertures 312. The apertures 312 can have a circular, polygonal, irregular, and/or other shape. The aperture 312 can be elongate with rounded ends. The apertures 312 can all be the same or having varying shapes and/or sizes. The apertures 312 can be arranged in different configurations. For example, the apertures 312 can cooperate to form a square with each aperture 312 forming a corner thereof. The apertures 312 can cooperate to form a circular, polygonal, irregular, and/or other shape depending on what configuration is required or desired to couple to a corresponding pole base and/or is needed for structural integrity. The apertures 312 can be used to secure the top plate 204 to a pole base, such as a pole base plate, which can include utilizing bolts. The apertures 312 can be oversized relative to a bolt that will extend therethrough. Having over-sized apertures 312 relative to the bolt can be advantageous for convenient alignment. Apertures 312 can be oversized relative to corresponding apertures of a pole base or pole base plate, which can be advantageous for convenient alignment.

The top plate 304 can have an opening 310. The opening 310 can used to allow wiring, cords, optical fibers, and/or other devices through the top plate 304 and into and/or out of a cavity of the pole base cabinet 300. The opening 310 can be centrally located. In a configuration, the opening 310 can be located at any position on the top plate 304. The opening 310 can have a circular, polygonal, irregular, and/or other shape. In a configuration, a periphery defining the opening 310 can be rounded to reduce abrasion on devices extending therethrough. In a configuration, a periphery defining the opening 310 can be coated or covered with a non-abrasive material to reduce abrasion on devices extending therethrough. In a configuration, the apertures 312 can be distributed around the opening 310, which can include circumferentially or radially distributed. In a configuration, the opening 310 can be located centered relative to the plurality of apertures 312. The opening 310 can be larger than each of the apertures 312.

For example, as shown in FIG. 14, a pole base plate 305 can be positioned on the top plate 304. An aperture 312 of the top plate 304 can be aligned with a corresponding aperture of the pole base plate, base plate 305. A bolt 374 can extend through the aperture 312 of the top plate 304 and the corresponding aperture of the pole base plate 305. A washer 373 can be positioned between the head of the bolt 374 and the top plate 304. The washer 373 can protect the top plate 304 and/or enable the apertures 312 to be oversized relative to the head of the bolt 374 for at least the advantages explained above. A first nut 370 can be secured on the end of the bolt 374 proximate the pole base plate 305 to securely couple the top plate 304 and pole base plate 305 together. A second nut 372 can be secured on the end of the bolt 374 proximate the first nut 370 to securely couple the top plate 304 and pole base plate 305 together. A washer 371 can be positioned between the first nut 370 and the pole base plate 305. The washer 371 can be used for similar advantages as detailed for the washer 373. Any other suitable fasteners and fastener system may be used.

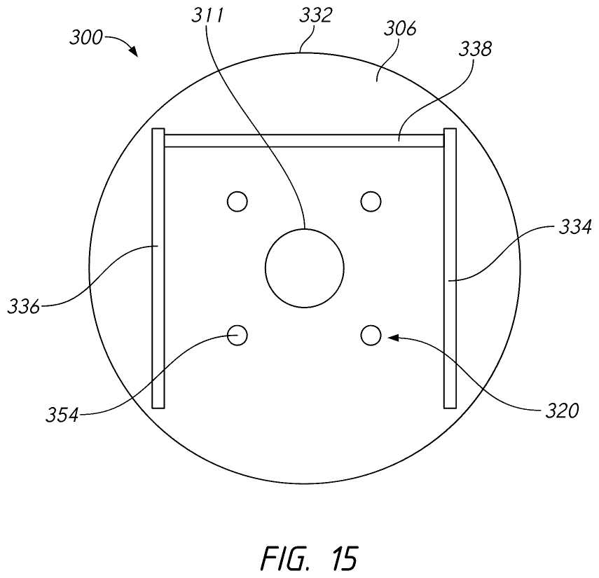

As shown in FIG. 12, the pole base cabinet 300 can have a bottom or second plate, disc, sheet 306. The bottom plate 306 can have a periphery 332 that is circular, as shown in FIG. 15, or polygonal, irregular, and/or others. The bottom plate 306 can have a plurality of apertures 354, which can include two, three, four, five, six, or more apertures 354. The apertures 354 can have a circular, polygonal, irregular, and/or other shape. In a configuration, the apertures 354 can be elongate with rounded ends. In a configuration, the apertures 354 can be the same as or similar to the apertures 312. The apertures 354 can all be the same or having varying shapes and/or sizes. The apertures 354 can be arranged in different configurations. For example, the apertures 354 can cooperate to form a square with each aperture 354 forming a corner thereof. The apertures 354 can cooperate to form a circular, polygonal, irregular, and/or other shape depending on what configuration is required or desired to couple to a corresponding pole base and/or is needed for structural integrity. The apertures 354 can be used to secure the bottom plate 306 to the footing 360.

The bottom plate 306 can have an opening 311. The opening 311 can used to allow wiring, cords, optical fibers, and/or other devices through the bottom plate 306 and into and/or out of the cavity 320 of the pole base cabinet 300. For example, wiring and/or cables can be routed through conduits in a footing or base upon which the pole base cabinet 300 is mounted and extend through the opening 311 and into the cavity. The wiring and/or cables can be used to supply electrical power to components/items stored in the cavity, components/items stored outside the cavity, and/or a light source mounted on a pole that is coupled to the pole base cabinet 300. The opening 311 can be centrally located. In a configuration, the opening 311 can be located at any position on the bottom plate 306. The opening 311 can have a circular, polygonal, irregular, and/or other shape. In a configuration, a periphery defining the opening 311 can be rounded to reduce abrasion on devices extending therethrough. In a configuration, a periphery defining the opening 311 can be coated or covered with a non-abrasive material to reduce abrasion on devices extending therethrough. In a configuration, the apertures 354 can be distributed around the opening 311, which can include circumferentially or radially distributed. In a configuration, the opening 311 can be located centered relative to the plurality of apertures 354. The opening 311 can be larger than each of the apertures 354. The opening 311 can be the same as or different than the opening 310. In a configuration, the opening 311 is larger than the opening 310.

The top plate 304 and the bottom plate 306 can be offset and/or parallel from each other. The top plate 304 and the bottom plate 306 can define ends and/or opposing ends of the pole base cabinet 300. The top plate 304 and the bottom plate 306 can be flat. In a configuration, the top plate 304 and the bottom plate 306 can include recesses, curves, and/or contours. The top plate 304 and the bottom plate 306 can be positioned on a center-longitudinal axis of the pole base cabinet 300. The top plate and the bottom plate 306 can be centered on a center-longitudinal axis of the pole base cabinet 300. In a configuration, the top plate 304 can be the same as the bottom plate 306. This can be advantageous when more wiring or cables are directed into the cavity through the bottom plate 306 than out of the cavity through the top plate 306. In a configuration, the top plate 304 does not have an opening 310 and/or the bottom plate 306 does not have an opening 311.

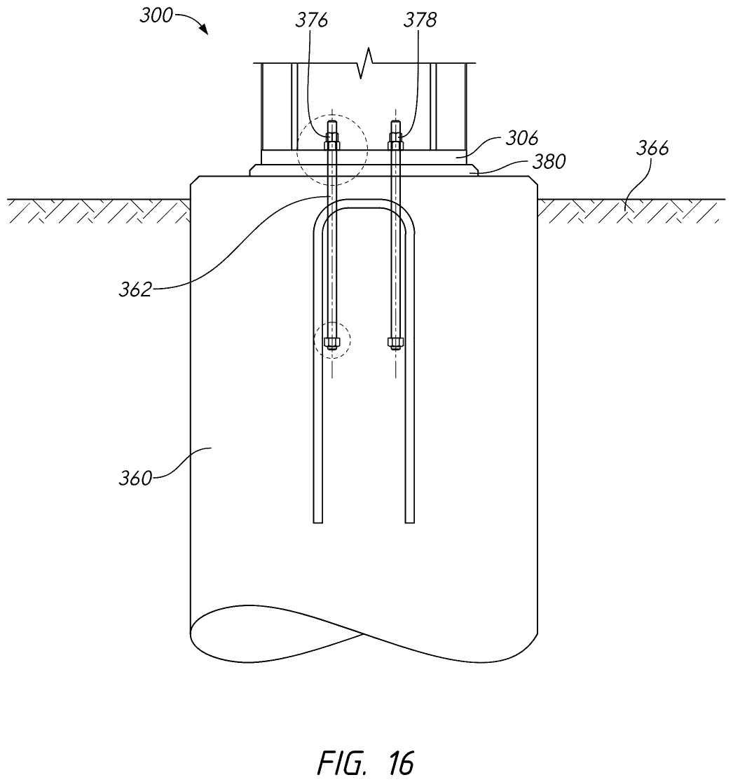

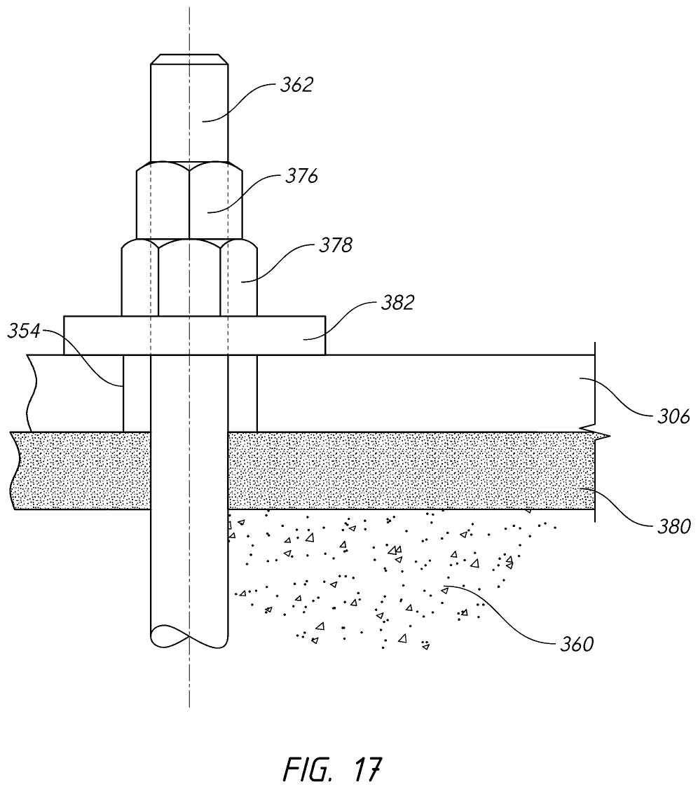

As shown in FIGS. 16 and 17, the bottom plate 306 can be coupled to the footing 360. The footing can have an anchor 362 with a portion of the anchor 362 extending out of the footing 360. The anchor 362 can extend through one of the apertures 354 of the bottom plate 306. An intermediate layer 380 can be positioned between the bottom plate 306 and the footing 360. The intermediate layer 380 can be grout, which can include a non-shrink grout. A first nut 378 can be secured on the anchor 362 to securely couple the bottom plate 306 to the footing 360. A washer 382 can be positioned between the first nut 378 and the bottom plate 306. A second nut 376 can be secured on the anchor 362 to securely couple the bottom plate 306 to the footing 360. The level of the pole base cabinet 300 can be adjusted by adjusting each of the nuts to be higher or lower. In a configuration, the level of the pole can be adjusted in a similar manner.

The pole base cabinet 300 can have a peripheral wall, side, surface 308, which can also be referred to as a skin and/or wall 308. The peripheral wall 308 can extend and/or be coupled to, which can include directly, rigidly, or fixedly connected, from the top plate 304 to the bottom plate 306. The peripheral wall 308 can extend from and/or be coupled to, which can include directly, rigidly, or fixedly connected, the periphery 330 of the top plate 304 to and/or proximate a periphery 332 of the bottom plate 306. The peripheral wall 308 can extend from a bottom surface of the top plate 304 to a top surface of the bottom plate 306. The peripheral wall 308 can define a periphery of the pole base cabinet 300, which can be circular, polygonal, irregular, and/or other shapes. The peripheral wall 308 can define a periphery of the pole base cabinet 300 that can be the same as or similar to the shape of the periphery 330 of the top plate 204 and/or periphery 332 of the bottom plate 306. The peripheral wall 308 can define a rounded periphery of the pole base cabinet 300, which can be similar to a tube. The peripheral wall 308 can define a main opening. The main opening can provide access into a cavity of the pole base cabinet 300. The cavity can be centrally located in the pole base cabinet 300. The cavity can house items and/or components, which can include the items and/or components detailed herein. The main opening can be varying sizes and shapes, which can include circular, polygonal, irregular, and/or others. In a configuration, the main opening can be rectangular in shape. The main opening can extend to or proximate the top plate 304 and proximate the bottom plate 306.

The main opening can be covered with a door 302, as shown in FIG. 12, permanently or temporarily preventing and/or restricting access to the cavity. The main opening can be uncovered by the door 302 to allow access to the cavity. In a configuration, the door 302 can be releasably or fixedly coupled to the pole base cabinet 300 with a hinge allowing the door 302 to be swung open and closed while remaining coupled to the pole base cabinet 300. The door 302 can have a curvature matching a curvature of the peripheral wall 308. The door 302 can have a perimeter or periphery that matches the main opening such that the door 302 can cover the main opening. The door 302 can be a thickness matching that of the peripheral wall 308.

The pole base cabinet 300 can have a frame which can include a plurality of support panels and/or one or more internal stiffening panels. In a configuration, the peripheral wall 308 can be coupled to the frame, which can include being coupled, which can include directly, rigidly, or fixedly connected, such as being welded and spot welded to the portions of the frame. The plurality of support panels can include a first support panel, plank, girder, joist, pillar, plank, brace, beam 334, second support panel, plank, girder, joist, pillar, plank, brace, beam 336, and/or a third support panel, plank, girder, joist, pillar, plank, brace, beam 338, as shown in FIGS. 12, 15, and 13. The first support panel 334, second support panel 336, and/or a third support panel 338 of pole base cabinet 300 can be the same as or similar to the first support panel 234, second support panel 236, and/or a third support panel 238 of the pole base cabinet 200.

The first support panel 334, second support panel 336, and/or a third support panel 338 can at least partially define a cavity, similar to cavity 220. The first support panel 334, second support panel 336, and/or a third support panel 338 can extend between and/or be coupled to, which can include directly, rigidly, or fixedly connected, the top plate 304 and the bottom plate 306. The first support panel 334, second support panel 336, and/or a third support panel 338 can form three sides of a rectangular-like structure surrounding or at least partially surrounding the cavity. The first support panel 334, second support panel 336, and/or a third support panel 338 can be the same or similar size and shape. The first support panel 334, second support panel 336, and/or a third support panel 338 can be different sizes and shapes. The first support panel 334, second support panel 336, and/or a third support panel 338 can be rectangular panels. The first support panel 334 can be offset from the second support panel 336. The first support panel 334 and second support panel 336 can be parallel to each other. The third support panel 338 can extend between and/or be coupled to, which can include directly, rigidly, or fixedly connected, the first support panel 334 and second support panel 336. The third support panel 338 can extend between and/or be coupled to, which can include directly, rigidly, or fixedly connected, ends or proximate ends of the first support panel 334 and second support panel 336. The third support panel 338 can extend between and/or be coupled to, which can include directly, rigidly, or fixedly connected, ends or proximate ends of first support panel 334 and second support panel 336 that are opposite a main opening. The third support panel 238 can be positioned opposite the main opening. As shown in FIG. 13, the third support panel 338 can be proximate the ends, which can include inset from the ends, of the first support panel 234 and second support panel 336.

The frame of the pole base cabinet 300 can have one more internal stiffening panels, which can include a first internal stiffening panel, plank, girder, joist, pillar, plank, brace, beam 340, as shown in FIGS. 12 and 13. The first internal stiffening panel 340 of pole base cabinet 300 can be the same as or similar to the first internal stiffening panel 240. In a configuration, the first support panel 334, second support panel 336, third support panel 338, and/or first internal stiffening panel 340 is spaced away from the peripheral wall 308. The peripheral wall 308, and others described herein, can be non-load bearing.

The first internal stiffening panel 340 can be coupled to, which can include directly, rigidly, or fixedly connected, the top plate 304. The first internal stiffening panel 340 can extend perpendicularly away from the top plate 304. The first internal stiffening panel 340 can extend to a position between the top plate 304 and the bottom plate 306, providing room for items to be store in the cavity. The first internal stiffening panel 340 can be a rectangular panel. The first internal stiffening panel 240 can be straight or curved. The first internal stiffening panel 340 can extend between, which can include directly, rigidly, or fixedly connected, the first support panel 334 and the second support panel 336. The first internal stiffening panel 340 can extend between and/or be coupled to, which can include directly, rigidly, or fixedly connected, ends or proximate ends of the first support panel 334 and the second support panel 336. The first internal stiffening panel 340 can be positioned proximate the main opening and/or door 302. The first internal stiffening panel 340 can be positioned opposite the third support panel 338. The first internal stiffening panel 340 can be offset from and/or parallel to the third support panel 338. The plurality of apertures 312 can be positioned between the first internal stiffening panel 340 and the third support panel 338. The first internal stiffening panel 340 can be a width that is the same as the third support panel 338. As shown in FIG. 13, the first internal stiffening panel 340 can be proximate the ends, which can include inset from the ends, of the first support panel 334 and second support panel 336.

The thickness and/or material of the varying components of the pole base cabinet 300 can vary depending on the desired structural integrity. For example, materials such as metals (such as steel, high strength steel, aluminum, and/or others), metal alloys, polymers (such as plastic), ceramics, and/or others can be used. For example, each of the plurality of support panels can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The internal stiffening panel can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The peripheral wall can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The top plate and/or bottom plate can have thicknesses of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Relatedly, the components listed above can have varying widths, heights, and/or lengths to provide a desired size. For example, the pole base cabinet 300 can have an overall diameter or width of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches or height or length of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches. These are example ranges, such that other dimensions can be employed that are not explicitly listed herein.

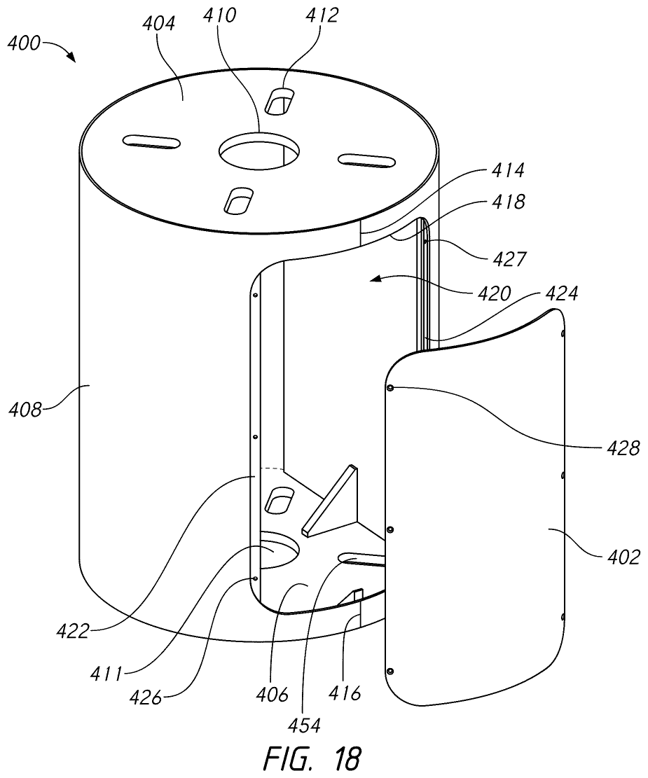

With reference to FIGS. 18-22, a pole base cabinet, casing, housing, enclosure, locker 400 is described. Pole base cabinet 400 can include substantially the same or similar features described or shown herein in reference to other configurations of pole base cabinets. Similarly numbered features can be the same or similar. The top half of the pole base cabinet 400 can mirror the bottom half. A lateral half of the pole base cabinet 400 can mirror the other lateral half.

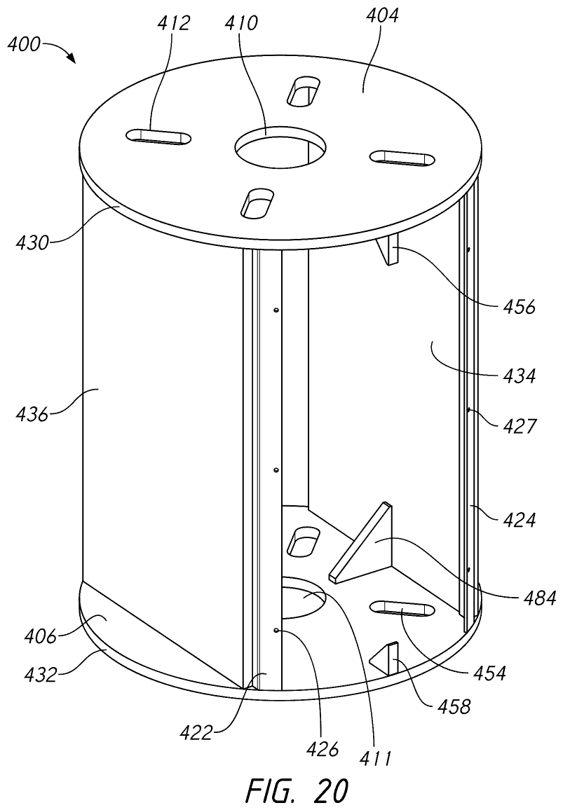

As shown in FIG. 18, the pole base cabinet 400 can have a top or first plate, disc, sheet 404. The top plate 404 can have an opening 410. The top plate 404 can have a plurality of apertures 412. The top plate 404 can have a periphery 430, as shown in FIG. 20.

The pole base cabinet 400 can have a bottom plate or second, disc, sheet 406. The bottom plate 406 can be the same or similar to the top plate 404. The bottom plate 406 can have an opening 411. The bottom plate 406 can have a periphery 432, as shown in FIG. 20.

The pole base cabinet 400 can have a peripheral wall, side, surface 408. The peripheral wall 408 can extend from and/or be coupled to, which can include directly, rigidly, or fixedly connected, the top plate 404 to the bottom plate 406. The peripheral wall 408 can extend from and/or be coupled to, which can include directly, rigidly, or fixedly connected, the periphery 430 of the top plate 404 to the periphery 432 of the bottom plate 406. The peripheral wall 408 can define a periphery of the pole base cabinet 400, which can be circular, polygonal, irregular, and/or other shapes. In a configuration, similar to the peripheral wall 208, the peripheral wall 408 can be manipulated from a disassembled state to the treated or manipulated state shown in FIG. 18 by forming the peripheral wall 208 into the rounded tube-like configuration such that the peripheral wall 408 can be coupled to, which can include directly, rigidly, or fixedly connected, or proximate itself at the top joint 414 and the bottom joint 416. In a configuration, the peripheral wall 408 can be manufactured in the configuration illustrated in FIG. 18 such that there is no top joint 414 and/or bottom joint 416.

The peripheral wall 408 can define a main opening 418. The main opening 418 can provide access into a cavity 420 of the pole base cabinet 400. The cavity 420 can house or contain items and/or components, which can include the items and components detailed herein.

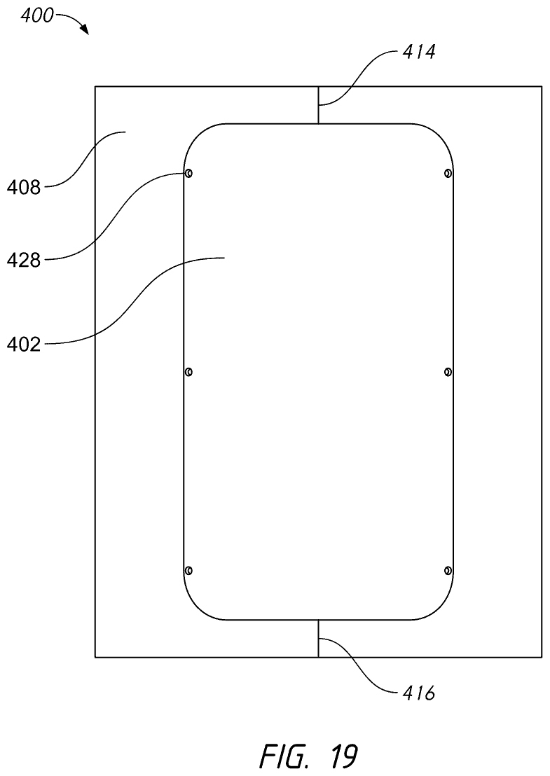

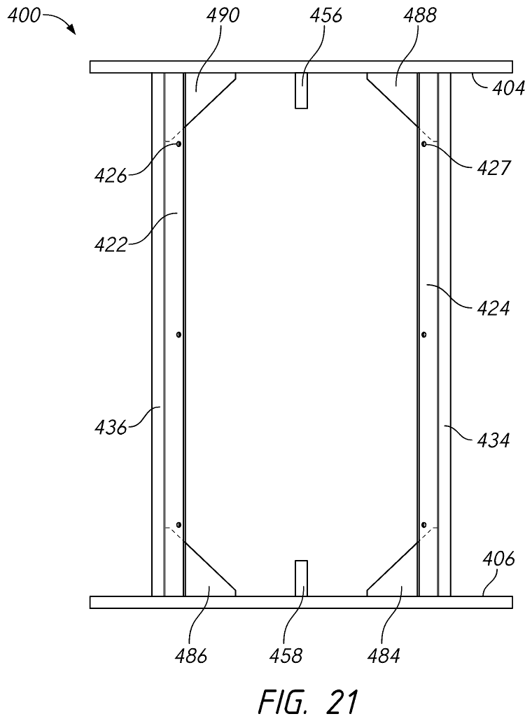

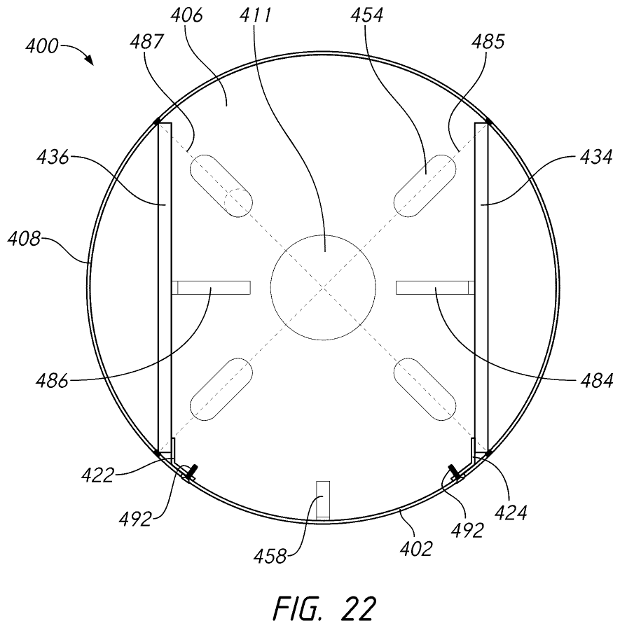

The main opening 418 can be covered with a door 402, as shown in FIG. 19, permanently or temporarily preventing and/or restricting access to the cavity 420, which can include by releasably coupling. The main opening 418 can be uncovered with the door 402 removed, as shown in FIG. 18, to allow access to the cavity 420. The door 402 can include a plurality of door apertures 428. The door apertures can be used to couple the door 402 to the pole base cabinet 400. The door apertures 428 can correspond to flange apertures 426, 427 positioned on a first flange, rim, border, frame, lip 424 and/or a second flange, rim, border, frame, lip 422 of the pole base cabinet. The door can be coupled to the pole base cabinet 400 by placing the door 402 over the main opening 418 such that the door apertures 428 are aligned with the flange apertures 426, 427 and inserting a bolt, screw, rivet, and/or other similar device 492 through the door apertures 428 and the flange apertures 426, 427. The first flange 424 and/or the second flange 422 can be similar or the same as to the first flange 224 and/or the second flange 222. In a configuration, as shown in FIG. 22, the first flange 424 and/or the second flange 422 can be coupled to internal surfaces of the first support panel 434 and the second support panel 436, respectively.

As shown in FIGS. 18 and 20-22, the pole base cabinet 400 can include a frame that can include a plurality of support panels. The plurality of support panels can include a first support panel, plank, girder, joist, pillar, plank, brace, beam 434 and a second support panel, plank, girder, joist, pillar, plank, brace, beam 436. The first support panel 434 and the second support panel 436 can be configured the same as or similar to the first support panel 434 and the second support panel 236 the pole base cabinet 200. The peripheral wall 408 can be coupled, which can include directly, rigidly, or fixedly connected, to the ends or proximate the ends of the first support panel 434 and the second support panel 436.

As shown in FIG. 22, a first plane 485 can extend through where the first support panel 434 is coupled to the peripheral wall 208, two of the plurality of apertures 454, the opening 411, and where the second support panel 436 is coupled to the peripheral wall 208. A second plane 487 can extend through where the first support panel 434 is coupled to the peripheral wall 208, two of the plurality of apertures 454, the opening 411, and where the second support panel 436 is coupled to the peripheral wall 208. The first plane 485 can be perpendicular to the second plane 487. The first plane 485 and the second plane 487 can intersect at the opening 411.

As shown in FIG. 21, the pole base cabinet 400 can have a plurality of support tabs, projections, protrusions, bosses, stiffeners, which can include a first top support tab 488, second top support tab 490, first bottom support tab 484, and/or second bottom support tab 486. The first top support tab 488, second top support tab 490, first bottom support tab 484, and/or second bottom support tab 486 can be the same or different size and shape. The first top support tab 488, second top support tab 490, first bottom support tab 484, and/or second bottom support tab 486 can be triangular.

The first top support tab 488 can be coupled to, which can include directly, rigidly, or fixedly connected, the top plate 404. The first top support tab 488 can be coupled to, which can include directly, rigidly, or fixedly connected, the first support panel 434. As shown in FIG. 22, the first top support tab 488 can be positioned at and/or be coupled to, which can include directly, rigidly, or fixedly connected, a middle portion of the first support panel 434. The first top support tab 488 can be centered in the width direction of the first support panel 434.

The second top support tab 490 can be coupled to, which can include directly, rigidly, or fixedly connected, the top plate 404. The second top support tab 490 can be coupled to, which can include directly, rigidly, or fixedly connected, the second support panel 436. As shown in FIG. 22, the second top support tab 490 can be positioned at and/or be coupled to, which can include directly, rigidly, or fixedly connected, a middle portion of the second support panel 436. The second top support tab 490 can be centered in the width direction of the second support panel 436.

The first bottom support tab 484 can be coupled to, which can include directly, rigidly, or fixedly connected, the bottom plate 406. The first bottom support tab 484 can be coupled to, which can include directly, rigidly, or fixedly connected, the first support panel 434. As shown in FIG. 20, the first bottom support tab 484 can be positioned at a middle portion of the first support panel 434. The first bottom support tab 484 can be centered in the width direction of the first support panel 434.

The second bottom support tab 486 can be coupled to, which can include directly, rigidly, or fixedly connected, the bottom plate 406. The second bottom support tab 486 can be coupled to, which can include directly, rigidly, or fixedly connected, the second support panel 436. The second bottom support tab 486 can be positioned at a middle portion of the second support panel 436. The second bottom support tab 486 can be centered in the width direction of the second support panel 436.

The pole base cabinet 400 can have a top tab projection, protrusion, boss, stiffener 456 and/or a bottom tab projection, protrusion, boss, stiffener 458, as shown in FIG. 20. The top tab 456 and/or bottom tab 458 can be configured as the top tab 256 and/or bottom tab 258 of pole base cabinet 200.

The thickness and/or material of the varying components of the pole base cabinet 400 can vary depending on the desired structural integrity. For example, each of the plurality of support panels can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Each of the plurality of support tabs can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The peripheral wall can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Each of the plurality of tabs can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The top plate and/or bottom plate can have thicknesses of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Relatedly, the components listed above can have varying widths, heights, and/or lengths to provide a desired size. For example, the pole base cabinet 400 can have an overall diameter or width of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches and/or height or length of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches. These are example ranges, such that other dimensions can be employed that are not explicitly listed herein.

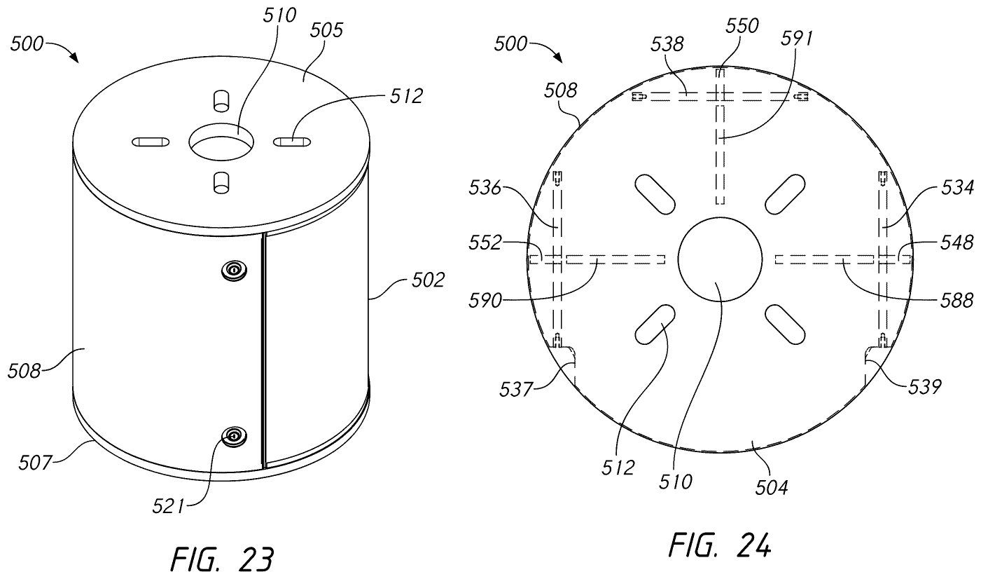

With reference to FIGS. 23-28, a pole base cabinet, casing, housing, enclosure, locker 500 is described. Pole base cabinet 500 can include substantially the same or similar features described or shown herein in reference to other configurations of pole base cabinets. Similarly numbered features can be the same or similar.

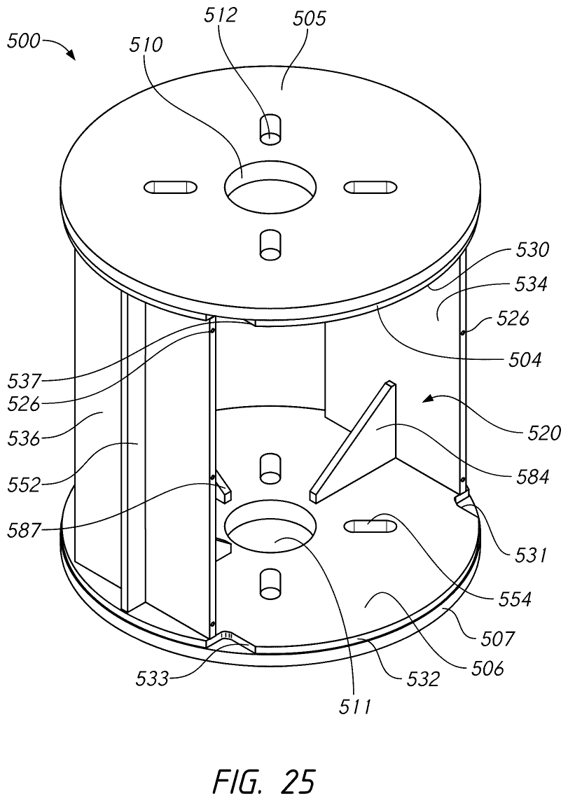

As shown in FIG. 25, the pole base cabinet 500 can have a top or first plate, disc, sheet 504. The top plate 504 can be the same as the top plate 404 except that the top plate 504 is thinner and/or can have a first cutout 539 and/or second cutout 537. The top plate 504 can have an opening 510 and/or a plurality of apertures 512. The first top cutout 539 and the second top cutout 537 can be notches in the periphery 530 of the top plate 504. The first top cutout 539 and the second top cutout 537 can be positioned proximate the main opening and/or door 520. A secondary top plate 505 that is the same as the top plate 404 can be positioned above the top plate 504.

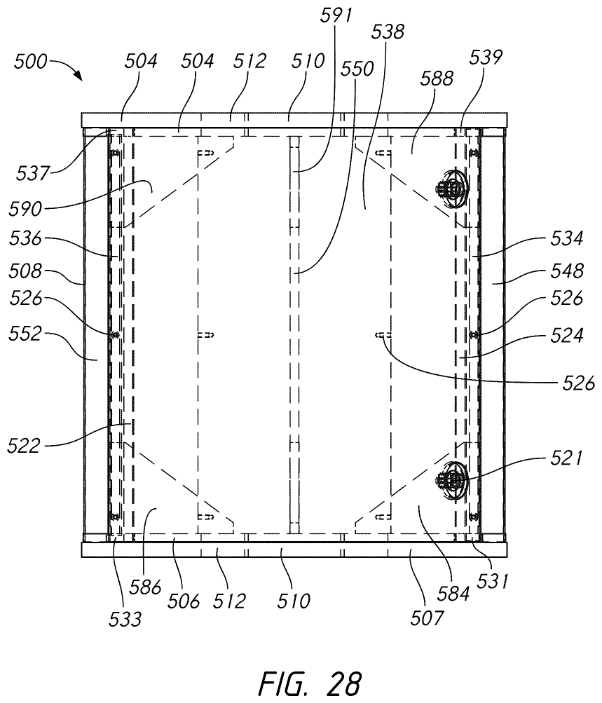

The pole base cabinet 500 can have a bottom or second plate, disc, sheet 506. The bottom plate 506 can be the same as the top plate 504, having a first bottom cutout 531 and/or second bottom cutout 533. The bottom plate 506 can have an opening 511 and/or a plurality of apertures 554. The first bottom cutout 531 and/or second bottom cutout 533 can be notches in the periphery 532 of the bottom plate 506. The first top cutout 539, the second top cutout 537, first bottom cutout 531, and/or second bottom cutout 533 can receive ends of a first flange, rim, border, frame, lip 524 and/or second flange, rim, border, frame, lip 522, shown in FIG. 28. The door 502 can be releasably coupled to the pole base cabinet 500 and/or first flange 524 and/or the second flange 522. The door 502, shown in FIG. 23, can be secured to the first flange 524 and/or the second flange 522 with fasteners 521, which can be rivets, screws, bolts, and/or other similar devices. A secondary bottom plate 507 that is the same as the secondary top plate 505 can be positioned below the bottom plate 506.

A peripheral wall, side, surface 508 can extend between and/or be coupled to, which can include directly, rigidly, or fixedly connected, the top plate 504 and the bottom plate 506. Specifically, the peripheral wall 508 can extend from and/or be coupled to, which can include directly, rigidly, or fixedly connected, the periphery 530 of the top plate 504 to the periphery 532 of the bottom plate 506. The peripheral wall 508 can extend from and/or be coupled to, which can include directly, rigidly, or fixedly connected, a bottom surface of the secondary top plate 505 to a top surface of the secondary bottom plate 507.

As shown in FIGS. 24-26, the pole base cabinet 500 can have a frame to provide structure support that can include a plurality of support panels and/or external stiffening panels. The plurality of support panels can include a first support panel, plank, girder, joist, pillar, plank, brace, beam 534, second support panel, plank, girder, joist, pillar, plank, brace, beam 536, and/or the third support panel, plank, girder, joist, pillar, plank, brace, beam 538. The first support panel 534, second support panel 536, and/or the third support panel 538 can extend between and/or be coupled to, which can include directly, rigidly, or fixedly connected, the top plate 504 and the bottom plate 506. The first support panel 534, second support panel 536, and/or the third support panel 538 can be the same or different sizes and shapes. The first support panel 534, second support panel 536, and/or the third support panel 538 can be rectangular panels. The first support panel 534, second support panel 536, and/or the third support panel 538 can be positioned proximate the peripheral wall 508, the periphery 530 of the top plate 504, and/or the periphery 532 of the bottom plate 506. The first support panel 534, second support panel 536, and/or the third support panel 538 can all have openings 526 which can be used for coupling. The first support panel 534 and/or second support panel 536 can be offset and/or parallel to each other. The third support panel 538 can be oriented perpendicularly relative to the first support panel 534 and second support panel 536. The first support panel 534 and second support panel 536 can be on opposing side of the main opening and/or door 502.

The plurality of external stiffening panels can include a first external stiffening panel, plank, girder, joist, pillar, plank, brace, beam 548, second external stiffening panel, plank, girder, joist, pillar, plank, brace, beam 552, and/or a third external stiffening panel, plank, girder, joist, pillar, plank, brace, beam 550. The first external stiffening panel 548, second external stiffening panel 552, and/or a third external stiffening panel 550 can be configured the same as the first external stiffening panel 248, second external stiffening panel 252, and/or a third external stiffening panel 250 of the pole base cabinet 200. The first external stiffening panel 548, second external stiffening panel 552, and/or a third external stiffening panel 550 can each, respectively, be connected to a side of the first support panel 534, second support panel 536, and/or the third support panel 538 that is opposite another side upon which the plurality of top support tabs (first top support tab 588, second top support tab 590, and/or third top support tab 591) and the plurality of bottom support tabs (first bottom support tab 584, second bottom support tab 586, and/or third bottom support tab 587) are connected.

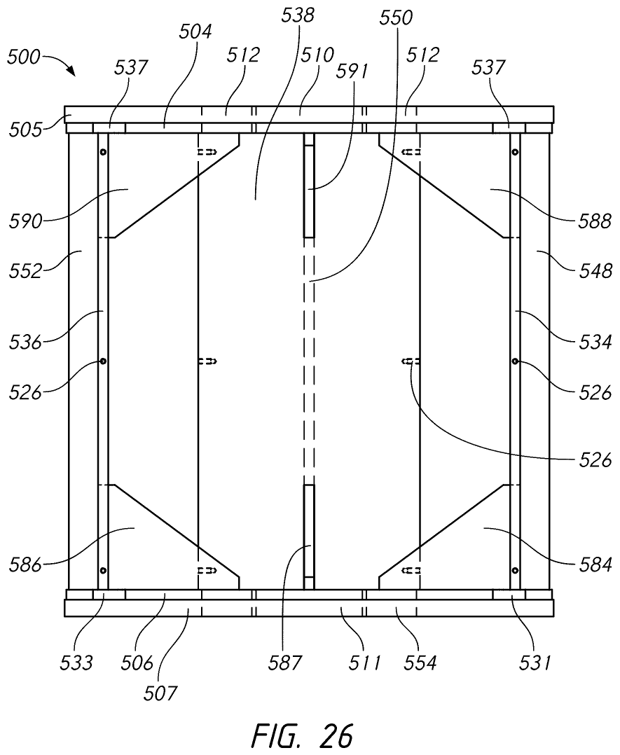

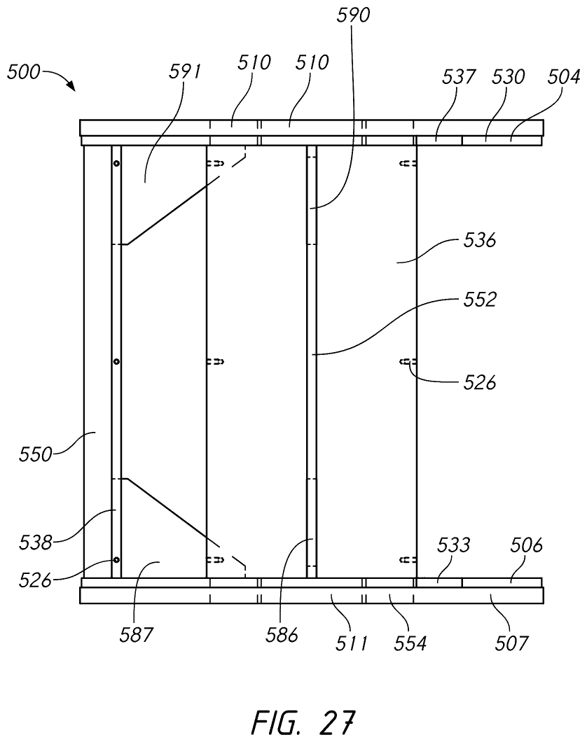

As shown in FIGS. 26 and 27, the pole base cabinet 500 can have a plurality of support tabs, projections, protrusions, bosses, stiffeners, which can include a first top support tab 588, second top support tab 590, third top support tab 591, first bottom support tab 584, second bottom support tab 586, and/or third bottom support tab 587. The first top support tab 588, second top support tab 590, third top support tab 591, first bottom support tab 584, second bottom support tab 586, and/or third bottom support tab 587 can be the same or different size and shape. The first top support tab 588, second top support tab 590, third top support tab 591, first bottom support tab 584, second bottom support tab 586, and/or third bottom support tab 587 can be triangular. The first top support tab 588, second top support tab 590, third top support tab 591, first bottom support tab 584, second bottom support tab 586, and/or third bottom support tab 587 can extend radially inward toward a central longitudinal axis of the pole base cabinet 500. The third top support tab 591 and the third bottom support tab 587 can be oriented perpendicularly to the first top support tab 588, second top support tab 590, first bottom support tab 584, and/or the second bottom support tab 586.

The first top support tab 588 can be coupled to, which can include directly, rigidly, or fixedly connected, the top plate 504. The first top support tab 588 can be coupled to, which can include directly, rigidly, or fixedly connected, the first support panel 534. As shown in FIG. 24, the first top support tab 588 can be positioned at a middle portion of the first support panel 534. The first top support tab 588 can be centered in the width direction of the first support panel 534.

The second top support tab 590 can be coupled to, which can include directly, rigidly, or fixedly connected, the top plate 504. The second top support tab 590 can be coupled to, which can include directly, rigidly, or fixedly connected, the second support panel 536. As shown in FIG. 24, the second top support tab 590 can be positioned at a middle portion of the second support panel 536. The second top support tab 590 can be centered in the width direction of the second support panel 536.

The third top support tab 591 can be coupled to, which can include directly, rigidly, or fixedly connected, the top plate 504. The third top support tab 591 can be coupled to, which can include directly, rigidly, or fixedly connected, the third support panel 538. As shown in FIG. 24, the third top support tab 591 can be positioned at a middle portion of the third support panel 538. The third top support tab 591 can be centered in the width direction of the third support panel 538.

The first bottom support tab 584 can be coupled to, which can include directly, rigidly, or fixedly connected, the bottom plate 506. The first bottom support tab 584 can be coupled to, which can include directly, rigidly, or fixedly connected, the first support panel 534. The first bottom support tab 584 can be positioned at a middle portion of the first support panel 534. The first bottom support tab 584 can be centered in the width direction of the first support panel 534.

The second bottom support tab 586 can be coupled to, which can include directly, rigidly, or fixedly connected, the bottom plate 506. The second bottom support tab 586 can be coupled to, which can include directly, rigidly, or fixedly connected, the second support panel 536. The second bottom support tab 586 can be positioned at a middle portion of the second support panel 536. The second bottom support tab 586 can be centered in the width direction of the second support panel 536.

The third bottom support tab 587 can be coupled to, which can include directly, rigidly, or fixedly connected, the bottom plate 506. The third bottom support tab 587 can be positioned at a middle portion of the third support panel 538. The third bottom support tab 587 can be centered in the width direction of the third support panel 538.

The thickness and/or material of the varying components of the pole base cabinet 500 can vary depending on the desired structural integrity. For example, each of the plurality of support panels can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Each of the plurality of support tabs can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Each of the plurality of external stiffening panels can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The peripheral wall can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The top plate and/or bottom plate can have thicknesses of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Relatedly, the components listed above can have varying widths, heights, and/or lengths to provide a desired size. For example, the pole base cabinet 500 can have an overall diameter or width of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches and/or height or length of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches. These are example ranges, such that other dimensions can be employed that are not explicitly listed herein.

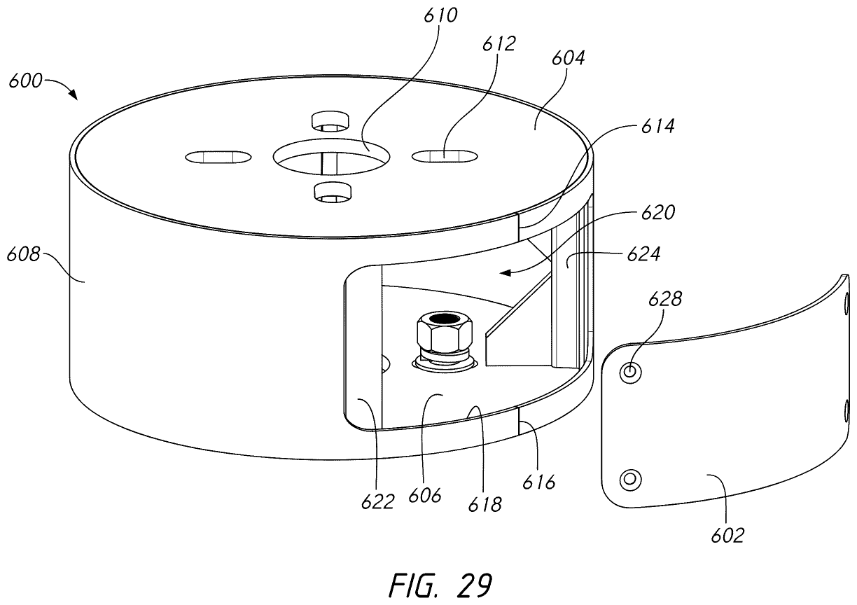

With reference to FIGS. 29-33, a pole base cabinet, casing, housing, enclosure, locker 600 is described. Pole base cabinet 600 can include substantially the same or similar features described or shown herein in reference to other configurations of pole base cabinets. Similarly numbered features can be the same or similar.

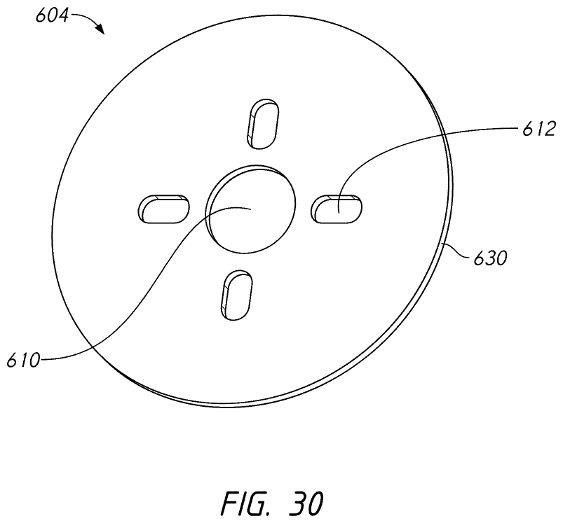

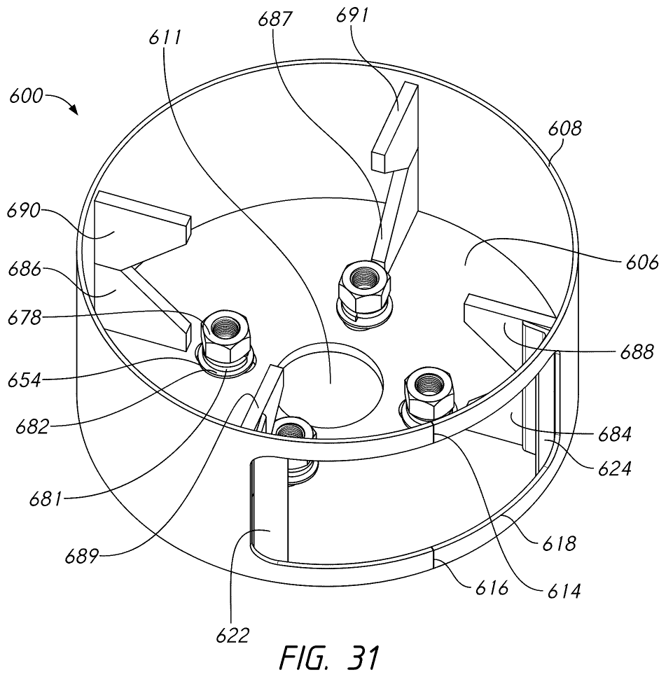

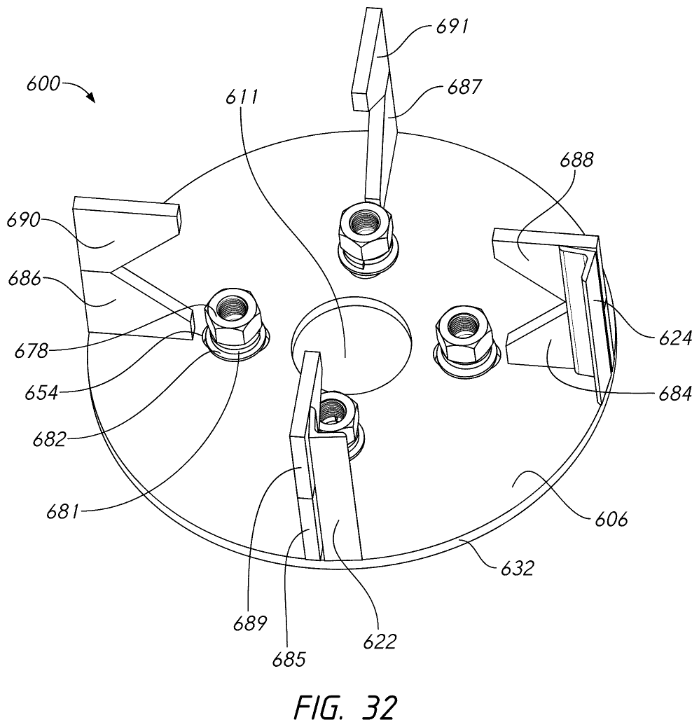

As shown in FIG. 29, the pole base cabinet 600 can have a top or first plate, disc, sheet 604. The top plate 604 can have a periphery 630, as shown in FIG. 30. The top plate 604 can have an opening 610. The top plate 604 can have a plurality of apertures 612 used to couple the top plate 604 to a pole base. The top plate 604 can be similar to the top plate 204 but the plurality of apertures 612 can be elongate apertures with rounded ends. The pole base cabinet 600 can have a bottom or second plate, disc, sheet 606. The bottom plate 606, as shown in FIGS. 31 and 32, can be the same as the top plate 604. A washer 682, lock nut 681, and/or nut 678 can be used to couple the bottom plate 606 or top plate 604 to a bolt or anchor extending through the apertures 654 or 612.

A peripheral wall, side, surface 608 can extend between and/or be coupled to, which can include directly, rigidly, or fixedly connected, the top plate 604 and the bottom plate 606. The peripheral wall 608 can define a main opening 618 that allows access to a cavity 620. The peripheral wall 608 can be formed in a similar manner described in reference to the peripheral wall 208, resulting in the top joint 614 and/or the bottom joint 616. In a configuration, the peripheral wall 608 is manufactured or formed without creating a top joint 614 and/or bottom joint 616.

The main opening 618 can be covered by a door 602. The door 602 can releasably couple to the pole base cabinet 600, periphery of the main opening 618, and/or first flange, rim, border, frame, lip 624 and/or the second flange, rim, border, frame, lip 622. The door 602 can cover the main opening 618, restricting access to the cavity 620. The door 602 can uncover the main opening 618, as illustrated in FIG. 29, to allow access to the cavity 620. The door 602 can include door apertures 628. The door apertures 628 can be used to couple the door 602 to the pole base cabinet 600. Specifically, the door apertures 628 can be used to couple the door 602 to the first flange 624 and/or the second flange 622, described in more detail below.

The pole base cabinet, as shown in FIGS. 31 and 30, can include a plurality of support tabs, projections, protrusions, bosses, stiffeners, which can include a first top support tab 688, second top support tab 691, third top support tab 690, fourth top support tab 689, first bottom support tab 684, second bottom support tab 687, third bottom support tab 686, and/or fourth bottom support tab 685. The first top support tab 688, second top support tab 691, third top support tab 690, and/or fourth top support tab 689 can be coupled to, which can include directly, rigidly, or fixedly connected, the top plate 604. The first top support tab 688, second top support tab 691, third top support tab 690, and/or fourth top support tab 689 can be equally and/or unequally spaced apart from each other and/or distributed around the top plate 604, which can include being equally and/or unequally spaced apart and/or distributed around the opening 610 of the top plate 604, the top plate 604, and/or a central axis of the top plate 604. The first bottom support tab 684, second bottom support tab 687, third bottom support tab 686, and/or fourth bottom support tab 685 can be coupled to, which can include directly, rigidly, or fixedly connected, the bottom plate 606. The first bottom support tab 684, second bottom support tab 687, third bottom support tab 686, and/or fourth bottom support tab 685 can be equally and/or unequally spaced apart from each other and/or distributed around the bottom plate 606, which can include being equally and/or unequally spaced apart from each other and/or distributed around the bottom plate 606, the opening 611, and/or a central axis of the bottom plate 606.

The first top support tab 688, second top support tab 691, third top support tab 690, and/or fourth top support tab 689 can extend radially inward from the periphery 630 of the top plate 604. The first bottom support tab 684, second bottom support tab 687, third bottom support tab 686, and/or fourth bottom support tab 685 can extend radially inward from the periphery 632 of the bottom plate 606.

The first top support tab 688 can be coupled to, which can include directly, rigidly, or fixedly connected, the first bottom support tab 684 such that the first top support tab 688 and first bottom support tab 684 together extend between the top plate 604 and the bottom plate 606. The second top support tab 691 can be coupled to, which can include directly, rigidly, or fixedly connected, the second bottom support tab 687 such that the second top support tab 691 and the second bottom support tab 687 together extend between the top plate 604 and the bottom plate 606. The third top support tab 690 can be coupled to, which can include directly, rigidly, or fixedly connected, the third bottom support tab 686 such that the third top support tab 690 and the third bottom support tab 686 together extend between the top plate 604 and the bottom plate 606. The fourth top support tab 689 and the fourth bottom support tab 685 can be coupled together, which can include directly, rigidly, or fixedly connected, such that the fourth top support tab 689 and the fourth bottom support tab 685 together extend between the top plate and the bottom plate 606.

The first top support tab 688, first bottom support tab 684, third top support tab 690, and/or third bottom support tab 686 can be coplanar. A first plane can extend through the first top support tab 688, first bottom support tab 684, third top support tab 690, third bottom support tab 686, and/or two of the apertures 654. The second top support tab 691, second bottom support tab 687, fourth top support tab 689, and/or fourth bottom support tab 685 can be coplanar. A second plane can extend through the second top support tab 691, second bottom support tab 687, fourth top support tab 689, fourth bottom support tab 685 and/or two of the apertures 654. The first plane and the second plane can be perpendicularly oriented relative to each other.

The first top support tab 688 and first bottom support tab 684 can be positioned proximate the main opening 618, as shown in FIG. 31. The fourth top support tab 689 and fourth bottom support tab 685 can be positioned proximate the main opening 618, as shown in FIG. 31. The main opening 618 can separate and/or extend between the first top support tab 688 and first bottom support tab 684, and the fourth top support tab 689 and fourth bottom support tab 685.

The first flange 624 can be coupled to, which can include directly, rigidly, or fixedly connected, the first top support tab 688 and first bottom support tab 684. The second flange 622 can be coupled to the fourth top support tab 689 and fourth bottom support tab 685. The first flange 624 and the second flange 622 can extend into the opening 618. The first flange 624 and the second flange 622 extend between the top plate 604 and the bottom plate 606. The first flange 624 and/or the second flange 622 can be coupled to, which can include directly, rigidly, or fixedly connected, the top plate 604 and/or the bottom plate 606. The first flange 624 and/or the second flange 622 can be positioned proximate the periphery 630 of the top plate 604 and/or the periphery 632 of the bottom plate 606. The first flange 624 and the second flange 622 can be the same size and shape.

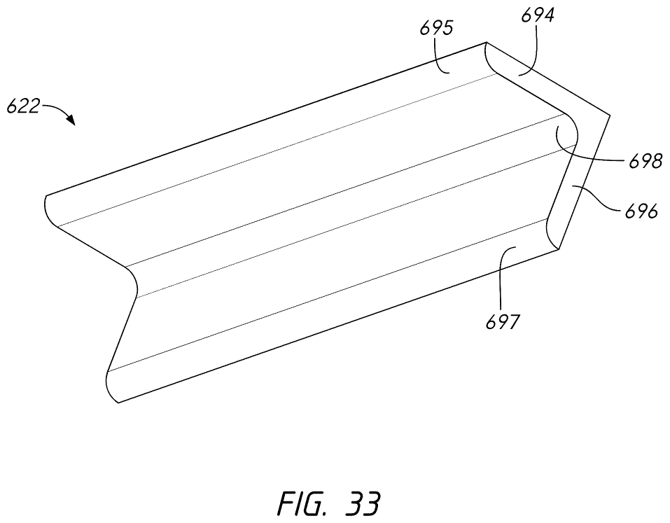

As shown in FIG. 33, the first flange 624 and the second flange 622 can have a first side 694 and a second side 696. The first side 694 and/or the second side 696 can be coupled to, which can include directly, rigidly, or fixedly connected, the first top support tab 688, first bottom support tab 684, fourth top support tab 689, and fourth bottom support tab 685. The first side 694 and the second side 696 can be perpendicularly oriented relative to each other. The first side 694 has an end 695 that can be curved. The second side 696 has an end 697 that can be curved. A curve 698 can extend between the first side 694 and the second side 696.

The thickness and/or material of the varying components of the pole base cabinet 600 can vary depending on the desired structural integrity. For example, each of the plurality of support tabs can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The peripheral wall can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The top plate and/or bottom plate can have thicknesses of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Relatedly, the components listed above can have varying widths, heights, and/or lengths to provide a desired size. For example, the pole base cabinet 600 can have an overall diameter or width of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches and/or height or length of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches. These are example ranges, such that other dimensions can be employed that are not explicitly listed herein.

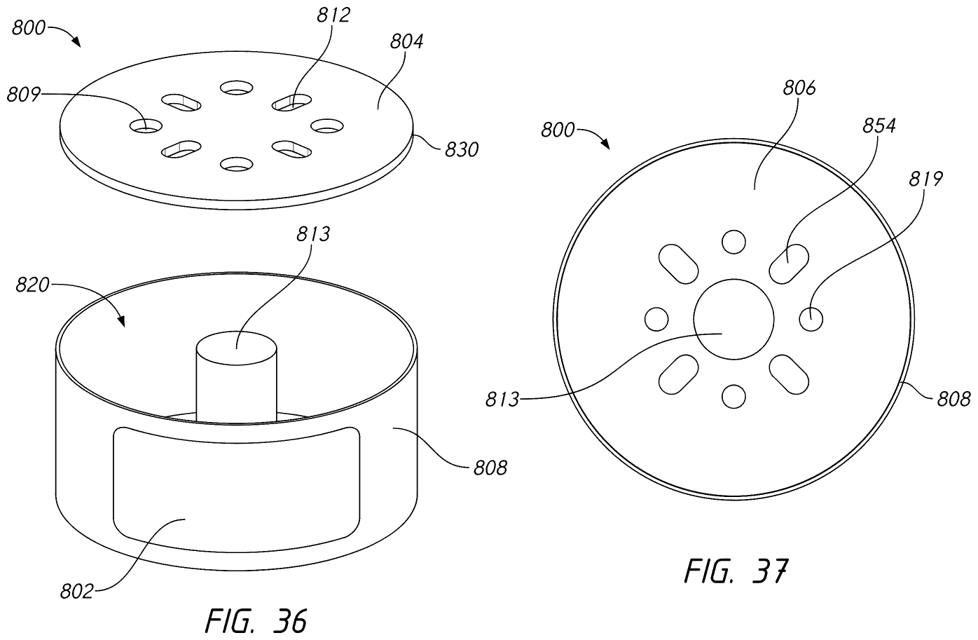

With reference to FIGS. 36-37, a pole base cabinet, casing, housing, enclosure, locker 700 is described. Pole base cabinet 700 can include substantially the same or similar features described or shown herein in reference to other configurations of pole base cabinets. Similarly numbered features can be the same or similar.

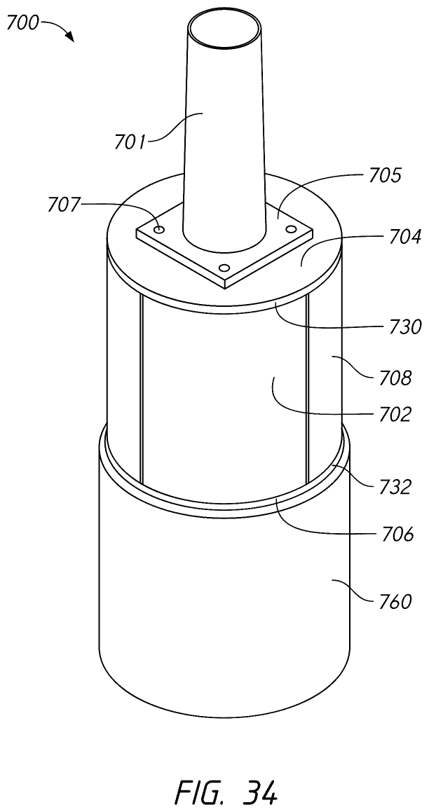

As shown in FIG. 34, a pole 701 can be mounted onto the pole base cabinet 700. Specifically, a pole base plate, baseplate 705 can be coupled to a top or first plate, disc, sheet 704 of the pole base cabinet 700. The baseplate 705 can have a plurality of apertures 707 that facilitate coupling the top plate 704 to the baseplate 705, using methods described herein (for example, using bolts, nuts, and/or washers). The top plate 704 can have a periphery 730. The pole base cabinet 700 can have a bottom plate 706. The bottom or second plate, disc, sheet 706 can have a periphery 732. A peripheral wall, side, surface 708 can extend between and/or be coupled to the top plate 704 and the bottom plate 706. The peripheral wall 708 can extend from and/or be coupled to, which can include directly, rigidly, or fixedly connected, the periphery 730 of the top plate 704 to the periphery 732 of the bottom plate 706. The peripheral wall 708 can extend from and/or be coupled to, which can include directly, rigidly, or fixedly connected, a bottom surface of the top plate 704 that is proximate the periphery 730 to a top surface of bottom plate 706 that is proximate the periphery 732. The peripheral wall 708 can define a main opening providing access into a cavity of the pole base cabinet 700 in which items can be stored. A door 702 can cover and/or uncover the main opening to restrict or provide access to the cavity. The pole base cabinet 700 can be secured to a footing 760. Specifically, the bottom plate 706 can be coupled to the footing 760.

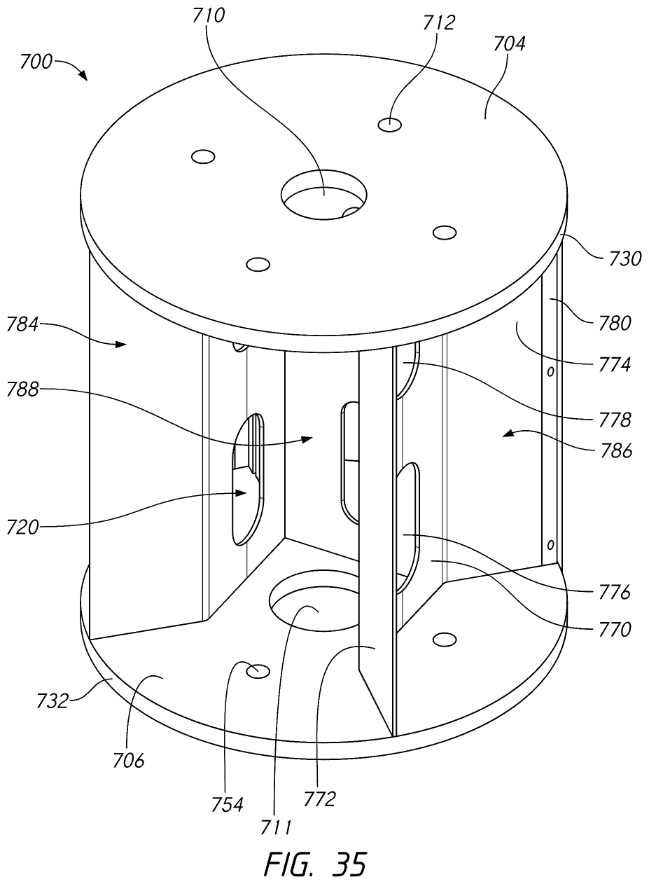

As shown in FIG. 35, the top plate, disc, sheet 704 can be the same as the top plate 204 but with the plurality of apertures 712 spaced farther away from the opening 710 than the spacing between the apertures 212 and the opening 210. The bottom plate, disc, sheet 706 can be the same as the top plate 704. The bottom plate 706 can have an opening 711 that is larger than the opening 710.

The pole base cabinet 700 can have a frame for structural support which can include a plurality of support structures or structural supports, which can include a first support structure, support structure 786, second support structure, support structure 784, and/or third support structure, support structure 788. The first support structure 786, second support structure 784, and/or third support structure 788 can be the same or different size and shape. The first support structure 786, second support structure 784, and/or third support structure 788 can at least partially define the cavity of the pole base cabinet. The first support structure 786, second support structure 784, and/or third support structure 788 can extend between the top plate 704 and the bottom plate 706. The first support structure 786, second support structure 784, and/or third support structure 788 can be coupled to, which can include directly, rigidly, or fixedly connected, the top plate 704 and/or the bottom plate 706.

The first support structure 786, second support structure 784, and third support structure 788 can each include a center panel, plank, girder, joist, pillar, plank, brace, beam 770, a first panel wing, plank, girder, joist, pillar, plank, brace, beam 772, and a second panel wing, plank, girder, joist, pillar, plank, brace, beam 774. The center panel 770 can extend between the first panel wing 772 and the second panel wing 774. The center panel 770 of each of the first support structure 786, second support structure 784, and third support structure 788 can cooperate to define a square or rectangular shape that at least partially defines a cavity 720 of the pole base cabinet 700. The center panel 770 of each of the first support structure 786, second support structure 784, and third support structure 788 can be offset from and/or at least partially surround the opening 711 of the bottom plate 706 and opening 710 of the top plate. The center panel 770 of the first support structure 786 can be offset from and/or parallel to the center panel 770 of the second support structure 784. The center panel 770 of the third support structure 788 can extended between the center panels 770 of the first support structure 786 and the second support structure 784. The center panel 770 of the third support structure 788 can be perpendicular to the center panel 770 of each of the first support structure 786 and the second support structure 784. The center panel 770 can have a top opening 778 and/or a bottom opening 776. The top opening 778 and/or bottom opening 776 can be elongate openings with rounded ends. The top opening 778 and/or the bottom opening 776 can enable wires, cords, optical fibers, and other similar devices to be routed therethrough.

The first panel wing, first wing panel 772 and the second panel wing, second panel wing 774 can extend away from the center/central panel 770 at an angle, which can be the same or different angle. In a configuration, the first panel wing 772 and the second panel wing 774 extend to or proximate the periphery 730 of the top plate 704 and the periphery 732 of the bottom plate 706. In a configuration, the first panel wing 772 and the second panel wing 774 extend, couple (such as directly, rigidly, or fixedly connected), or be proximate to the peripheral wall 708. In a configuration, the top plate 704, bottom plate 706, first panel wing 772 of the first support structure 786, and second panel wing 774 of the second support structure 784 define the main opening of the pole base cabinet 700. In a configuration, the peripheral wall 708 extends from and/or can be coupled to (which can include directly, rigidly, or fixedly connected) the first panel wing 772 of the first support structure 786 to the second panel wing 774 of the second support structure 784 to define a periphery of the pole base cabinet 700 and/or the main opening. One of the plurality of apertures 712 and/or one of the plurality of apertures 754 can be positioned between the first panel wing 772 and the second panel wing 774 of each of the support structures.

The first support structure 786, second support structure 784, and third support structure 788 can be proximate and/or coupled to, which can include directly, rigidly, or fixedly connected, each other. The second panel wing 774 of the first support structure 786 and the first panel wing 772 of the third support structure 788 can be proximate, adjacent, and/or coupled to, which can include directly, rigidly, or fixedly connected, each other. The second panel wing 774 of the second support structure 784 and the first panel wing 772 of the third support structure 788 can be proximate, adjacent, and/or coupled to, which can include directly, rigidly, or fixedly connected, each other. In a configuration, a fastener or clip 780 can be used to join the first support structure 786, second support structure 784, and/or third support structure 788. In a configuration, the first support structure 786, second support structure 784, and/or third support structure 788 can be coupled, which can include directly, rigidly, or fixedly connected, via welding, a threaded connection, rivets, adhesion, and/or other similar mechanisms.

The thickness and/or material of the varying components of the pole base cabinet 700 can vary depending on the desired structural integrity. For example, each of the plurality of structural supports can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The peripheral wall can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The top plate and/or bottom plate can have thicknesses of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Relatedly, the components listed above can have varying widths, heights, and/or lengths to provide a desired size. For example, the pole base cabinet 700 can have an overall diameter or width of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches and/or height or length of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches. These are example ranges, such that other dimensions can be employed that are not explicitly listed herein.

With reference to FIGS. 36-37, a pole base cabinet 800 is described. Pole base cabinet 800 can include substantially the same or similar features described or shown herein in reference to other configurations of pole base cabinets. Similarly numbered features can be the same or similar.

The pole base cabinet 400 can have a top or first plate, disc, sheet 804. The top plate 804 can include a plurality of apertures 812 that can be used to couple the top plate 804 to the base of a pole, such as a pole base plate. The top plate 804 can have a periphery 830. The top plate 804 can have one or more openings 809, which can include one, two, three, four, five, six, and/or more openings 809. The one or more openings 809 can be similar to the opening 210. The one or more openings 809 can be at any position of the top plate 804. The one or more openings 809, similar to opening 210, can be used to allow wiring, cords, optical fibers, and/or other devices through the top plate 804 and into a cavity 820 of the pole base cabinet 800.

The pole base cabinet 800 can have a bottom or second plate, disc, sheet 806. The bottom plate 806 can be the same as the top plate 804. The bottom plate 806 has a plurality of apertures 854 that can be used to couple the bottom plate 806 to a footing (also referred to as a base). The bottom plate 806 can have one or more openings 819, which can include one, two, three, four, five, six, and/or more openings 819. The one or more openings 819 can be similar to the opening 211 and/or one or more openings 809. The one or more openings 819 can be at any position of the bottom plate 806. The one or more openings 819, similar to opening 211, can be used to allow wiring, cords, optical fibers, and/or other devices through the bottom plate 806 and into a cavity 820 of the pole base cabinet 800.

The pole base cabinet 800 can have a peripheral wall, side, surface 808 that can extend from and/or be coupled to, which can include directly, rigidly, or fixedly connected, the top plate 804 to the bottom plate 806. The peripheral wall 808 can extend from and/or be coupled to, which can include directly, rigidly, or fixedly connected, the periphery 830 of the top plate 804 to the periphery of the bottom plate 806. The peripheral wall 808 can have a main opening that is covered and uncovered by the door 802 allowing access into the cavity 820.

The pole base cabinet 800 can have a column 813. The column 813 can have a cross-section that is circular, polygonal, irregular, and/or another shape. The column 813 can extend from and/or be coupled to, which can include directly, rigidly, or fixedly connected, the bottom plate 806 to the top plate 804. A central longitudinal axis of the pole base cabinet 800 can extend through the column 813. The column 813 can extend from and/or be coupled to, which can include directly, rigidly, or fixedly connected, a center of the top plate 804 to the bottom plate 806. In a configuration, the column 813 is not positioned along the central longitudinal axis of the pole base cabinet 800 or at the center of the top plate 804 and/or the bottom plate 806. The column 813 can be a load bearing feature of the pole base cabinet 800.

The thickness and/or material of the varying components of the pole base cabinet 800 can vary depending on the desired structural integrity. For example, the column 813 can have a diameter or cross-sectional width of less than 1, 1-1½, 1½-2, 2-2½, 2½-3, 3-3½, 3½-4, 4-4½, 4½-5, 5-5½, 5½-6, 6½-7, 7½-8, 8½-9, 9½-10, or greater than 10 inches. The peripheral wall can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The top plate and/or bottom plate can have thicknesses of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Relatedly, the components listed above can have varying widths, heights, and/or lengths to provide a desired size. For example, the pole base cabinet 800 can have an overall diameter or width of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches and/or height or length of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches. These are example ranges, such that other dimensions can be employed that are not explicitly listed herein.

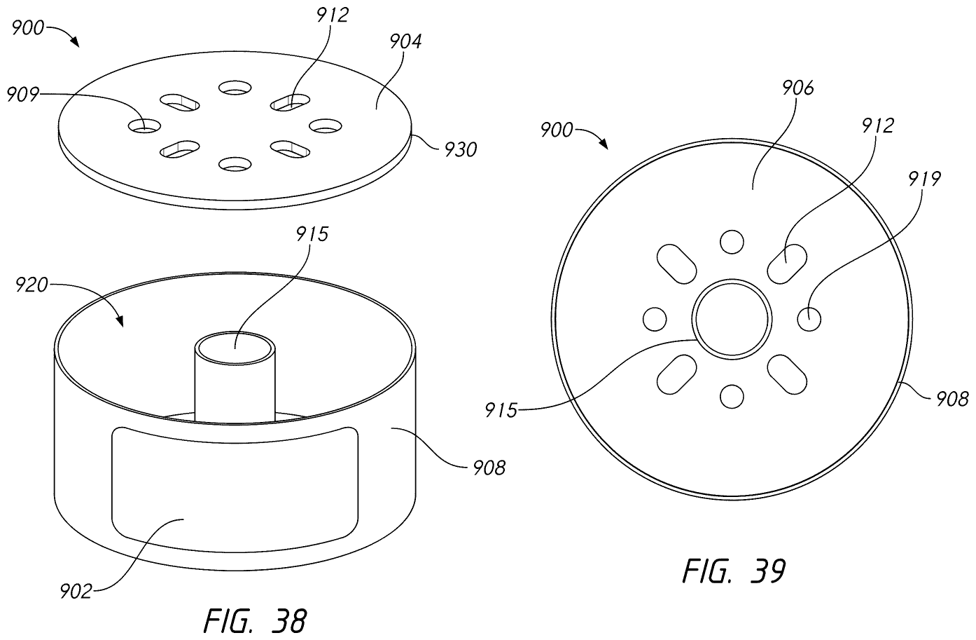

With reference to FIGS. 38-39, a pole base cabinet, casing, housing, enclosure, locker 900 is described. Pole base cabinet 900 is substantially the same or similar as pole base cabinet 800 apart from the differences detailed below. The pole base cabinet 900 can have a top or first plate, disc, sheet 904, which can have a periphery 930, plurality of apertures 912, a door 902, one or more openings 909, and/or one or more openings 919. The pole base cabinet 900 can have a bottom or second plate, disc, sheet 906, which can include a plurality of apertures 912 and/or one or more openings 919. The pole base cabinet 900 can have a peripheral wall, side, surface 908 that extends between and/or is coupled to, which can include directly, rigidly, or fixedly connected, the top plate 904 and/or the bottom plate 906. The pole base cabinet 900 has a tube 915, instead of a column 813. The tube 915 is hollow, having a central cavity. The tube 915 can be positioned the same as described in reference to the column 813 as described above. The tube 915 can be a load bearing feature of the pole base cabinet 900. The pole base cabinet 900 can have a door 902 providing access to a cavity 920.

The thickness and/or material of the varying components of the pole base cabinet 900 can vary depending on the desired structural integrity. For example, the tube 915 can have an outer diameter or cross-sectional width of less than 1, 1-1½, 1½-2, 2-2½, 2½-3, 3-3½, 3½-4, 4-4½, 4½-5, 5-5½, 5½-6, 6½-7, 7½-8, 8½-9, 9½-10, or greater than 10 inches and/or a tubular wall thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The peripheral wall can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The top plate and/or bottom plate can have thicknesses of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Relatedly, the components listed above can have varying widths, heights, and/or lengths to provide a desired size. For example, the pole base cabinet 900 can have an overall diameter or width of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches or height or length of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches. These are example ranges, such that other dimensions can be employed that are not explicitly listed herein.

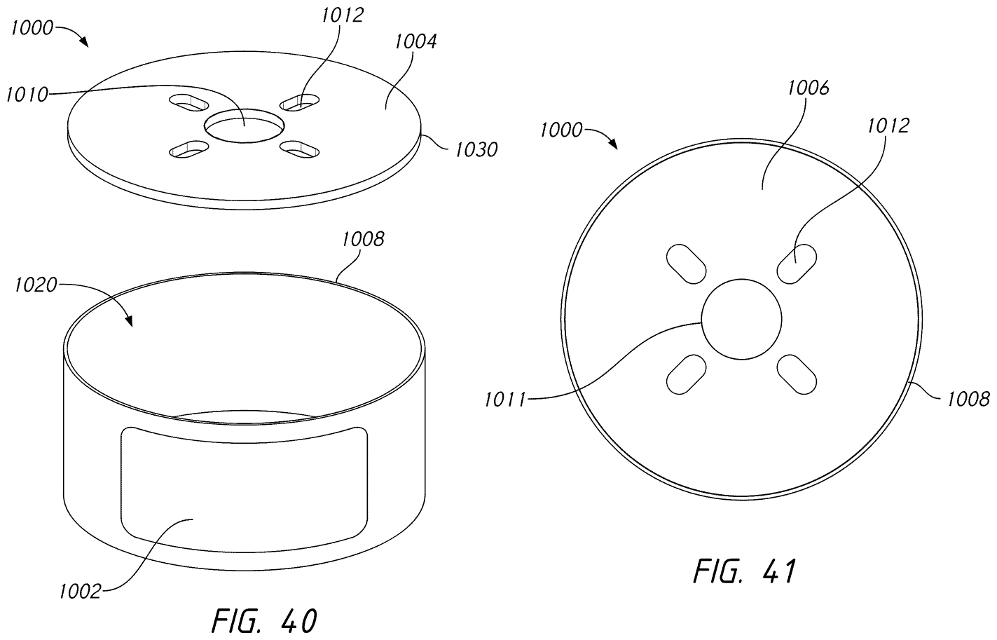

With reference to FIGS. 40-41, a pole base cabinet, casing, housing, enclosure, locker 1000 is described. Pole base cabinet 1000 is substantially the same or similar as pole base cabinet 800 apart from the differences detailed below. The pole base cabinet 1000 does not have a column 813 or tube 915 for structural support. Instead, the peripheral wall, side, surface 1008 is made of a high-load bearing material, such as high-strength steel, high-density steel, and/or hollow structural steel and/or tubing, for structural support. Not having internal support structures can advantageously provide more storage space in the cavity 1020. The pole base cabinet 1000 can have a door 1002 providing access to the cavity 1020. The top or first plate, disc, sheet 1004 can be the same as the top plate 604 of pole base cabinet 600. The top plate 1004 can have an opening 1010, a periphery 1030, and/or a plurality of apertures. The pole base cabinet 1000 can have bottom or second plate, disc, sheet 1006, which can have a plurality of apertures 1012 and/or opening 1011. The pole base cabinet 1000 can have a peripheral wall, side, surface 1008 that extends between and/or is coupled to, which can include directly, rigidly, or fixedly connected, the top plate 1004 and/or the bottom plate 1006. The peripheral wall 1008 can define or have a circular periphery and/or define a circular periphery of the pole base cabinet 1000.

The thickness and/or material of the varying components of the pole base cabinet 1000 can vary depending on the desired structural integrity. The peripheral wall can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The top plate and/or bottom plate can have thicknesses of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Relatedly, the components listed above can have varying widths, heights, and/or lengths to provide a desired size. For example, the pole base cabinet 1000 can have an overall diameter or width of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches or height or length of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches. These are example ranges, such that other dimensions can be employed that are not explicitly listed herein.

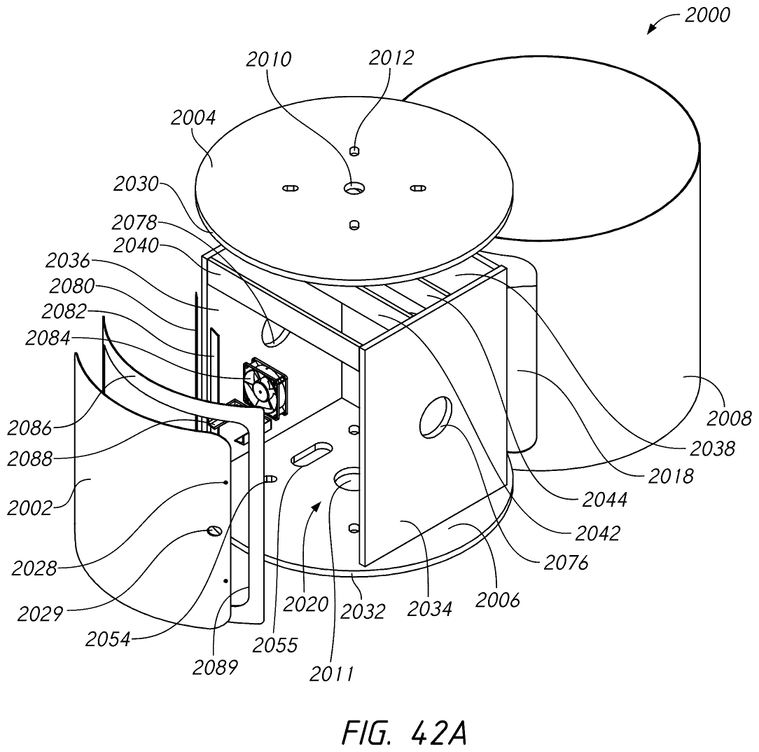

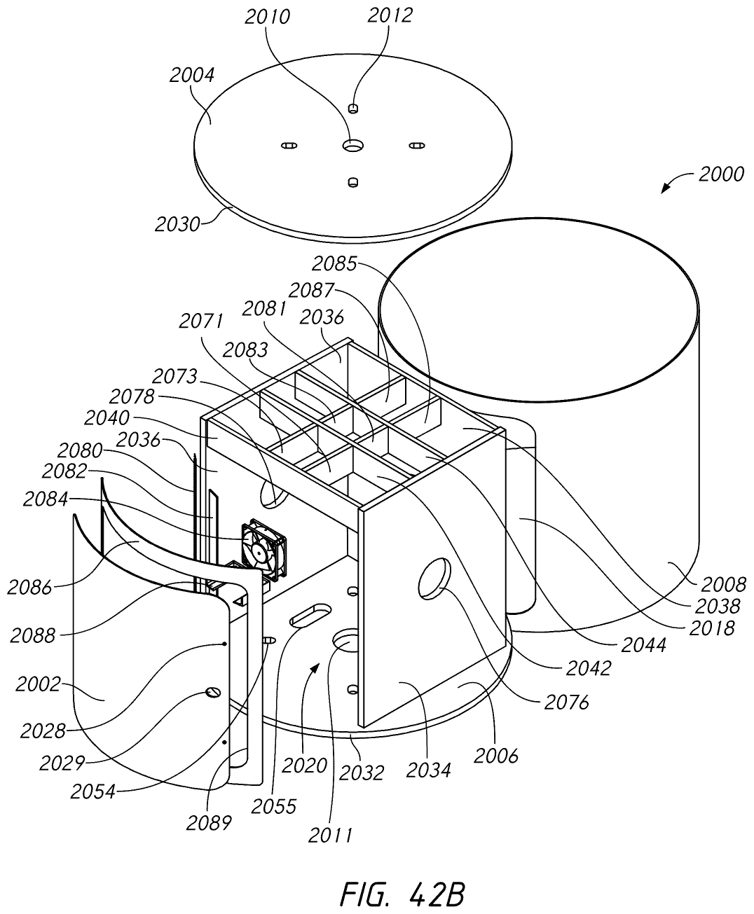

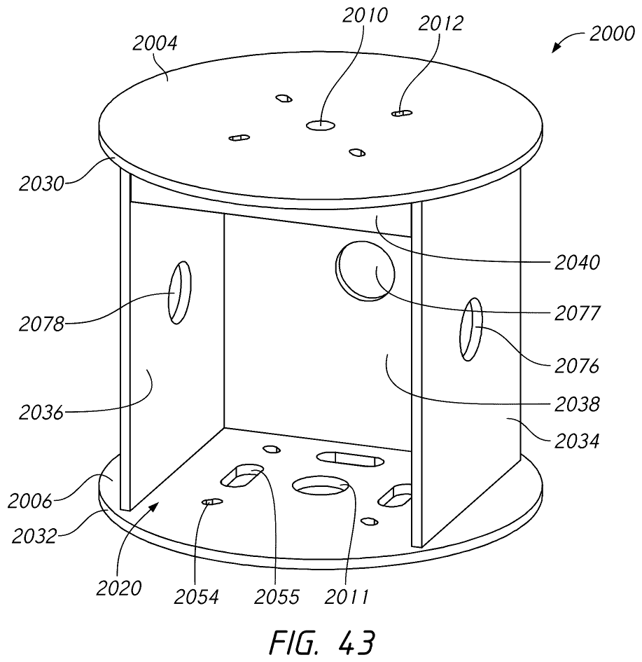

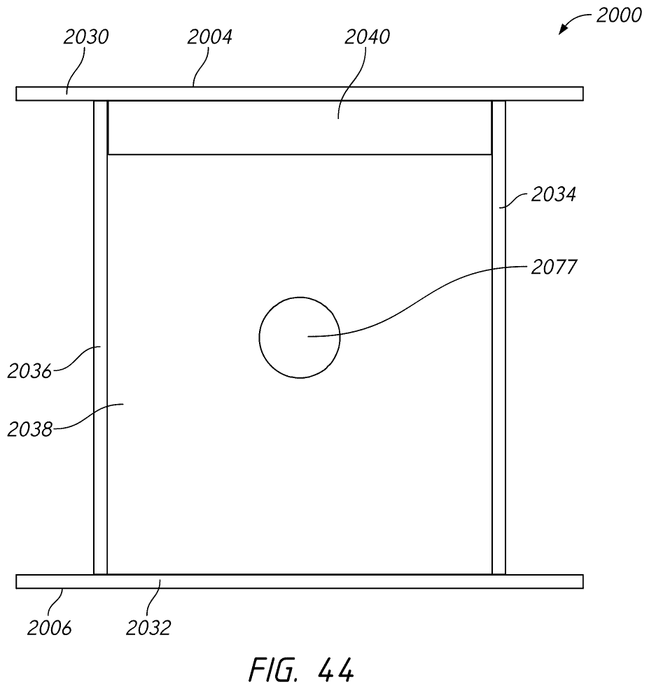

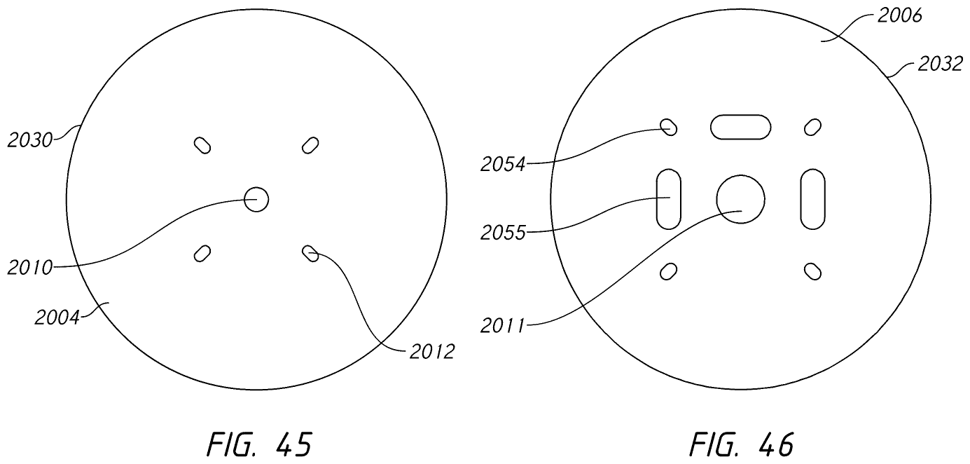

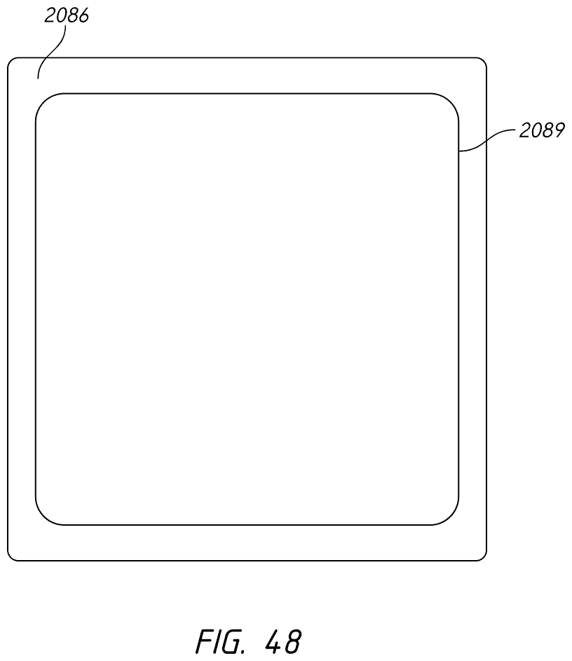

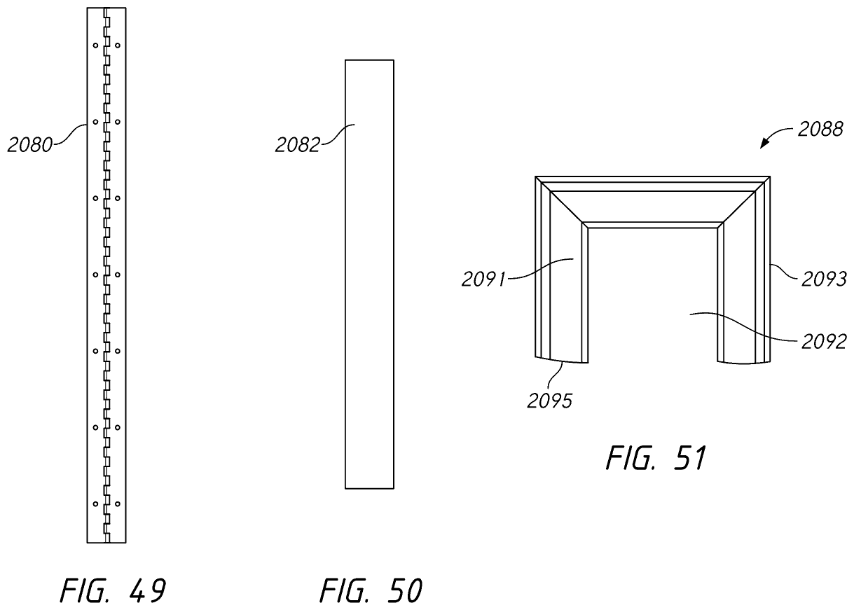

With reference to FIGS. 42A-51, a pole base cabinet, casing, housing, enclosure, locker 2000 is described. Pole base cabinet 2000 can include substantially the same or similar features described or shown herein in reference to other configurations of pole base cabinets. Similarly numbered features can be the same or similar.

As shown in FIGS. 42A, 42B, 43, and 45, the pole base cabinet 2000 can have a top or first plate, disc, sheet 2004. The top plate 2004 can have a periphery, perimeter 2030 that is circular, as shown, or polygonal, irregular, and/or others. The top plate 2004 can have a plurality of apertures 2012, which can include two, three, four, five, six, or more apertures 2012. The apertures 2012 can be used to secure the top plate 2004 to a pole base, such as a pole base plate. For example, bolts attached to a pole base can extend through the apertures 2012 and be secured with nuts, washers, and/or other similar devices, coupling the top plate 2004 and pole base cabinet 2000 to the pole base and pole. The apertures 2012 can have a circular, polygonal, irregular, and/or other shape. The apertures 2012 can all be the same or have varying shapes and/or sizes. The apertures 2012 can cooperate to form a circular, polygonal, irregular, and/or other shape depending on what configuration is required or desired to couple to a corresponding pole base and/or is needed for structural integrity. The apertures 2012 can cooperate to form a square with each aperture 2012 forming a corner thereof. The aperture 2012 can be elongate with rounded ends. The apertures 2012 can be oversized relative to a bolt that will extend therethrough. Having over-sized apertures 2012 relative to the bolt can be advantageous for convenient alignment. Apertures 2012 can be oversized relative to corresponding apertures of a pole base or pole base plate, which can be advantageous for convenient alignment.

The top plate 2004 can have an opening 2010. The opening 2010 can used to allow wiring, cords, optical fibers, and/or other devices through the top plate 2004 and into and/or out of a cavity 2020 of the pole base cabinet 2000. The opening 2010 can be centrally located. In a configuration, the opening 2010 can be located at any position on the top plate 2004. The opening 2010 can have a circular, polygonal, irregular, and/or other shape. In a configuration, a periphery defining the opening 2010 can be rounded to reduce abrasion on devices extending therethrough. In a configuration, a periphery defining the opening 2010 can be coated or covered with a non-abrasive material to reduce abrasion on devices extending therethrough. In a configuration, the apertures 2012 can be distributed around the opening 2010, which can include circumferentially or radially distributed. In a configuration, the opening 2010 can be located centered relative to the plurality of apertures 2012. The opening 2010 can be larger than each of the apertures 2012.

As shown in FIGS. 42A, 42B, 43, and 46, the pole base cabinet 2000 can have a bottom or second plate, disc, sheet 2006. The bottom plate 2006 can have a periphery 2032 that is circular, as shown, or polygonal, irregular, and/or others. The periphery 2032 of the bottom plate 2006 can be the same as the periphery 2030 of the top plate 2004. The periphery 2032 of the bottom plate 2006 can be different than the periphery 2030 of the top plate 2004. The bottom plate 2006 can have a plurality of apertures 2054, which can include two, three, four, five, six, or more apertures 2054. The apertures 2054 can be used to secure the bottom plate 2006 to a footing or base, such as a concrete base or other support or structure, which can include a footing above grade or below grade. For example, bolts or an anchor attached to the footing and/or rebar can extend through the apertures 2054 and be secured with nuts, washers, and/or other similar devices, coupling the bottom plate 2006 and the pole base cabinet 2000 to the footing. The plurality of apertures 2054 can be the same as the plurality of apertures 2012. The apertures 2054 can have a circular, polygonal, irregular, and/or other shape. The apertures 2054 can all be the same or have varying shapes and/or sizes.

The apertures 2054 can be arranged in different configurations. The apertures 2054 can cooperate to form a square with each aperture 2054 forming a corner thereof. The apertures 2054 can cooperate to form a circular, polygonal, irregular, and/or other shape depending on what configuration is required to couple to a corresponding footing or bolt arrangement. In a configuration, the top plate 2004 can be the same as the bottom plate 2006. The apertures 2054 can be elongate with rounded ends. The apertures 2054 can be oversized relative to a bolt that will extend therethrough. Having over-sized apertures 2054 relative to the bolt can be advantageous for convenient alignment. Apertures 2054 can be oversized relative to corresponding apertures of a footing or base, such as a concrete base or other support or structure (e.g., a footing above grade or below grade), which can be advantageous for convenient alignment.

The bottom plate 2006 can have a plurality of apertures 2055, which can include two, three, four, five, six, or more apertures 2055. The apertures 2055 can be used to secure the bottom plate 2006 to a footing or base, such as a concrete base or other support or structure, which can include a footing above grade or below grade. In some embodiments, conduits, tubing, and/or wiring extend through apertures 2055 and into the cavity 2020. In some embodiments, bolts or an anchor attached to the footing and/or rebar can extend through the apertures 2055 and be secured with nuts, washers, and/or other similar devices, coupling the bottom plate 2006 and the pole base cabinet 2000 to the footing. The apertures 2055 can have a circular, polygonal, irregular, and/or other shape. The apertures 2055 can all be the same or have varying shapes and/or sizes. The apertures 2055 can be arranged in different configurations. Each of the apertures 2055 can be positioned between adjacent apertures 2054. Each of the apertures 2055 can be positioned along a side of a square defined by the apertures 2054. In some embodiments, each of the apertures 2055 can be positioned along a side of a square defined by the apertures 2054, excluding the side closest to a door 2002 and/or main opening 2018 of the pole base cabinet 2000. In some embodiments, a longitudinal axis of each of the apertures 2055 can be perpendicular to each other. In some embodiments, a longitudinal axis of each of the apertures 2055 can be respectively parallel to a first support panel 2034, second support panel 2036, and third support panel 2038 of the pole base cabinet 2000.

The apertures 2055 can cooperate to form a circular, polygonal, irregular, and/or other shape depending on what configuration is required to couple to a corresponding footing or bolt arrangement. The apertures 2055 can be elongate with rounded ends. The apertures 2055 can be oversized relative to a bolt that will extend therethrough. Having over-sized apertures 2055 relative to the bolt can be advantageous for convenient alignment. Apertures 2055 can be oversized relative to corresponding apertures of a footing or base, such as a concrete base or other support or structure (e.g., a footing above grade or below grade), which can be advantageous for convenient alignment. In some embodiments, apertures 2055 can be larger than apertures 2054.

The bottom plate 2006 can have an opening 2011. The opening 2011 can be used to allow wiring, cords, optical fibers, and/or other devices through the bottom plate 2006 and into and/or out of the cavity 2020 of the pole base cabinet 2000. For example, wiring and/or cables can be routed through conduits in a footing or base upon which the pole base cabinet 2000 is mounted and extend through the opening 2011 and into the cavity 2020. The wiring and/or cables can be used to supply electrical power to components/items stored in the cavity 2020, components/items stored outside the cavity 2020, and/or a light source mounted on a pole that is coupled to the pole base cabinet 2000. The opening 2011 can be centrally located. In a configuration, the opening 2011 can be located at any position on the bottom plate 2006.

The opening 2011 can have a circular, polygonal, irregular, and/or other shape. In a configuration, a periphery defining the opening 2011 can be rounded to reduce abrasion on devices extending therethrough. In a configuration, a periphery defining the opening 2011 can be coated or covered with a non-abrasive material to reduce abrasion on devices extending therethrough. In a configuration, the apertures 2054 and/or apertures 2055 can be distributed around the opening 2011, which can include circumferentially or radially distributed. In a configuration, the opening 2011 can be centrally located relative to the plurality of apertures 2054 and/or apertures 2055. The opening 2011 can be larger than each of the apertures 2054 and/or apertures 2055. The opening 2011 can be the same as or different than the opening 2010. In a configuration, the opening 2011 is larger than the opening 2010.

The top plate 2004 and the bottom plate 2006 can be offset and/or parallel from each other. The top plate 2004 and the bottom plate 2006 can define ends and/or opposing ends of the pole base cabinet 2000. The top plate 2004 and the bottom plate 2006 can be flat. In a configuration, the top plate 2004 and/or the bottom plate 2006 can include recesses, curves, and/or contours. The top plate 2004 and the bottom plate 206 can be positioned on a center-longitudinal axis of the pole base cabinet 2000. The top plate 2004 and the bottom plate 2006 can be centered on a center-longitudinal axis of the pole base cabinet 2000. In a configuration, the top plate 2004 can be the same as the bottom plate 2006. In a configuration, the top plate 2004 does not have an opening 2010 and/or the bottom plate 2006 does not have an opening 2011.

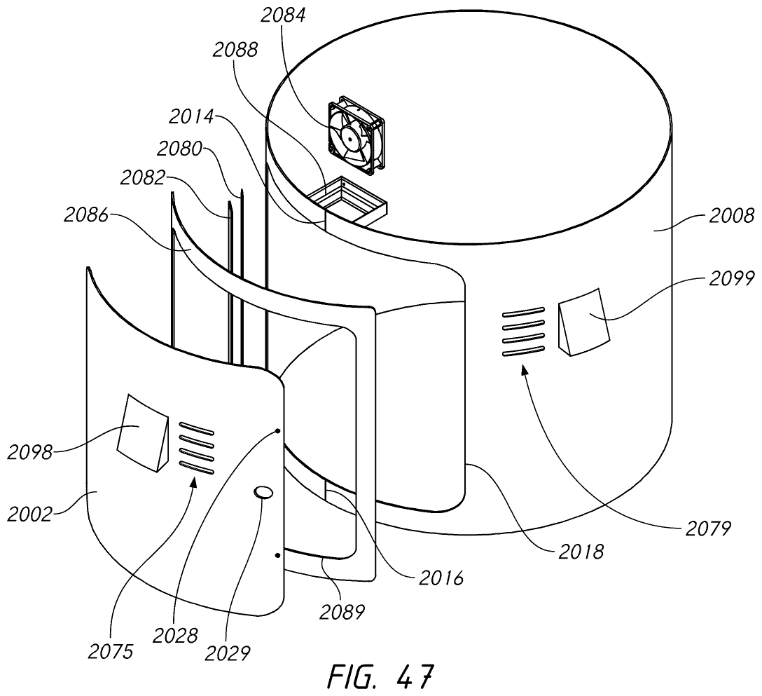

As shown in FIGS. 42A, 42B, and 47, the pole base cabinet 2000 can have a peripheral wall, side, surface 2008, which can also be referred to as a skin and/or wall 2008. The peripheral wall 2008 can extend from and/or be coupled, which can include directly, rigidly, or fixedly connected, to the top plate 2004 to the bottom plate 2006. The peripheral wall 2008 can extend from and/or be coupled, which can include directly, rigidly, or fixedly connected, to the periphery 2030 of the top plate 2004 to and/or proximate a periphery 2032 of the bottom plate 2006. The peripheral wall 2008 can extend and/or be coupled, which can include directly, rigidly, or fixedly connected, around the periphery 2030 of the top plate 2004 and/or periphery 2032 of the bottom plate 2006.

The peripheral wall 2008 can define a periphery of the pole base cabinet 2000, which can be circular, polygonal, square, rectangular, irregular, and/or other shapes. The peripheral wall 2008 can define a periphery of the pole base cabinet 2000 that can be the same as or similar to the shape of the periphery 2030 of the top plate 2004 and/or periphery 2032 of the bottom plate 2006. The peripheral wall 2008 can define a rounded or circular periphery of the pole base cabinet 2000, which can be similar to a tube. In a configuration, the peripheral wall 2008 can be manipulated from a disassembled configuration to the configuration shown in FIGS. 42A, 42B, and 47 by forming the peripheral wall 2008 into the rounded tube-like configuration such that the peripheral wall 2008 can be coupled to or proximate itself at the top joint, abutment, seam, junction, connection 2014 and the bottom joint, abutment, seam, junction, connection 2016. In a configuration, the peripheral wall 2008 can be manufactured such that there is no top joint 2014 and/or bottom joint 2016.

The peripheral wall 2008 can define a main opening 2018. The main opening 2018 can provide access into a cavity 2020 of the pole base cabinet 2000. The cavity 2020 can be centrally located in the pole base cabinet 2000. The cavity 2020 can house items and/or components, which can include the items and/or components detailed herein. The main opening 2018 can be varying sizes and shapes, which can include circular, polygonal, irregular, and/or others. In a configuration, the main opening 2018 can be rectangular in shape with rounded corners. The main opening 2018 can extend to proximate the top plate 2004 and proximate the bottom plate 2006.

As shown in FIGS. 42A, 42B, 47, and 48, the pole base cabinet 2000 can have a gasket, seal, door stop, flange, door frame 2086. The door frame 2086 can be positioned around the main opening 2018 of the peripheral wall 2008. The door frame 2086 can extend into the main opening 2018. In some embodiments, the door frame 2086 can have a periphery or shape generally corresponding to the shape of main opening 2018. In some embodiments, the door frame 2086 can have an opening 2089 therethrough. The opening 2089 can be smaller than the main opening 2018. In some embodiments, the opening 2089 can be the same or similar shape as the main opening 2018 but smaller. In some embodiments, the opening 2089 can have a shape, edge, or lip generally corresponding to the shape of main opening 2018, such as a square or other shapes discussed herein, but can be smaller than the main opening 2018. An inner periphery of the door frame 2086 that defines the opening 2089 can extend into the main opening 2018. The door frame 2086 can be positioned such that the cavity 2020 can be accessed through the main opening 2018 and the opening 2089. The opening 2089 can be centered on a central axis of the main opening 2018. The inner periphery of the peripheral wall 2008 that defines the main opening 2018 can be positioned around the opening 2089. The main opening 2018 can surround the opening 2089. The inner periphery of the peripheral wall 2008 that defines the main opening 2018 can circumscribe the opening 2089.

In some embodiments, the door frame 2086 can be a door stop. The door frame 2086 can be positioned inside the cavity 2020 and/or on an interior side of the peripheral wall 2008. The door frame 2086 can be coupled, which can include directly, rigidly, or fixedly connected, to the peripheral wall 2008, a portion of the peripheral wall 2008 proximate the main opening 2018, and/or an interior surface of the peripheral wall 2008. In some embodiments, the door frame 2086 is coupled, which can include directly, rigidly, or fixedly connected, to a hinge 2080 and/or shim 2082 that are coupled, which can include directly, rigidly, or fixedly connected, to the peripheral wall 2008. As described above, the opening 2089 can be smaller than the main opening 2018. A portion of the door frame 2086 that is proximate the opening 2089 can extend into the main opening 2018.

The door 2002, described in more detail elsewhere herein, can interface (e.g., engage) with the door frame 2086. In some embodiments, the door 2002 can engage with the portion of the door frame 2086 that is proximate the opening 2089 and extending into the main opening 2018. In some embodiments, the door 2002 can engage with a gasket (e.g., seal) positioned on the portion of the door frame 2086 that is proximate the opening 2089 and extending into the main opening 2018. The door 2002 can be coupled to the pole base cabinet 2000 with a hinge 2080 such that the door 2002 can rotate closed to block access to the cavity 2020 or open to allow access to the cavity 2020. The door 2002 can cover the opening 2089 and the main opening 2018. As described elsewhere herein, the hinge 2080 can be coupled, which can include directly, rigidly, or fixedly connected, to the door frame 2086 and/or peripheral wall 2008. As described elsewhere herein, the shim 2082 can be coupled, which can include directly, rigidly, or fixedly connected, to the door frame 2086 and/or peripheral wall 2008. In some embodiments, the hinge 2080 and shim 2082 can offset the door frame 2086 from the inner surface of the peripheral wall 2008, which can enable the door 2002 to engage with the door frame 2086 and/or a gasket attached to the door frame 2086 while being flush with the outer surface of the peripheral wall. In some embodiments, the hinge 2080 and/or the shim 2082 can offset the door frame 2086 from the inner surface of the peripheral wall 2008, which can enable the door 2002 to engage with a gasket (e.g., seal) to provide a sealed interface. In some embodiments, the hinge 2080 and/or the shim 2082 can offset the door frame 2086 from the inner surface of the peripheral wall 2008 to enable a gasket to be positioned between the door frame 2086 and the peripheral wall 2008 that engages with the door 2002.

In a closed configuration, the door 2002 can interface with the portion of the door frame 2086 and/or a gasket coupled to the door frame 2086 that is proximate the opening 2089 and extending into the main opening 2018. The door frame 2086 can stop the door 2002 from rotating inward toward the cavity 2020. The door frame 2086 can physically impede rotation of the door 2002 in one direction. In the closed configuration, the door 2002 can be flush with the peripheral wall 2008 (e.g., outer surface of the peripheral wall 2008) while interfacing with the door frame 2086 and/or a gasket coupled to the door frame 2086. In the closed configuration, the door 2002 can be positioned within the inner periphery of the peripheral wall 2008 that defines the main opening 2018. In the closed configuration, the door 2002 can be positioned within the main opening 2018. The periphery of the door 2002 can be the same or similar shape, which can include smaller, as the periphery defining the main opening 2018. The door frame 2086 and the door 2002 can engage to form a seal (e.g., a sealed interface), which can advantageously inhibit particulate (e.g., dust), fluid, and/or other matter from entering the cavity 2020. The door frame 2086, peripheral wall 2008, and/or door 2002 can engage to form a seal (e.g., a sealed interface), which can advantageously inhibit particulate (e.g., dust), fluid, and/or other matter from entering the cavity 2020. In some embodiments, the periphery of the door 2002 can interface and/or be proximate the inner periphery of the peripheral wall defining the main opening 2018 to form a seal (e.g., a sealed interface), which can advantageously inhibit particulate (e.g., dust), fluid, and/or other matter from entering the cavity 2020. In some embodiments, a gasket can be positioned between the door 2002, door frame 2086, and/or portion of the peripheral wall defining the main opening 2018 to provide a seal (e.g., a sealed interface), which can advantageously inhibit particulate (e.g., dust), fluid, and/or other matter from entering the cavity 2020. The gasket can be made from a variety of materials, such as polymers (e.g., rubber, silicone, etc.) and or other suitable materials. Providing a sealed interface can protect the contents of the pole base cabinet 2000, such as electronics and/or other equipment. The door frame 2086 can be made of a variety of materials, such as metals, polymers (e.g., rubber, silicone, etc.), and/or other materials.

As described above, the main opening 2018 can be covered with the door 2002, as shown in FIGS. 42A and 42B, permanently or temporarily preventing and/or restricting access to the cavity 2020. The door 2002 can be curved, which can include curving about a central axis of the pole base cabinet 2000 such that the door 2002 has a curvature that generally matches the curvature of the peripheral wall 2008. This can allow the door 2002 to cover the main opening 2018 while providing a generally continuous periphery to the pole base cabinet 2000 with the peripheral wall 2008. The door frame 2086 can be curved to interface with the curved door 2002. As described above, the door 2002 can be flush with the peripheral wall 2008 in the closed configuration and match the curvature of the peripheral wall 2008. In some embodiments, the door 2002 can have a slightly greater radius than the peripheral wall 2008 to be positioned on the outer surface of the peripheral wall 2008. The door 2002 can couple to the pole base cabinet 2000, periphery of the main opening 2018, door frame 2086, and/or one or more of the supports described herein.

The door 2002 can open via a hinge (e.g., piano hinge) 2080, illustrated in FIGS. 42A, 42B, 47, and 49, such that the door 2002 can be rotated to prevent and allow access into the cavity 2020. The hinge 2080 can be coupled, which can include directly, rigidly, or fixedly connected, to the door frame 2086 and/or peripheral wall 2008. The hinge 2080 can be positioned between the peripheral wall 2008 and the door frame 2086. The hinge 2080 can space the door frame 2086 away from an inner surface of the peripheral wall 2008.

In some embodiments, a shim 2082, illustrated in FIGS. 42A, 42B, 47, and 50, can be coupled, which can include directly, rigidly, or fixedly connected, to the door frame 2086 and/or peripheral wall 2008. The shim 2082 can be coupled, which can include directly, rigidly, or fixedly connected, to the door frame 2086 and/or peripheral wall 2008. The shim 2082 can be positioned between the peripheral wall 2008 and the door frame 2086. The shim 2082 can space (e.g., offset) the door frame 2086 away from an inner surface of the peripheral wall 2008. The shim 2082 can be coupled, which can include directly, rigidly, or fixedly connected, to the door frame 2086 and/or peripheral wall 2008 on one side of the main opening 2018 while the hinge 2080 is on an opposite side of the main opening 2018. The shim 2082 can offset the door frame 2086 from the peripheral wall 2008 the same distance that the hinge 2080 offsets the door frame 2086 from the peripheral wall 2008. This can facilitate the door 2002 being flush with the peripheral wall 2008 in the closed configuration. The shim 2082 can ensure that the door frame 2086 and the door 2002 properly align in the closed configuration. In some embodiments, the shim 2082 can be the same length as the hinge 2080. The shim 2082, in some embodiments, can be wider than the hinge 2080. The shim 2082 can be an elongate structure, which can include having a rectangular periphery. In some embodiments, the shim 2082 is a wedge. In some embodiments, the shim 2082 is curved to match the curvature of the peripheral wall 2008. In some embodiments, the shim 2082 and the hinge 2080 have the same thickness.

As shown in FIG. 47, the door 2002 can include vent(s) 2098 (e.g., covered vents). In a configuration, the peripheral wall 2008 can include vent(s) 2099 (e.g., covered vents). The pole base cabinet 2000 can have both, none, and/or one of vent(s) 2098 and vent(s) 2099. The vent(s) 2098 and/or vent(s) 2099 can be used to vent the cavity 2020, which can advantageously assist in cooling the cavity 2020 and/or the contents therein (e.g., electronics). The door 2002 can include a plurality of door apertures 2028, which can include two, three, four, five, six, seven, eight, or more door apertures 2028. The door apertures 2028 can be used to couple the door 2002 to the pole base cabinet 2000, which can include the peripheral wall 2008, door frame 2086, top plate 2004, bottom plate 2006, and/or support panels. In some embodiments, a bolt, screw, rivet, and/or other similar device can be inserted through the door apertures 2028 to engage with the peripheral wall 2008, door frame 2086, top plate 2004, bottom plate 2006, and/or support panels to couple the door 2002 to the pole base cabinet 2000. The door apertures 2028 can correspond to apertures positioned on the pole base cabinet 2000, such as apertures on the peripheral wall 2008, door frame 2086, top plate 2004, bottom plate 2006, and/or support panels. The door 2002 can be a thickness generally matching or being generally the same as that of the thickness of the peripheral wall 2008. In some embodiments, the door 2002 has a thickness that is larger than the thickness of the peripheral wall 2008.

In some embodiments, the door 2002 can include one or more vents 2075. Unlike as illustrated in FIG. 47, the door 2002 can have none, one, or both of vent 2075 or vent 2098. In some embodiments, the vent 2075 can include a single aperture (e.g., hole, opening, perforation) or multiple apertures, which can include apertures of different sizes and/or shapes. In some embodiments, the vent 2075 is uncovered.

In some embodiments, the peripheral wall 2008 can include one or more vents 2079. Unlike as illustrated in FIG. 47, the peripheral wall 2008 can have none, one, or both of vent 2079 or vent 2099. In some embodiments, the vents 2079 can include a single aperture (e.g., hole, opening, perforation) or multiple apertures, which can include apertures of different sizes and/or shapes. In some embodiments, the vent 2079 is uncovered.

The door 2002 can be locked and/or unlocked. In some embodiments, the door 2002 can include an aperture 2029. The aperture 2029 can be used to lock the door 2002. For example, the aperture 2029 can receive a lock. The lock received by the aperture 2029 can have a component that engages with the peripheral wall 2008, door frame 2086, and/or another component of the pole base cabinet 2000 to prevent the door 2002 from being opened. In some embodiments, the aperture 2029 can receive a handle.

As shown in FIGS. 42A-44, the pole base cabinet 2000 can include a frame providing structural support and/or integrity, wherein the frame can have a plurality of support panels and/or a plurality of internal stiffening panels. The peripheral wall 2008 can be coupled, which can include directly, rigidly, or fixedly connected, to portions of the frame, which can include welded.

The plurality of support panels can include a first support panel, plank, girder, joist, pillar, plank, brace, beam 2034, second support panel, plank, girder, joist, pillar, plank, brace, beam 2036, and/or a third support panel, plank, girder, joist, pillar, plank, brace, beam 2038. In some embodiments, the pole base cabinet 2000 does not have a third support panel 2038. As shown in FIGS. 42A-44, the first support panel 2034, second support panel 2036, and/or third support panel 238 can at least partially define the cavity 2020. In some embodiments, the first support panel 2034, second support panel 2036, third support panel 238, top plate 2004, and/or bottom plate 2006 can at least partially define the cavity 2020. The first support panel 2034, second support panel 2036, and/or a third support panel 2038 can extend between and/or be coupled, which can include directly, rigidly, or fixedly connected, to the top plate 2004 and the bottom plate 2006.

The first support panel 2034, second support panel 2036, and/or a third support panel 2038 can form three sides of a rectangular-like structure surrounding or at least partially surrounding the cavity 2020. The first support panel 2034, second support panel 2036, and/or a third support panel 2038 can be the same, similar, or different size and shape. The first support panel 2034, second support panel 2036, and/or a third support panel 2038 can be rectangular panels. The first support panel 2034, second support panel 2036, and/or a third support panel 2038 can be straight or curved. The first support panel 2034, second support panel 2036, and/or third support panel 2038 can have ends (e.g., edges, longitudinal edges) that are proximate the periphery 2030 of the top plate 2004 and/or the periphery 2032 of the bottom plate 2006. The first support panel 2034, second support panel 2036, and/or third support panel 2038 can extend and/or be coupled, which can include directly, rigidly, or fixedly connected (e.g., welded), to the peripheral wall 2008.

The first support panel 2034 can be offset from and/or parallel to the second support panel 2036. The third support panel 2038 can extend between and/or be coupled, which can include directly, rigidly, or fixedly connected, to the first support panel 2034 and the second support panel 2036. The third support panel 2038 can extend between and/or be coupled to, which can include directly, rigidly, or fixedly connected, ends or proximate ends (e.g., edges, longitudinal edges) of the first support panel 2034 and second support panel 2036. The third support panel 2038 can extend between and/or be coupled, which can include directly, rigidly, or fixedly connected, to ends or proximate ends (e.g., edges, longitudinal edges) of the first support panel 2034 and second support panel 2036 that are opposite the main opening 2018. The third support panel 2038 can be positioned opposite the main opening 2018. The third support panel 2038 can be perpendicular to the first support panel 2034 and/or second support panel 2036. The first support panel 2034, second support panel 2036, and third support panel 2038 can cooperate to form three sides of a box.

The first support panel 2034, second support panel 2036, and/or a third support panel 2038 can each respectively have a first aperture (e.g., hole, opening, port) 2076, second aperture (e.g., hole, opening, port) 2078, and/or third aperture (e.g., hole, opening, port) 2077. In a configuration, respective peripheries defining the first aperture 2076, second aperture 2078, and/or third aperture 2077 can be rounded to reduce abrasion on devices extending therethrough. In a configuration, respective peripheries defining the first aperture 2076, second aperture 2078, and/or third aperture 2077 can be coated or covered with a non-abrasive material to reduce abrasion on devices extending therethrough. The first aperture 2076 can be centered on the first support panel 2034. The second aperture 2078 can be centered on the second support panel 2036. The third aperture 2077 can be centered on the third support panel 2038.

The first aperture 2076, second aperture 2078, and/or third aperture 2077 can be circles, polygons, irregular shaped, and/or other shapes. The first aperture 2076, second aperture 2078, and/or third aperture 2077 can be the same size and/or shape. The first aperture 2076 and second aperture 2078 can be coaxially aligned. The third aperture 2077 can have an axis that intersects and/or is perpendicular to a shared central axis of the first aperture 2076 and second aperture 2078. The first aperture 2076, second aperture 2078, and/or third aperture 2077 can increase, respectively, the rigidity of the first support panel 2034, second support panel 2036, and/or a third support panel 2038. The first aperture 2076, second aperture 2078, and/or third aperture 2077 can provide access to the main cavity 2020 for wiring, cords, optical fibers, and/or other devices.

The pole base cabinet 2000 can include a plurality of internal stiffening panels, planks, girders, joists, pillars, planks, braces, beams, which can include the first internal stiffening panel 2040, second internal stiffening panel 2042, and/or third internal stiffening panel 2044. In some embodiments, the pole base cabinet 2000 can have fewer than three (e.g., one or two) or more than three (e.g., four, five, six, seven, etc.) internal stiffening panels. In some embodiments, the first internal stiffening panel 2040, second internal stiffening panel 2042, and/or third internal stiffening panel 2044 are the same. In some embodiments, the first internal stiffening panel 2040, second internal stiffening panel 2042, and/or third internal stiffening panel 2044 provide structural integrity (e.g., rigidity, strength) to the pole base cabinet 2000, while allowing the cavity 2020 to have sufficient space to house items described herein.

The first internal stiffening panel 2040, second internal stiffening panel 2042, and/or third internal stiffening panel 2044 can be coupled, which can include directly, rigidly, or fixedly connected, to the top plate 2004. In some embodiments, the first internal stiffening panel 2040, second internal stiffening panel 2042, and/or third internal stiffening panel 2044 can be spaced away from the top plate 2004. The first internal stiffening panel 2040, second internal stiffening panel 2042, and/or third internal stiffening panel 2044 can extend equidistantly or to different distances away from (e.g., relative to) the top plate 2004. The first internal stiffening panel 2040, second internal stiffening panel 2042, and/or third internal stiffening panel 2044 can have a length that is the same as the width of the third support panel 2038. The first internal stiffening panel 2040, second internal stiffening panel 2042, and/or third internal stiffening panel 2044 can extend to a position between the top plate 2004 and the bottom plate 2006, providing room for items to be store in the cavity 2020 while providing structural support. In some embodiments, the first internal stiffening panel 2040, second internal stiffening panel 2042, and/or third internal stiffening panel 2044 extend from the top plate 2004 and/or a top edge of the first support panel 2034 and/or second support panel 2036 a distance that that is less than 1/20, 1/20- 1/10, 2/20- 3/20, 3/20-⅕, ⅕-¼, ¼- 6/20, 6/20- 7/20, 7/20-⅖, 9/20-½, and/or greater than ½ the height of the cavity 2020, distance between the top plate 2004 and the bottom plate 2006, and/or length (e.g., height) of the first support panel 2034, second support panel 2036, and/or third support panel 2038. In some embodiments, the first internal stiffening panel 2040, second internal stiffening panel 2042, and/or third internal stiffening panel 2044 extend from the top plate 2004 and/or a top edge of the first support panel 2034 and/or second support panel 2036 a distance that that is less than 1/20, 1/19, 1/18, 1/17, 1/16, 1/15, 1/14, 1/13, 1/12, 1/11, 1/10, 1/9, ⅛, 1/7, ⅙, ⅕, ¼, ⅓, and/or ½ the height of the cavity 2020, distance between the top plate 2004 and the bottom plate 2006, and/or length (e.g., height) of the first support panel 2034, second support panel 2036, and/or third support panel 2038. In some embodiments, the first internal stiffening panel 2040, second internal stiffening panel 2042, and/or third internal stiffening panel 2044 have a width (e.g., height) that is less than 1/20, 1/19, 1/18, 1/17, 1/16, 1/15, 1/14, 1/13, 1/12, 1/11, 1/10, 1/9, ⅛, 1/7, ⅙, ⅕, ¼, ⅓, and/or ½ the height of the cavity 2020, distance between the top plate 2004 and the bottom plate 2006, and/or length (e.g., height) of the first support panel 2034, second support panel 2036, and/or third support panel 2038. The first internal stiffening panel 2040, second internal stiffening panel 2042, and/or third internal stiffening panel 2044 can be rectangular, square, and/or other shaped panels. The first internal stiffening panel 2040, second internal stiffening panel 2042, and/or third internal stiffening panel 2044 can be straight or curved. The first internal stiffening panel 2040, second internal stiffening panel 2042, and/or third internal stiffening panel 2044 can be the same size (e.g., same length, width, and/or thickness).

The first internal stiffening panel 2040, second internal stiffening panel 2042, and/or third internal stiffening panel 2044 can extend between and/or be coupled to, which can include directly, rigidly, or fixedly connected, the first support panel 2034 and the second support panel 2036. In some embodiments, the first internal stiffening panel 2040, second internal stiffening panel 2042, and/or third internal stiffening panel 2044 are coupled to, which can include directly, rigidly, or fixedly connected, the first support panel 2034 and the second support panel 2036 proximate the top plate 2004 and/or top portion of the first support panel 2034 and the second support panel 2036. In some embodiments, the first internal stiffening panel 2040, second internal stiffening panel 2042, and/or third internal stiffening panel 2044 are positioned at the same elevation. In some embodiments, the first internal stiffening panel 2040, second internal stiffening panel 2042, and/or third internal stiffening panel 2044 can extend between and/or be coupled to, which can include directly, rigidly, or fixedly connected, the first support panel 2034 and the second support panel 2036 at the same elevation. In some embodiments, the first internal stiffening panel 2040, second internal stiffening panel 2042, and/or third internal stiffening panel 2044 extend perpendicularly relative to a central axis of the pole base cabinet 2000. The first internal stiffening panel 2040, second internal stiffening panel 2042, and/or third internal stiffening panel 2044 can be parallel to the third support panel 2044 and/or each other. The first internal stiffening panel 2040, second internal stiffening panel 2042, and/or third internal stiffening panel 2044 can be perpendicular relative to the first support panel 2034 and the second support panel 2036. The first internal stiffening panel 2040, second internal stiffening panel 2042, and/or third internal stiffening panel 2044 can be spaced apart (e.g., offset) from each other. In some embodiments, the first internal stiffening panel 2040 and third internal stiffening panel 2044 are on opposite sides of the second internal stiffening panel 2042. In some embodiments, the first internal stiffening panel 2040 and third internal stiffening panel 2044 are equally spaced from the second internal stiffening panel 2042. In some embodiments, the first internal stiffening panel 2040 and third internal stiffening panel 2044 are unequally spaced away from the internal stiffening panel 2042. The first internal stiffening panel 2040, second internal stiffening panel 2042, and/or third internal stiffening panel 2044 can be positioned between the top plate 2004 and the bottom plate 2006.

The first internal stiffening panel 2040 can extend between and/or be coupled to, which can include directly, rigidly, or fixedly connected, ends and/or proximate ends (e.g., edges, longitudinal edges) of the first support panel 2034 and second support panel 2036 that are proximate the opening 2018. The first internal stiffening panel 2040 can be positioned between the second internal stiffening panel 2042 and the main opening 2018. The first internal stiffening panel 2040 can be positioned proximate the main opening 2018. The first internal stiffening panel 2040 can be offset from the second internal stiffening panel 2042.

The second internal stiffening panel 2042 can be positioned, which can include equidistantly positioned, between the first internal stiffening panel 2040 and third internal stiffening panel 2044. The second internal stiffening panel 2042 can be positioned along a median plane of the pole base cabinet 2000. The second internal stiffening panel 2042 can be positioned on a common plane as a central axis that extends between the aperture 2076 and the aperture 2078. The second internal stiffening panel 2042 can be positioned between and/or offset from the first internal stiffening panel 2040 and third internal stiffening panel 2044. The second internal stiffening panel 2042 can be positioned between and/or be coupled to, which can include directly, rigidly, or fixedly connected, midpoints and/or portions of the first support panel 2034 and second support panel 2036. The second internal stiffening panel 2042 can intersect a central axis of the pole base cabinet 2000. The second internal stiffening panel 2042 can extend across the opening 2010.

The third internal stiffening panel 2044 can be positioned between the second internal stiffening panel 2042 and the third support panel 2038. The third internal stiffening panel 2044 can be offset from the second internal stiffening panel 2042 and the third support panel 2038. The third internal stiffening panel 2044 can be positioned at and/or proximate a midpoint between the second internal stiffening panel 2042 and the third support panel 2038. In some embodiments, the third internal stiffening panel 2044 can be positioned closer to the second internal stiffening panel 2042 or third support panel 2038.

The pole base cabinet 2000 shown in FIG. 42B can be the same as the pole base cabinet 2000 shown in FIG. 42A, aside from the differences described herein. As shown in FIG. 42B, the pole base cabinet 2000 can include internal stiffening panels, internal panel, planks, girders, joists, pillars, planks, braces, beams, which can include the first internal brace 2071, second internal brace 2073, third internal brace 2081, fourth internal brace 2083, fifth internal brace 2085, and/or sixth internal brace 2087. In some embodiments, the first internal brace 2071, second internal brace 2073, third internal brace 2081, fourth internal brace 2083, fifth internal brace 2085, and/or sixth internal brace 2087 provide structural integrity (e.g., rigidity, strength) to the pole base cabinet 2000, while allowing the cavity 2020 to have sufficient space to house items described herein. In some embodiments, the first internal brace 2071, second internal brace 2073, third internal brace 2081, fourth internal brace 2083, fifth internal brace 2085, and/or sixth internal brace 2087 can be the same height as the first internal stiffening panel 2040, second internal stiffening panel 2042, and/or third internal stiffening panel 2044.

The first internal brace 2071, second internal brace 2073, third internal brace 2081, fourth internal brace 2083, fifth internal brace 2085, and/or sixth internal brace 2087 can be coupled, which can include directly, rigidly, or fixedly connected, to the top plate 2004. In some embodiments, the first internal brace 2071, second internal brace 2073, third internal brace 2081, fourth internal brace 2083, fifth internal brace 2085, and/or sixth internal brace 2087 can be spaced away from the top plate 2004. The first internal brace 2071, second internal brace 2073, third internal brace 2081, fourth internal brace 2083, fifth internal brace 2085, and/or sixth internal brace 2087 can extend equidistantly or to different distances away from (e.g., relative to) the top plate 2004.

The first internal brace 2071, second internal brace 2073, third internal brace 2081, fourth internal brace 2083, fifth internal brace 2085, and/or sixth internal brace 2087 can extend to a position between the top plate 2004 and the bottom plate 2006, providing room for items to be stored in the cavity 2020 while providing structural support. In some embodiments, the first internal brace 2071, second internal brace 2073, third internal brace 2081, fourth internal brace 2083, fifth internal brace 2085, and/or sixth internal brace 2087 extend from the top plate 2004 and/or a top edge of the first support panel 2034 and/or second support panel 2036 a distance that that is less than 1/20, 1/20- 1/10, 2/20- 3/20, 3/20-⅕, ⅕-¼, ¼- 6/20, 6/20- 7/20, 7/20-⅖, 9/20-½, and/or greater than ½ the height of the cavity 2020, distance between the top plate 2004 and the bottom plate 2006, and/or length (e.g., height) of the first support panel 2034, second support panel 2036, and/or third support panel 2038. In some embodiments, the first internal brace 2071, second internal brace 2073, third internal brace 2081, fourth internal brace 2083, fifth internal brace 2085, and/or sixth internal brace 2087 extend from the top plate 2004 and/or a top edge of the first support panel 2034 and/or second support panel 2036 a distance that that is less than 1/20, 1/19, 1/18, 1/17, 1/16, 1/15, 1/14, 1/13, 1/12, 1/11, 1/10, 1/9, ⅛, 1/7, ⅙, ⅕, ¼, ⅓, and/or ½ the height of the cavity 2020, distance between the top plate 2004 and the bottom plate 2006, and/or length (e.g., height) of the first support panel 2034, second support panel 2036, and/or third support panel 2038. In some embodiments, the first internal brace 2071, second internal brace 2073, third internal brace 2081, fourth internal brace 2083, fifth internal brace 2085, and/or sixth internal brace 2087 have a width (e.g., height) that is less than 1/20, 1/19, 1/18, 1/17, 1/16, 1/15, 1/14, 1/13, 1/12, 1/11, 1/10, 1/9, ⅛, 1/7, ⅙, ⅕, ¼, ⅓, and/or ½ the height of the cavity 2020, distance between the top plate 2004 and the bottom plate 2006, and/or length (e.g., height) of the first support panel 2034, second support panel 2036, and/or third support panel 2038. The first internal brace 2071, second internal brace 2073, third internal brace 2081, fourth internal brace 2083, fifth internal brace 2085, and/or sixth internal brace 2087 can be rectangular, square, and/or other shaped panels. The first internal brace 2071, second internal brace 2073, third internal brace 2081, fourth internal brace 2083, fifth internal brace 2085, and/or sixth internal brace 2087 can be straight or curved. The first internal brace 2071, second internal brace 2073, third internal brace 2081, fourth internal brace 2083, fifth internal brace 2085, and/or sixth internal brace 2087 can be the same thickness.

The first internal brace 2071, second internal brace 2073, third internal brace 2081, fourth internal brace 2083, fifth internal brace 2085, and/or sixth internal brace 2087 can be parallel and/or offset from the first support panel 2034 and the second support panel 2036. The first internal brace 2071, second internal brace 2073, third internal brace 2081, fourth internal brace 2083, fifth internal brace 2085, and/or sixth internal brace 2087 can be perpendicular to the third support panel 2038. The first internal brace 2071, third internal brace 2081, and/or fifth internal brace 2085 can be equidistantly spaced away from the first support panel 2034 and the second support panel 2036. The first internal brace 2071, third internal brace 2081, and/or fifth internal brace 2085 can be coplanar. The second internal brace 2073, fourth internal brace 2083, and/or sixth internal brace 2087 can be equidistantly spaced away from the first support panel 2034 and the second support panel 2036. The second internal brace 2073, fourth internal brace 2083, and/or sixth internal brace 2087 can be coplanar.

The first internal brace 2071 and second internal brace 2073 can be the same size and shape. In some embodiments, the first internal brace 2071, second internal brace 2073, fifth internal brace 2085, and sixth internal brace 2087 are the same size and shape. In some embodiments, the first internal brace 2071, second internal brace 2073, third internal brace 2081, fourth internal brace 2083, fifth internal brace 2085, and/or sixth internal brace 2087 are the same size and shape. The first internal brace 2071 and second internal brace 2073 can be spaced apart from and parallel to each other. The first internal brace 2071 and second internal brace 2073 can extend between and/or be coupled to, which can include directly, rigidly, or fixedly connected, the first internal stiffening panel 2040 and the second internal stiffening panel 2042. The first internal brace 2071 and second internal brace 2073 can be positioned between at least two of the apertures 2012 of the top plate 2004.

The third internal brace 2081 and fourth internal brace 2083 can be spaced apart from and parallel to each other. The third internal brace 2081 and fourth internal brace 2083 can extend between and/or be coupled to, which can include directly, rigidly, or fixedly connected, the second internal stiffening panel 2042 and the third internal stiffening panel 2044. The opening 2010 of the top plate 2004 can be positioned between the third internal brace 2081 and fourth internal brace 2083. A central axis of the opening 2010 of the top plate 2004 can be positioned between the third internal brace 2081 and fourth internal brace 2083. In some embodiments, the opening 2010 and/or the central axis of the opening 2010 can be positioned between the third internal brace 2081, fourth internal brace 2083, second internal stiffening panel 2042, and third internal stiffening panel 2044. In some embodiments, the third internal brace 2081, fourth internal brace 2083, second internal stiffening panel 2042, and third internal stiffening panel 2044 can define a square and/or rectangle through which the central axis of the opening 2010 extends.

The fifth internal brace 2085 and sixth internal brace 2087 can be spaced apart from and parallel to each other. The fifth internal brace 2085 and sixth internal brace 2087 can extend between and/or be coupled to, which can include directly, rigidly, or fixedly connected, the third internal stiffening panel 2044 and the third support panel 2038. The fifth internal brace 2085 and sixth internal brace 2087 can be positioned between at least two of the apertures 2012 of the top plate 2004. The same distance can separate the first internal brace 2071 from the second internal brace 2073, the third internal brace 2081 from the fourth internal brace 2083, and the fifth internal brace 2085 from the sixth internal brace 2087.

As shown in FIGS. 42A, 42B, 47, and 51, the pole base cabinet 2000 can have a bracket (e.g., seat, holder, receiver, pocket, receptacle) 2088. The bracket 2088 can receive a fan 2084, which can include a cooling fan, pump, or other fluid moving device, that can cool the cavity 2020 and/or equipment within the cavity 2020 by moving air within the cavity 2020 or directing air through (in and out of) the cavity 2020 (e.g., providing a flow of air inside or through the cavity 2020). The fan 2084 can be corrosion resistant. The bracket 2088 can, as shown in FIG. 47, be coupled, which can include directly, rigidly, or fixedly connected, to an inside surface of the peripheral wall 2008. In some embodiments, the bracket 2088 can be coupled, which can include directly, rigidly, or fixedly connected, to one or more of the plurality of support panels, one or more of the internal stiffening panels, top plate 2004, door 2002, and/or bottom plate 2006.

The bracket 2088 can receive the fan 2084 such that the fan 2084 directs air toward the top plate 2004, bottom plate 2006, and/or one or more of the plurality of support panels and/or internal stiffening panels. As shown in FIG. 51, the bracket 2088 can have a peripheral edge (e.g., wall, retainer, side) 2093 that defines a recess (pocket, receiver) 2091 that can receive the fan 2084. The peripheral edge 2093 can retain the fan 2084. In some embodiments, the fan 2084 can be coupled to the bracket 2088 with a snap-fit, press-fit, fasteners, friction fit, and/or other coupling techniques. The bracket 2088 can have a hole (e.g., aperture) 2092 through which the fan 2084 can direct air. In some embodiments, the ends 2095 can interface with the peripheral wall 2008. In some embodiments, the ends 2095 can have a curvature that matches the curvature of the peripheral wall 2008. In some embodiments, the ends 2095 can be straight and/or flat.

The thickness and/or material of the varying components of the pole base cabinet 2000 can vary depending on the desired structural integrity. For example, materials such as metals (such as steel, high strength steel, aluminum, and/or others), metal alloys, polymers (such as plastic), ceramics, and/or others can be used. For example, each of the plurality of support panels can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Each of the plurality of internal stiffening panels and/or internal braces can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The peripheral wall can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The top plate and/or bottom plate can have thicknesses of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Relatedly, the components listed above can have varying widths, heights, and/or lengths to provide a desired size. For example, the pole base cabinet 2000 can have an overall diameter or width of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches and/or height or length of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches. These are example ranges, such that other dimensions can be employed that are not explicitly listed herein.

Electric vehicles are becoming more and more prevalent, resulting in an increased demand for electric vehicle (EV) charging stations. EV charging stations can be disposed at a variety of locations due to their relatively small footprint, which can at least include parking lots, adjacent roadways, etc. Often, light poles, utility poles, or other poles are positioned in these locations and are connected to a power supply. Accordingly, it can be efficient to incorporate EV charging at poles due to advantageous positioning in a parking lot, adjacent a roadway, etc. and/or because power is already supplied.

As described herein, pole base cabinets can be disposed between a footing or base and a pole, such as a light pole. The pole base cabinet can include a power connection therein and/or store supporting components, equipment, etc. for externally mounted devices. For example, disclosed herein are EV charging housings or mounts that can be used with at least any of the pole base cabinets described herein to facilitate the mounting of an EV charger to the pole base cabinet. The EV charging housing or mount can support an EV charger, connector, cable, user interface, etc. The EV charging housing or mount can provide an internal cavity through which power and/or data cables can extend between the EV charger and one or more components disposed inside of the pole base cabinet. For example, a power cable can be routed from inside the pole cabinet, through the internal cavity of the charging housing or mount, and to the EV charger to provide power.

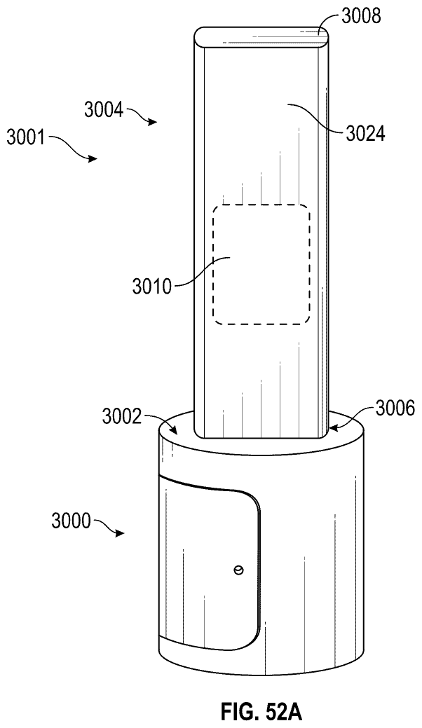

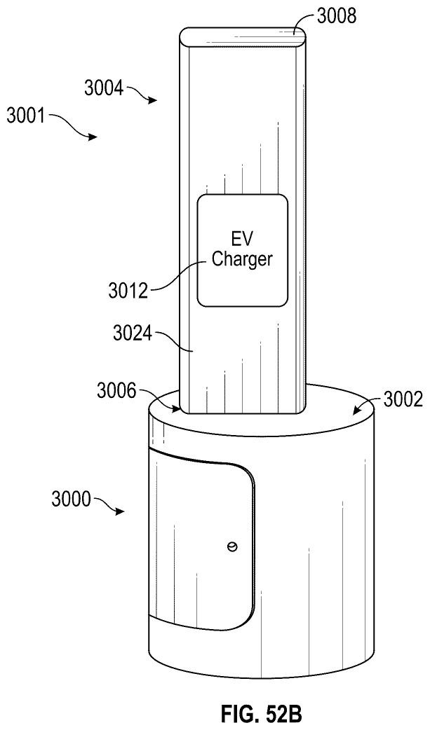

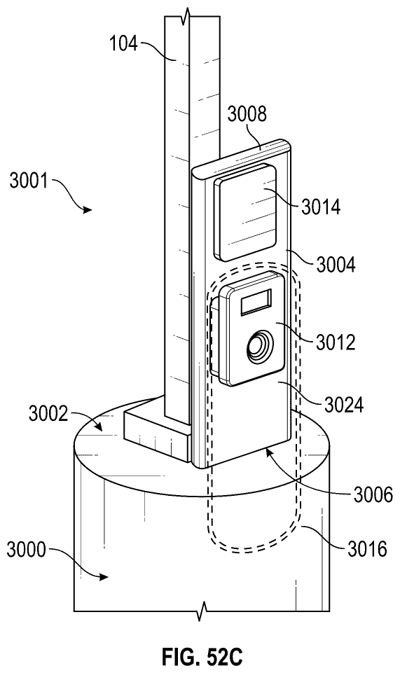

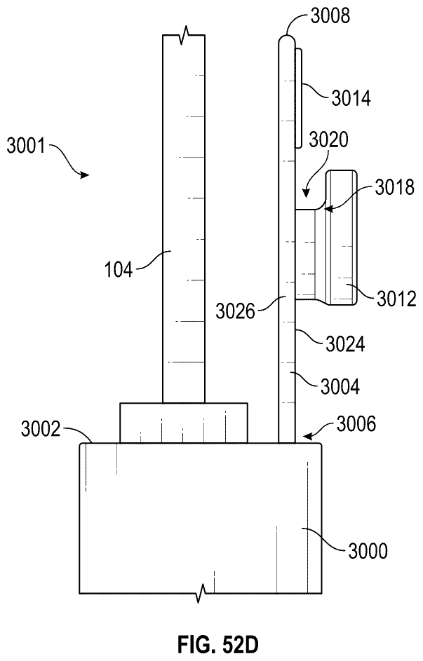

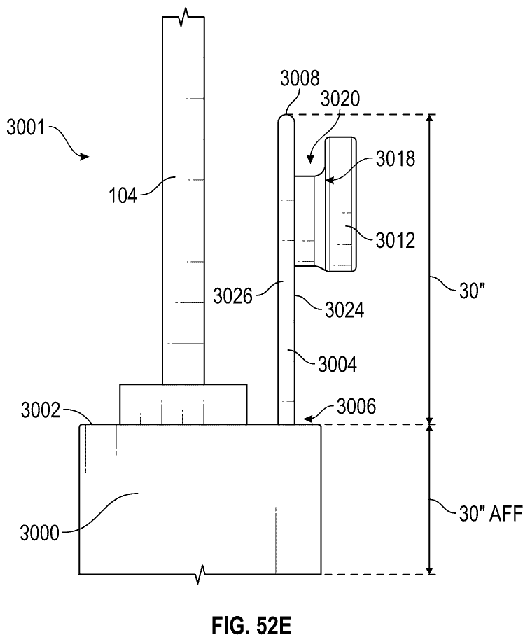

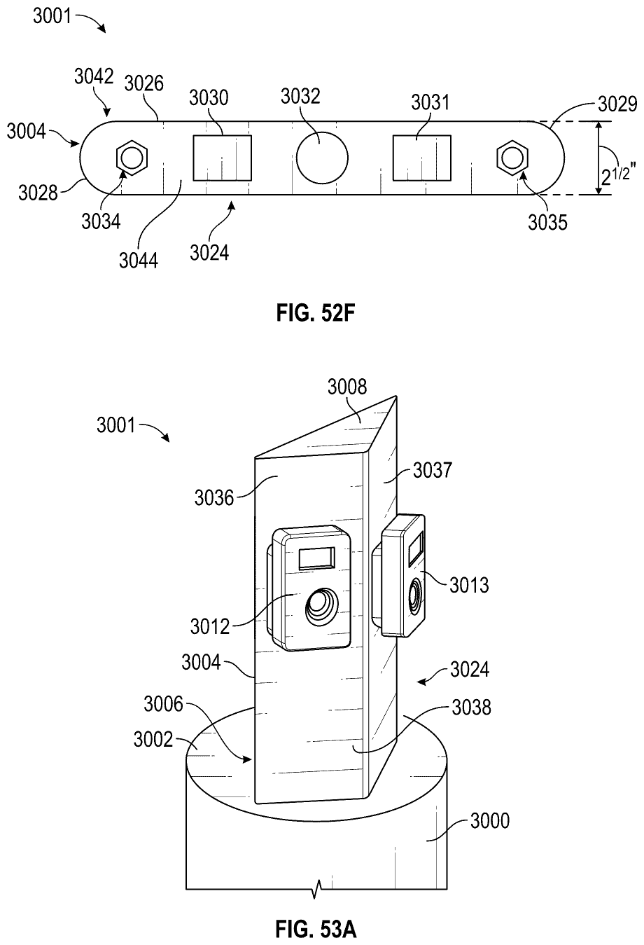

FIG. 52A illustrates an electric vehicle (EV) charging station 3001 with a housing 3004, which can also be referred to as an EV charging housing, stand, EV charging stand, support structure, frame, mount, and/or EV charging mount. The housing 3004 can support an EV charger and one or more components thereof, such as a charging cable, connector, user interface, display, signage, etc. The housing 3004 can, in some variants, include a cavity or hollow interior through which one or more cables, wires, or the like can be routed, which can facilitate connection between an EV charger and one or more features disposed inside the cavity of the pole base cabinet 3000. The pole base cabinet 3000 can be at least the same as, similar to, and/or incorporate features from any of the pole base cabinets herein.

The housing 3004 can be configured in numerous shapes and/or sizes. In some variants, the housing 3004 can be elongate. The housing 3004 can have varying peripheries and/or cross-sections, such as an oval, circular, polygonal (e.g., square, rectangular, etc.), irregular, and/or other periphery and/or cross-section. In some variants, the housing 3004 can be a shell, which can include having a wall surrounding a hollow interior. In some variants, the housing 3004 can be formed from structural components being joined together to form the housing 3004 with an internal cavity. In some variants the structural components can form the exterior surface or wall of the housing 3004.

The housing 3004 can include a first end 3006 and a second end 3008. In some variants, the periphery of the housing 3004 can be varied or consistent between the first end 3006 and the second end 3008. The second end 3008 can, in some variants, be free when the housing 3004 is mounted onto a pole base cabinet 3000. In some variants, the second end 3008 can be flat or rounded. The second end 3008 can be closed. The first end 3006 can be open or include a wall or surface with an opening therein to facilitate one or cables, wires, or the like to be routed into a cavity of the housing 3004. As described herein, the housing 3004 can be disposed on the pole base cabinet 3000, which can include the first end 3006 being disposed and/or coupled (e.g., bolted, fastened, adhered, welded, clipped, etc.) to the pole base cabinet 3000. In some variants, the housing 3004, e.g., the first end 3006, can be disposed on a top surface or top plate 3002 of the pole base cabinet 3000.

The housing 3004 can include a mount area 3010 on which an EV charger can be mounted. In some variants, the housing 3004 can include a front face 3024 which can include the mount area 3010 thereon. The front face 3024 can face outward, e.g., away from a central axis of the pole base cabinet 3000 and/or a pole mounted thereon. The EV charger can be bolted, fastened, adhered, welded, clipped, etc. to the housing 3004. The mount area 3010 can be disposed at a suitable height for a large portion of a population to easily interact with an EV charger mounted thereon.

FIG. 52B shows EV charging station 3001 with the housing 3004 with an EV charger 3012 mounted thereon. The EV charger 3012 can be mounted on the mount area 3010 using any of the techniques described herein. In some variants, the housing 3004 can include a cavity therein through which cables, wiring, and the like can be routed. For example, a power cable, data cable, and/or other wires/cables can be routed from inside the pole base cabinet 3000, through the top plate or surface 3002, through the cavity of the housing 3004, and to the EV charger 3012. This can advantageously protect the wires and cables from damage and/or tampering. In some variants, the first end 3006 can be open or include an opening through which cables and/or wires can be routed, as described herein.

As shown in FIG. 52C, the EV charger 3012 can include a cable 3016 with a connector to operatively couple to an electric vehicle for charging. In some variants, the EV charger 3012 and/or the housing 3004 can include a hook, mount, bracket, support, recess, gap, surface, groove, etc. to support the cable 3016 such that the cable 3016 is suspended off a ground surface. The EV charger 3012 can include a display, user interface, etc. through which the user can input commands and/or receive information, such as instruction.

The housing 3004 can be disposed in front of a pole 104 that is mounted on top of the pole base cabinet 3000. In some variants, a pole 104 may not be mounted on top of the pole base cabinet 3000. In some variants, the housing 3004 can be connected, attached, and/or secured to the pole 104 with or without being secured to the pole base cabinet 3000. The housing 3004, as illustrated, can include a sign 3014 and/or indicia, which can indicate the presence of the EV charger 3012 and/or instructions to a user. In some variants, the sign 3014 is a display, which can include a touch screen. In some variants, the sign 3014 is digital and can be programmed to display various information. In some variants, the sign 3014 is reflective.

As shown in FIG. 52D, the EV charger 3012 can include a back surface 3018 that is at least partially offset from the front face 3024 of the housing 3004 to define a gap or groove 3020. The gap 3020 can receive the cable 3016 therein for storage when not in use. The back surface 3018 can be a curved surface that curves away from the front face 3024 of the housing 3004. In some variants, the back surface 3018 can be offset from the front face 3024 at and/or proximate at least a portion of the periphery of the EV charger 3012 to define a gap or groove there around. For example, in some variants, the gap 3020 can extend around the lateral sides and top of the EV charger 3012 to facilitate wrapping the cable 3016 around the EV charger 3012. In some variants, the gap 3020 can extend around the entire or most of the periphery of the EV charger 3012.

The housing 3004, as shown in FIG. 52D, can include a back face 3026 that is opposite the front face 3024. In some variants, one or both of the back face 3026 and/or front face 3024 can be flat, which can include being parallel to each other. In some variants, the back face 3026 (back wall or surface) and front face 3024 (front wall or surface) can be angled or curved relative to each other or at least one or more portions thereof. In some variants, the housing 3004 can be connected, attached, and/or secured to the pole 104 via the back face 3026.

FIG. 52E illustrates the housing 3004 with a lower profile and example dimensions, which are not limiting. For example, the distance between the top surface of the top plate 3002 and the housing 3004 can be thirty inches, which can position the EV charger 3012 lower compared to as illustrated in FIG. 52D. The distance between a ground surface and the top surface of the top plate 3002 can be thirty inches.

FIG. 52F illustrates a top section view of the housing 3004. As shown, the housing 3004 can include a wall 3042. The wall 3042 can surround a cavity 3044. The wall 3042 can be varying thicknesses, which can depend on the environment within which the housing 3004 is installed. The wall 3042 can include a front face 3024 and a back face 3026, which can be parallel relative to each other. The wall 3042 can include curved longitudinal sides 3028, 3029 connecting the front face 3024 and back face 3026. The cavity 3044, as described herein, can house one or more items related to the EV charger 3012. For example, the cavity 3044 can house one or more cables, wires, or the like routed from inside the pole base cabinet 3000 to the EV charger 3012.

The housing 3004 can include one or more supports, which can also be referred to as braces, beams, struts, etc., to provide structural integrity to the housing 3004. For example, the housing 3004 can include a first support or beam 3030 and a second support or beam 3031. In some variants, the housing 3004 can include one support or more than two supports. In some variants, the housing 3004 can include supports disposed on an exterior of the housing 3004, e.g., on an exterior surface of the wall 3042. The first support 3030 and second support 3031 can be connected to and extend away from a wall or surface of the first end 3006, which can be a wall or surface defining the first end 3006. In some variants, the first support 3030 and second support 3031 can be connected to and extend away from the pole base cabinet 3000, which can include some structure therein, and pass through the wall or surface of the first end 3006 and into the housing 3004. The first support 3030 and second support 3031 can, in some variants, be elongate structures that extend in a longitudinal direction of the housing 3004 and/or the internal length or substantially the internal length of the housing 3004. In some variants, one or more braces, struts, and/or secondary supports can extend away from the first support 3030 and second support 3031 to engage the wall 3042 to provide additional structural integrity to the housing 3004. The first support 3030 and/or second support 3031 can have varying peripheries and/or cross-sections, which can at least include round, oval, polygonal (e.g., square, rectangular, etc.), irregular, and/or others. The first support 3030 and/or second support 3031 can be solid and/or hollow. The first support 3030 and second support 3031 can be spaced away from each other, which can include being parallel to each other. The spacing away of the first support 3030 form the second support 3031 can provide increased torsional control of the housing 3004.

The first end 3006 of the housing 3004 can terminate in a wall or surface. In some variants, as described herein, the wall or surface of the first end 3006 can be coupled, e.g., bolted, fastened, etc., to the pole base cabinet 3000, which can include the top plate 3002. An opening or hole 3032 can extend through the wall or surface of the first end 3006. The opening 3032 can be oval, circular, polygonal (e.g., square, rectangular, etc.), irregular, and/or others. The opening 3032 can, as described herein, facilitate one or more cables, wires, or the like to be routed from the cavity of the pole base cabinet 3000 into the cavity 3044 of the housing 3004. The one or more cables, wires, or the like can then be routed to the EV charger 3012, which can include being routed through another opening or hole extending through the wall 3042. The first support 3030 and/or second support 3031 can be disposed on opposing sides of the opening 3032. The top plate 3002 of the pole base cabinet 3000 can include a corresponding opening providing access into the cavity of the pole base cabinet 3000.

The housing 3004, e.g., the wall or surface of the first end 3006, can be coupled to the pole base cabinet 3000, which can include the top plate 3002. The housing 3004 can be coupled to the pole base cabinet 3000 using a variety of techniques, which can include being bolted, fastened, clamped, adhered, welded, etc. For example, the housing 3004 can be coupled to the pole base cabinet 3000 using a first bolt 3034 and second bolt 3035. To prevent tampering, the housing 3004 can be coupled to the pole base cabinet 3000 from inside the pole base cabinet 3000. For example, a user can access the cavity of the pole base cabinet 3000 through a door thereof, which may be lockable. The top plate 3002 of the pole base cabinet 3000 can include one or more holes, e.g., two, disposed therein that are sized to, respectively, receive a bolt. The one or more holes in the top plate 3002 can be threaded. The wall or surface of the first end 3006 of the housing 3004 can include corresponding one or more holes, which can be threaded. The one or more holes of the top plate 3002 and the one or more holes of the wall or surface of the first end 3006 of the housing 3004 can be aligned coaxially and a bolt or screw can be inserted to secure the housing 3004 to the pole base cabinet 3000. This arrangement can prevent the housing 3004 from being removed without having access to an interior of the pole base cabinet 3000 which can be secured by way of a lockable door, as described herein. FIG. 52F illustrates example dimensions, which are not limiting. As illustrated, the thickness of the housing 3004, which can be the distance between the front face 3024 and back face 3026, can be 2.5 inches. The front face 3024 and/or back face 3026 can be flat, which can include a flat surface that is twelve inches wide.

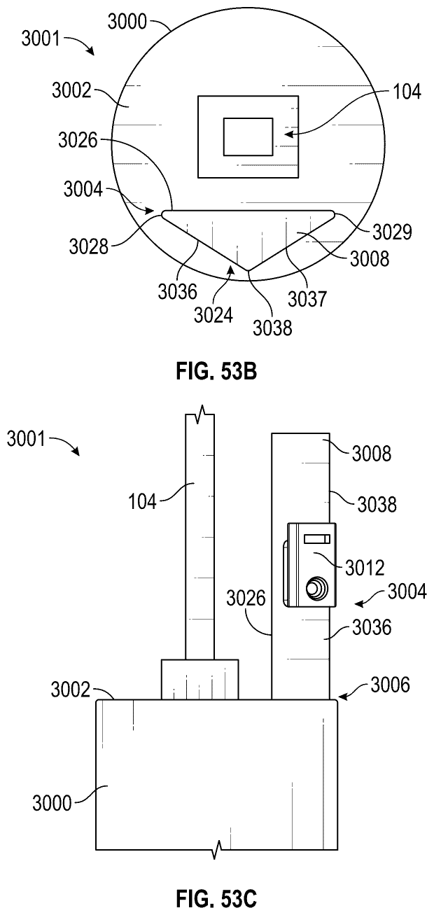

FIGS. 53A, 53B, and 53C illustrate the housing 3004 with a plurality of EV chargers. The housing 3004 can include a front face 3024 having a first angled front surface or wall 3036 and second angled front surface or wall 3037. The first angled front surface 3036 and second angled front surface 3037 can be angled to each other about a juncture 3038 therebetween, which can at least include being angled between 40 and 170 degrees. The first angled front surface 3036 and second angled front surface 3037 can be angled relative to the back face 3026 of the housing 3004. In some variants, the first angled front surface 3036, second angled front surface 3037, and back face 3026 can form a triangular periphery, which can include having rounded corners. The juncture 3038 can define the farthest portion of the front face 3024 away from the back face 3026. The first angled front surface 3036 and second angled front surface 3037 can extend from the juncture 3038 to opposite sides of the back face 3026. The first angled front surface 3036 can include an EV charger 3012 disposed therein. The second angled front surface 3037 can include an EV charger 3013 disposed therein. The angling of the first angled front surface 3036 and the second angled front surface 3037 can better position the EV chargers disposed thereon for user access. For example, when the housing 3004 and pole base cabinet 3000 are disposed between two adjacent parking spaces, the EV charger 3012 can be angled toward one parking space while the EV charger 3013 can be angled toward the other parking space to promote user access. In some variants, the front face 3024 can include more than two angled surfaces with EV chargers disposed thereon. In some variants, more than one EV charger can be disposed on each of first angled front surface 3036 and second angled front surface 3037.

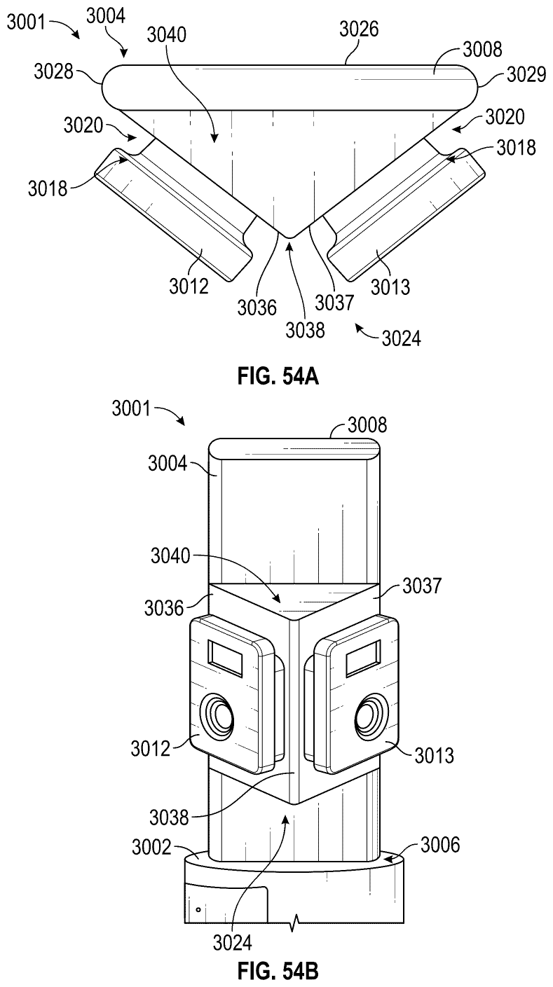

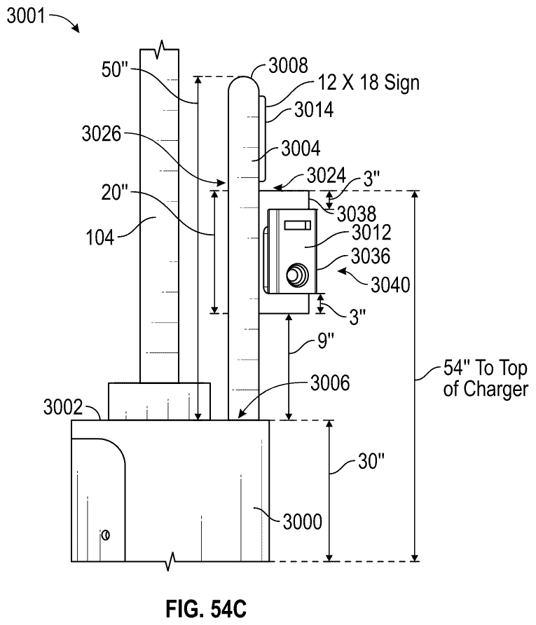

FIGS. 54A, 54B, and 54C illustrate a housing 3004 with a protrusion 3040, which can also be referred to as an extrusion, structure, mount, etc., having a plurality of EV chargers disposed herein. The protrusion 3040 can extend from the front face 3024 of the housing 3004. The protrusion 3040 can, in some variants, be formed in the front face 3024 of the housing 3004, which can include casting, 3D printing, bending, etc. In some variants, the protrusion 3040 can be coupled to the front face 3024, which can include via welding, adhering, bonding, bolting, fastening, clamping, etc. In some variants, the protrusion 3040 can be formed via bending and/or welding and then be coupled to the front face 3024. The protrusion 3040 can have a first angled front surface 3036 and a second angled front surface 3037 with a juncture 3038 therebetween, similar to as described in reference to FIGS. 53A-53C. The EV charger 3012 can be disposed on the first angled front surface 3036. The EV charger 3013 can be disposed on the second angled front surface 3037. In some variants, more than one EV charger can be disposed on each of the first angled front surface 3036 and/or second angled front surface 3037. The protrusion 3040 can be disposed at varying positions on the front face 3024, which can include at an intermediate position between the first end 3006 and second end 3008, proximate the second end 3008, or proximate the first end 3006. In some variants, more than one protrusion 3040 can extend from the front face 3024 of the housing 3004.

FIG. 54C illustrate a side view of the housing 3004 with example dimensions, which are not limiting. For example, the sign 3014, can be twelve by eighteen inches. The distance between a top surface of the top plate 3002 of the pole base cabinet 3000 and the second end 3008 of the housing 3004 can be 50 inches. The vertical length of the protrusion 3040 can be twenty inches. The distance between the top plate 3002 of the pole base cabinet 3000 and the bottom surface of the protrusion 3040 can be nine inches. The distance between a ground surface and a top surface of the EV charger 3012 can be fifty-four inches. The distance between the top surface of the EV charger 3012 and the top of the protrusion 3040 can be three inches. The distance between a ground surface and the top surface of the top plate 3002 can be thirty inches. The distance between a bottom surface of the EV charger 3012 and bottom surface of the protrusion 3040 can be three inches.

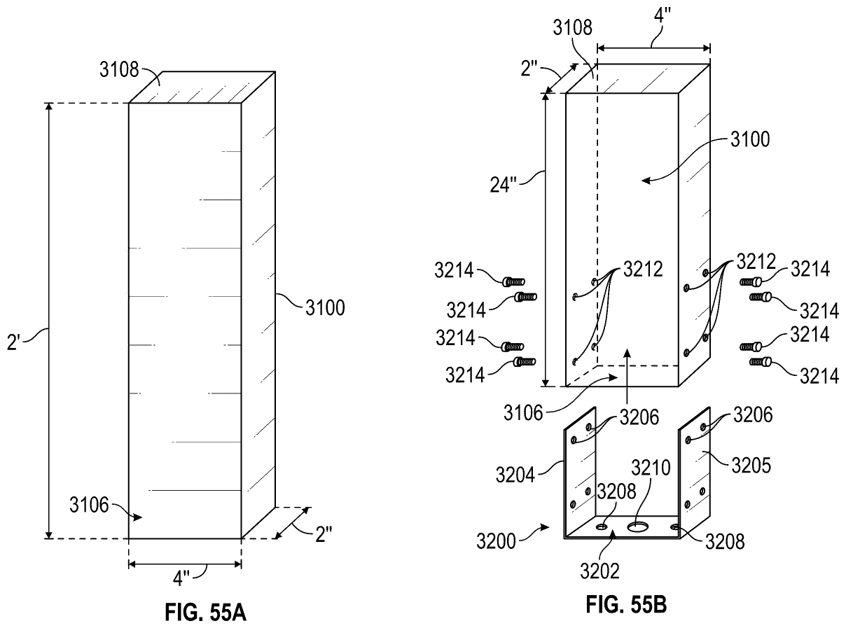

FIG. 55A shows a housing 3100, which can also be referred to as an EV charging housing, stand, EV charging stand, support structure, frame, mount, and/or EV charging mount. The housing 3100 can include a cavity therein, which can store one or more items and/or through which one or more cables, wires, or the like can be routed from an interior of the pole base cabinet 3000 to an EV charger. The housing 3100 can be disposed on, which can include being coupled to, the pole base cabinet 3000 (e.g., top plate 3002 of the pole base cabinet 3000). The housing 3100 can have a first end 3106 and second end 3108. The first end 3106 can be coupled to the pole base cabinet 3000, which can include the top plate 3002. The first end 3106 can be open. The second end 3108 can, in some variants, be a free end. The second end 3108 can be closed. The housing 3100 can be a variety of shapes and/or sizes. In some variants, the housing 3100 can be elongate. In some variants, the housing 3100 can have a periphery or cross-section that is circular, oval, polygonal (e.g., square, rectangular, etc.), irregular, and/or others. The housing 3100 can be a rectangular prism.

Examples dimensions are provided in FIG. 55A, which are not limiting. For example, the housing 3100 can have a height, from the first end 3106 to the second end 3108 of two feet, width of four inches, and/or depth of two inches.

FIG. 55B shows a bracket 3200 that can be used to mount the housing 3100 to the pole base cabinet 3000, which can include the top plate 3002. The bracket 3200 can include a bottom plate 3202 and a first vertical plate 3204 and second vertical plate 3205 extending therefrom. The bottom plate 3202 can be coupled to the pole base cabinet 3000, which can include the top plate 3002 of the pole base cabinet 3000. The bottom plate 3202 can include holes 3208. The holes 3208 can be aligned coaxially, respectively, with holes disposed in the top plate 3002 of the pole base cabinet 3000 and bolts or screws can be used to secure the bracket 3200 to the top plate 3002. The bottom plate 3202 can include an opening 3210. The opening 3210 can be aligned coaxially with an opening in the top plate 3002 such that one or more cables, wires, or the like can be routed through the top plate 3002 and through the bottom plate 3202. The opening 3210 can be varying sizes and/or shapes, which can include circular, oval, polygonal, irregular, and/or others.

The first vertical plate 3204 and second vertical plate 3205 can be offset from each other, which can include being parallel to each other. The first vertical plate 3204 and/or second vertical plate 3205 can be disposed on opposite ends of the bottom plate 3202. The first vertical plate 3204 and/or second vertical plate 3205 can include a plurality of holes 3206, which can correspond to holes 3212 disposed in the housing 3100, which can include being disposed in the vertical walls of the housing. For installation, the housing 3100 can be disposed over the bracket 3200 coupled to the top plate 3002. For example, the first vertical plate 3204 and second vertical plate 3205 can be disposed through the open first end 3106 such that the first vertical plate 3204 and second vertical plate 3205 are inside of the cavity of the housing 3100. The first vertical plate 3204 and second vertical plate 3205 can be disposed proximate the vertical walls of the housing 3100 such that the holes 3206 are coaxially aligned with the holes 3212 and bolts or screws 3214 can be disposed therethrough to couple the housing 3100 to the bracket 3200, resulting in the housing 3100 being coupled to the top plate 3002 of the pole base cabinet 3000. An EV charger can be mounted to any surface of the housing 3100. One or more cables, wires, or the like can be routed from an interior of the pole base cabinet 3000, through the top plate 3002 of the pole base cabinet 3000, through the opening 3210 of the bottom plate 3202 of the bracket 3200, through the cavity of the housing 3100, and to the EV charger, which can include being routed through one of the walls (e.g., opening therein) of the housing 3100.

In some variants, the EV charger can be coupled to the pole base cabinet 3000 (e.g., the top plate 3002). In some variants, the EV charger can be coupled to a pole disposed on the pole base cabinet 3000. In some variants, the housing 3004 can be coupled to a pole disposed on the pole base cabinet 3000. In some variants, the housing 3004 can be coupled to a pole that is not disposed on a pole base cabinet 3000. In some variants, the one or more cables or the like can be routed from the pole base cabinet 3000 through a pole mounted thereon to the EV charger 3012.

In some variants, a template, which can be made of various materials (e.g., paper, metal, metal alloys, polymers such as plastic, etc.), can provide a graphic illustrating the relative positioning of holes to be drilled in the front face 3024 of the housing 3004 to mount the EV charger 3012 and/or protrusion 3040. The template can be provided to an operator to facilitate installing the housing 3004 and EV charger 3012. Laws and/or regulations (e.g., ADA laws) may require that the EV charger 3012 be located at a set height or within a range of heights relative to the ground to promote accessibility. Accordingly, the operator can position the template on the front face 3024 at a suitable height off the ground to determine the appropriate hole positioning and drill and/or otherwise form holes in the front face 3024 to mount the EV charger 3012 and/or protrusion 3040 thereon. This can allow the operator to adjust the mounting height of the EV charger 3012 and/or protrusion 3040 to accommodate for varying base (e.g., footing) sizes, pole base cabinet sizes, etc. while using the same housing 3004.

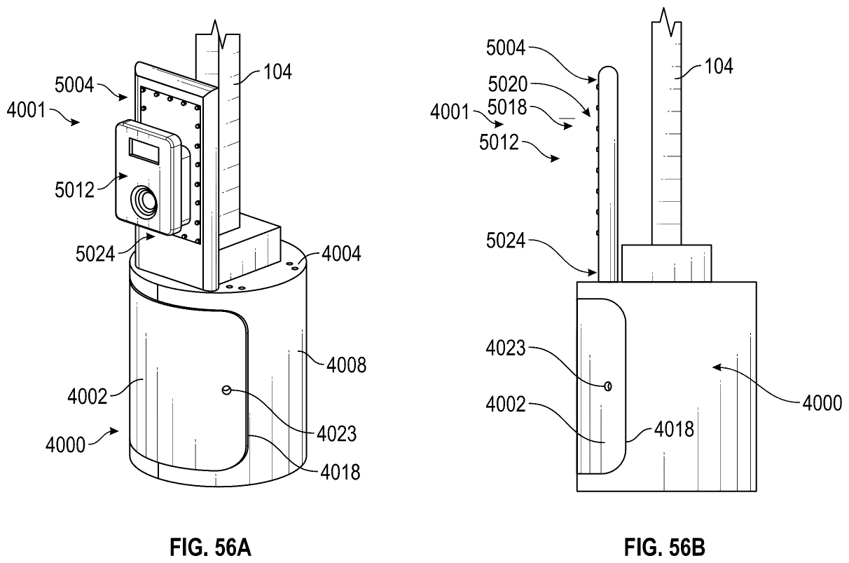

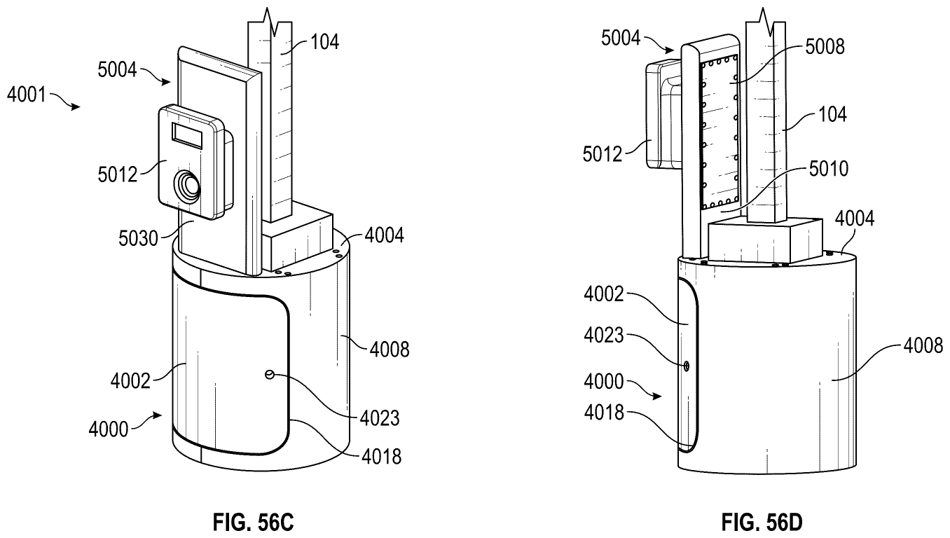

FIGS. 56A and 56B illustrate an electric vehicle (EV) charging station 4001 with a housing 5004, which can also be referred to as an EV charging housing, stand, EV charging stand, support structure, frame, mount, and/or EV charging mount. The housing 5004 can support an EV charger 5012 and one or more components thereof, such as a charging cable, connector, user interface, display, signage, etc. The EV charger 5012 can include a back surface 5018 that can curve and/or be angled to define a gap 5020 between a front face 5024 of the housing 5004 and the back surface 5018. A charging cable or the like can be disposed in the gap 5020 and supported by the back surface 5018, which can facilitate orderly storage of a charging cable.

The housing 5004 can, in some variants, include a cavity or hollow interior through which one or more cables, wires, or the like can be routed, which can facilitate connection between the EV charger 5012 and one or more features disposed inside a cavity of a base cabinet 4000, such as a data and/or power interface. The base cabinet 4000 can be at least the same as, similar to, and/or incorporate features from any of the pole base cabinets described herein. The base cabinet 4000 can include a peripheral wall 4008 extending around a periphery thereof. A main opening 4018 can extend through the peripheral wall 4008 to provide access into the cavity of the base cabinet 4000. The main opening 4018 can be covered by a door 4002 that can open to provide access into the cavity through the peripheral wall 4008 and close to block access. A lock 4023 can lock the door 4002 closed and unlock to enable the door 4002 to be opened.

The housing 5004 can be coupled (e.g., bolted, screwed, fastened, welded, adhered, etc.) to a top plate 4004 of the base cabinet 4000. The housing 5004 can be disposed proximate a pole 104 that can be supported by the base cabinet 4000. Components, such as cables, wires, and the like can be routed through the base cabinet 4000 to the pole 104. In some variants, no pole 104 is disposed on the base cabinet 4000.

The housing 5004 can be configured in numerous shapes and/or sizes. In some variants, the housing 5004 can be elongate. The housing 5004 can have varying peripheries and/or cross-sections, such as an oval, circular, polygonal (e.g., square, rectangular, etc.), irregular, and/or other periphery and/or cross-section. In some variants, the housing 5004 can be a shell, which can include having a wall surrounding a hollow interior. In some variants, the housing 5004 can be formed from structural components being joined together to form the housing 5004 with an internal cavity. In some variants, the structural components can form the exterior surface or wall of the housing 5004. In some variants, the housing 5004 can be coupled to the base cabinet 4000 (e.g., top plate 4004) and extend vertically away therefrom. In some variants, the housing 5004 can be a rectangular prism with rounded elongate sides and a top rounded periphery.

In some variants, as shown in FIGS. 56C and 56D, the housing 5004 can be rotated or reoriented (e.g., rotated or reoriented one hundred and eighty degrees) such that a removable panel 5008 is disposed on a rear surface of the housing 5004, which can include facing the pole 104. The removable panel 5008 can cover an opening in a second panel 5010 providing access into an internal cavity of the housing 5004. The removable panel 5008 can be removed to service the housing 5004, components in the housing 5004, EV charger 5012, etc. The surface, wall, or panel 5030 can face away from the pole 104. The EV charger 5012 can be mounted on the surface 5030. In some variants, multiple (e.g., two, three, four) EV chargers 5012 are disposed on the housing 5004. In some variants, multiple (e.g., two, three, four) housings 5004 are disposed on the base cabinet 4000 and one or more (e.g., two, three, four) EV chargers 5012 are disposed on each of the multiple housings 5004.

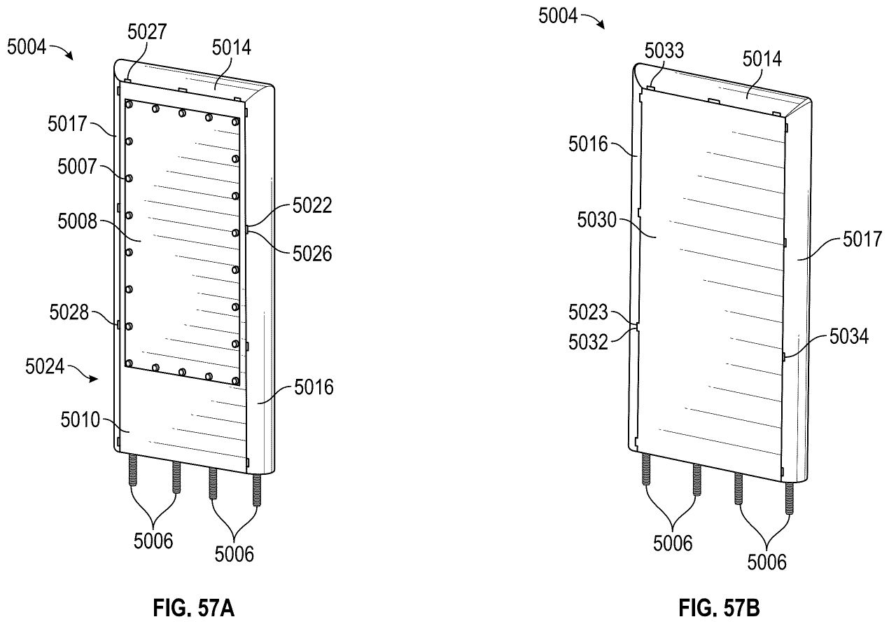

FIGS. 57A and 57B illustrate varying views of the housing 5004. In some variants, the housing 5004 can be 3D printed, cast, machined, molded, and/or formed using other methods. In some variants, the housing 5004 can be formed from multiple components joined together, which can include welded together.

The housing 5004 can include a front face 5024, which can be a rear face 5024 as described herein. The front face 5024 can include a first front panel 5008 (plank, wall), which can be a first rear panel 5008 (plank, wall). The first front panel 5008 can be coupled to the housing 5004 with a plurality of screws 5007 (bolts, fasteners). The first front panel 5008 can be removed from the housing 5004 to provide access into a cavity within the housing 5004. In some variants, the screws 5007 can be pan head tamper-resistant machine screws. In some variants, the EV charger 5012 can be mounted to the first front panel 5008. The first front panel 5008 can cover an opening in a second front panel 5010 (plank, wall) that provides access into the cavity. Together, the first front panel 5008 and the second front panel 5010 can define the front face 5024. The first front panel 5008 and/or second front panel 5010 can be flat. The first front panel 5008 and/or second front panel 5010 can have rectangular peripheries. The first front panel 5008 can have a periphery that is smaller than a periphery of the second front panel 5010.

The housing 5004 can include a back panel 5030 (plank, wall), which can be positioned opposite the front face 5024. The back panel 5030 can be a front panel 5030 (plank, wall) as described herein (e.g., facing forward or away from a pole 104). The back panel 5030 can define a back face of the housing 5004 or, in some variants, a front face of the housing 5004. In some variants, the size of the outer periphery of the back panel 5030 can be the same as the size of the outer periphery of the second front panel 5010. In some variants, an EV charger 5012 can be mounted on the back or front panel 5030.

The housing 5004 can include a first side panel 5016 (wall) and a second side panel 5017 (wall). The first side panel 5016 and second side panel 5017 can be disposed on opposing sides of the housing 5004. The first side panel 5016 and second side panel 5017 can define the longitudinal edges or sides of the housing 5004. The width of the first side panel 5016 can establish a thickness or depth of the cavity within the housing 5004. The first side panel 5016 and second side panel 5017 can be curved (e.g., have a rounded cross-section), which can define rounded edges or sides to the housing 5004. The first side panel 5016 and second side panel 5017 can be coupled to the second front panel 5010 and the back panel 5030. In some variants, the first side panel 5016 and the second side panel 5017 can be the same. In some variants, the first side panel 5016 can be in a mirrored orientation of the second side panel 5017 relative to a central longitudinal plane of the housing 5004 when the housing 5004 is assembled together.

The housing 5004 can include a top panel 5014 (wall). The top panel 5014 can define a top of the housing 5004. The top panel 5014 can define a width and/or thickness of the housing 5004. The top panel 5014 can be curved (e.g., have a curved cross-section), which can define a rounded top edge or side of the housing 5004. The top panel 5014 can be coupled to the second front panel 5010, back panel 5030, first side panel 5016, and/or second side panel 5017.

In some variants, the second front panel 5010, back panel 5030, second side panel 5017, first side panel 5016, and/or top panel 5014 can include complementary features that help to properly orient the foregoing components relative to each other, which can include prior to welding the foregoing components together. In some variants, the complementary features can provide structural rigidity or strength to the housing 5004 when assembled together. In some variants, the second front panel 5010 and/or back panel 5030 can include one or more tabs and the first side panel 5016, second side panel 5017, and/or top panel 5014 can include one or more notches configured to receive the one or more tabs to facilitate orientation. In some variants, the second front panel 5010, back panel 5030, second side panel 5017, first side panel 5016, and/or top panel 5014 can include one or more notches and/or tabs to facilitate relative positioning. In some variants, the second front panel 5010, back panel 5030, second side panel 5017, first side panel 5016, and/or top panel 5014 do not include complementary features to facilitate proper orientation. In some variants, the second front panel 5010, back panel 5030, second side panel 5017, first side panel 5016, and/or top panel 5014 can be welded together.

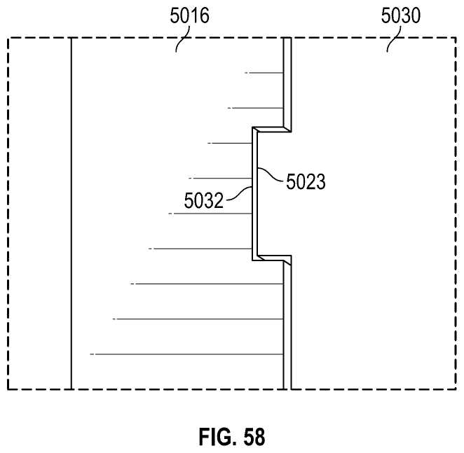

For example, the second front panel 5010 can include one or more tabs 5022 disposed about a periphery thereof that can correspond to one or more notches 5026 of the first side panel 5016, one or more notches 5028 of the second side panel 5017, and/or one or more notches 5027 of the top panel 5014. The notches 5026, 5027, 5028 (recesses, cutouts, gaps) can be respectively distributed along at least a portion of the front facing peripheries of the first side panel 5016, second side panel 5017, and top panel 5014. The tabs 5022 can be placed in the one or more notches 5026, one or more notches 5028, and/or notches 5027 to properly orient the first side panel 5016, second side panel 5017, and/or top panel 5014 relative to the second front panel 5010. The back panel 5030 can include one more tabs 5023 which can correspond to one or more notches 5032 of the first side panel 5016, one or more notches 5034 of the second side panel 5017, and/or one or more notches 5033 of the top panel 5014. The notches 5032, 5033, 5034 (recesses, cutouts, gaps) can be respectively distributed along at least a portion of the rear facing peripheries of the first side panel 5016, second side panel 5017, and top panel 5014. The tab 5023 can be placed in the one or more notches 5032, one or more notches 5034, and/or one or more notches 5033 to properly orient the first side panel 5016, second side panel 5017, and/or top panel 5014 relative to the back panel 5030. Properly oriented relative to each other, the first side panel 5016, second side panel 5017, top panel 5014, second front panel 5010, and/or back panel 5030 can be welded together. An example of the tab 5023 of the back panel 5030 positioned within the notch 5032 of the first side panel 5016 is illustrated in FIG. 58.

Returning to FIGS. 57A and 57B, the housing 5004 can be coupled to the base cabinet 4000 with one or more bolts 5006 (fasteners, screws). In some variants, the housing 5004 can be coupled to the base cabinet 4000 with four bolts 5006. The one or more bolts 5006 can extend from a bottom of the housing 5004 to facilitate coupling with the base cabinet 4000.

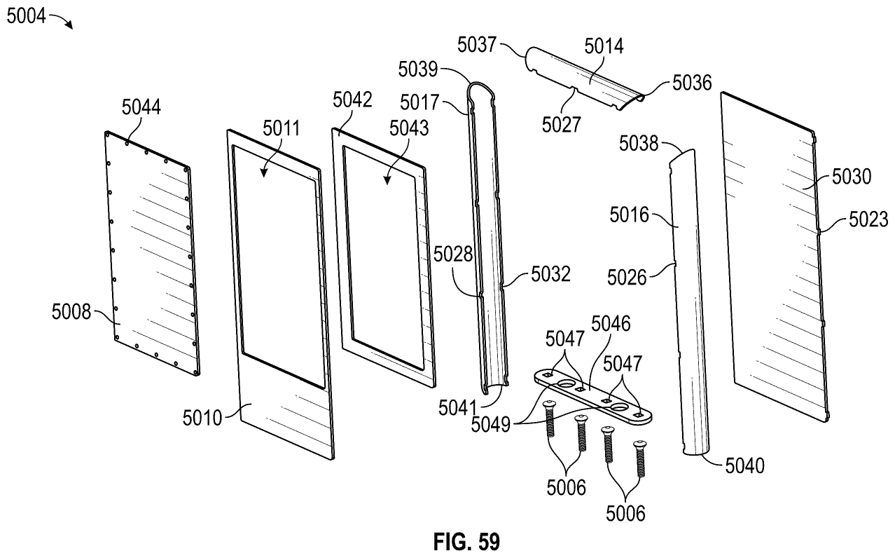

FIG. 59 illustrates an exploded view of the housing 5004. As illustrated the first front panel 5008 can include a plurality of apertures 5044 through which the screws 5007 can extend to facilitate coupling the first front panel 5008 to a frame 5042 (support, structure, including a wall 5042 as discussed herein to which an EV charger 5012 is mounted, including via a first front panel 5008 as discussed herein). The frame 5042 can include an opening 5043. The frame 5042 can have a rectangular periphery. The second front panel 5010 can include an opening 5011. The frame 5042 can be positioned relative to the second front panel 5010 such that the frame 5042 is disposed around a periphery of the second front panel 5010 defining the opening 5011 and extend into the opening 5011 so that the first front panel 5008 may be positioned within the opening 5011 and secured to the frame 5042, blocking the opening 5011 and opening 5043. The first front panel 5008 can be removed from the opening 5011 and decoupled from the frame 5042 to provide access into an internal cavity of the housing 5004 through the opening 5011 and opening 5043.

The first side panel 5016 can include a first end 5040 and a first top angled end 5038, which can be disposed at opposite ends of the first side panel 5016. The first end 5040 can be flat. The first end 5040 can extend around a curved end portion of a bottom panel 5046 of the housing 5004. The first end 5040 can contact the top plate 4004 of the base cabinet 4000. The first top angled end 5038 can be angled. The first top angled end 5038 can contact a first angled end 5036 of the top panel 5014 to define a corner of the housing 5004.

The second side panel 5017 can include a second end 5041 and a second top angled end 5039, which can be disposed at opposite ends of the second side panel 5017. The second end 5041 can be flat. The second end 5041 can extend around a curved end portion of a bottom panel 5046 of the housing 5004. The second end 5041 can contact the top plate 4004 of the base cabinet 4000. The second top angled end 5039 can be angled. The second top angled end 5039 can contact a second angled end 5037 of the top panel 5014 to define a corner of the housing 5004.

The housing 5004 can include a bottom panel 5046 (plate, plank, wall). The bottom panel 5046 can be an elongate panel with rounded ends. The rounded ends can correspond to the rounded inner periphery of the first end 5040 and second end 5041. The bottom panel 5046 can define a bottom of the housing 5004. The bottom panel 5046 can include slots 5047 (holes, apertures, openings). The slots 5047 can be various shapes and sizes, which can include circular, oval, polygonal (e.g., square, rectangle), irregular, and/or others. The plurality of bolts 5006 can be respectively disposed through the slots 5047 to couple the housing 5004 to the base cabinet 4000. The bottom panel 5046 can include a first opening 5048 (aperture, hole) and/or a second opening 5049 (aperture, hole). The first opening 5048 can be disposed between adjacent slots 5047. The second opening 5049 can be disposed between adjacent slots 5047. In some variants, cables, wires, and/or other components can be routed from the base cabinet 4000 through the first opening 5048 and/or second opening 5049, into the internal cavity of the housing 5004, and to the EV charger 5012. In some variants, supports, members, bars, rods, struts, beams, braces, and/or other structures can extend from the top plate 4004 of the base cabinet 4000 and into the housing 5004 through the first opening 5048 and/or second opening 5049 to provide structural support to the housing 5004. In some variants, supports, members, bars, rods, struts, beams, braces, and/or other structures can extend from the bottom panel 5046 through the inside of the housing 5004 to provide structural support to the housing 5004.

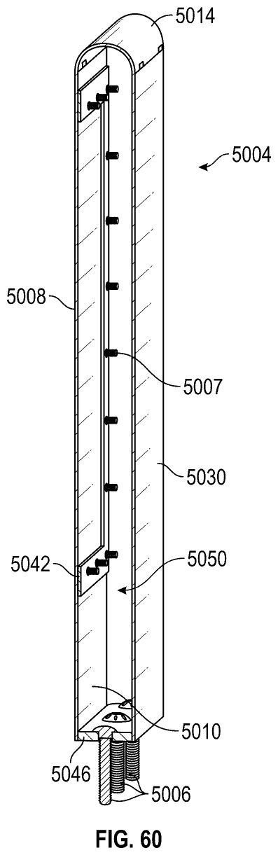

FIG. 60 illustrates a sectioned view of the housing 5004 to show the cavity 5050 thereof. As described herein, the cavity 5050 can be used to store one or more items, including routing one or more cables through the housing 5004 to the EV charger 5012. As described herein, the first front panel 5008 can be coupled to the frame 5042 by way of the screws 5007 to block the opening 5011 of the second front panel 5010. In some variants the outer surface of the first front panel 5008 can be flush with the surrounding outer surface of the second front panel 5010. The second front panel 5010, frame 5042, and/or first front panel 5008 can be parallel relative to the back panel 5030. The second front panel 5010, frame 5042, and/or first front panel 5008 can be offset from the back panel 5030. The bottom panel 5046 can be oriented perpendicular relative to the second front panel 5010 and back panel 5030.

The housing 5004 can be manufactured via a variety of techniques. In some variants, the first front panel 5008, second front panel 5010, frame 5042, first side panel 5016, second side panel 5017, top panel 5014, back panel 5030, and/or bottom panel 5046 can be cut from one or more sheets of material. In some variants, the first side panel 5016, second side panel 5017, and/or top panel 5014 can be bent to form curved shapes. In some variants, the first side panel 5016, second side panel 5017, and/or top panel 5014 can be cast in a curved shape. The frame 5042 can be attached (e.g., welded, adhered, bolted, fastened, etc.) to the second front panel 5010 around the opening 5011 thereof. The first side panel 5016, second side panel 5017, and top panel 5014 can be connected to the back panel 5030 and second front panel 5010. In some variants, the back panel 5030 and/or second front panel 5010 can include tabs (e.g., tabs 5023) that can be inserted into one or more notches in the first side panel 5016, second side panel 5017, and/or top panel 5014 to facilitate the proper orientation therebetween. The back panel 5030 and second front panel 5010 can be welded to the first side panel 5016, second side panel 5017, and top panel 5014. The first top angled end 5038 of the first side panel 5016 can be disposed against the first angled end 5036 of the top panel 5014. The second top angled end 5039 of the second side panel 5017 can be disposed against the second angled end 5037 of the top panel 5014. The first end 5040 of the first side panel 5016, second end 5041 of the second side panel 5017, bottom periphery of the back panel 5030, and bottom periphery of the second front panel 5010 can be attached (e.g., welded, adhered, fastened, etc.) to a periphery of the bottom panel 5046. The curve of the first side panel 5016 and second side panel 5017 can correspond to the curve of the ends of the bottom panel 5046. The housing 5004 can be attached to the top plate 4004 as described herein by coupling the bottom panel 5046 to the top plate 4004 with the bolts 5006. The first front panel 5008 can be disposed within the opening 5011 of the second front panel 5010 and coupled to the frame 5042 with one or more screws and/or bolts to enclose the cavity of the housing 5004.

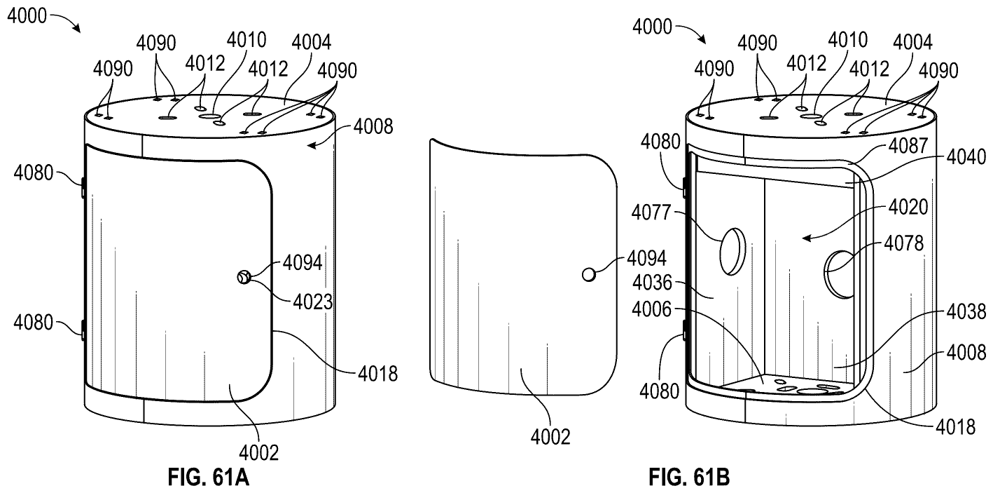

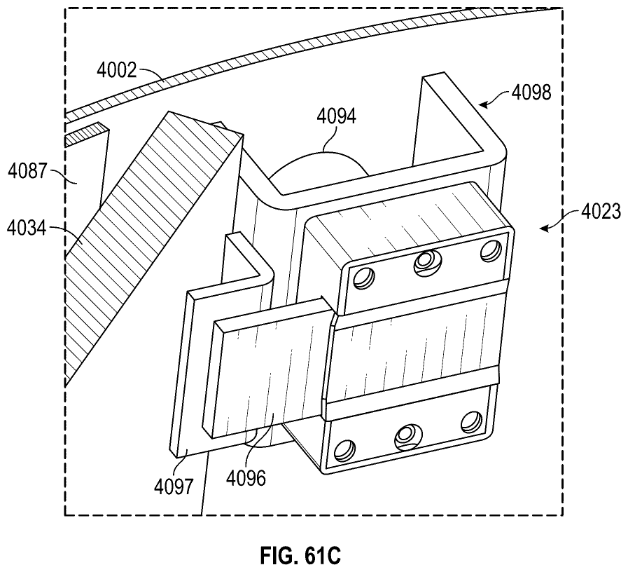

With reference to FIGS. 61A-63B, a pole base cabinet, base cabinet, cabinet, casing, housing, enclosure, locker base cabinet 4000 is described. Base cabinet 4000 can include substantially the same or similar features described or shown herein in reference to other configurations of pole base cabinets. Similarly numbered features can be the same or similar.

As shown in FIG. 61A, the base cabinet 4000 can include a top plate 4004 (first plate, disc, sheet). The top plate 4004 can have a periphery that is circular (as illustrated), oval, polygonal, irregular, and/or others. The top plate 4004 can include an opening 4010 (aperture, hole), which can be centrally disposed on the top plate 4004. Cables, wires, optical fibers, or the like can be routed into and/or out of an internal cavity of the base cabinet 4000 by way of the opening 4010. In some variants, one or more cables, wires, or the like can be routed to the pole 104 and/or EV charger 5012, which can be by way of the housing 5004, through the opening 4010 and/or other opening in the top plate 4004. The opening 4010 can have a circular, polygonal, irregular, and/or other shape. In a configuration, a periphery defining the opening 4010 can be rounded to reduce abrasion on devices extending therethrough. In a configuration, a periphery defining the opening 4010 can be coated or covered with a non-abrasive material to reduce abrasion on devices extending therethrough.

The top plate 4004 can include a plurality of apertures 4012, which can include two, three, four, five, six, or more. The apertures 4012 can be used to secure the top plate 4004 to a pole base, such as a pole base plate. For example, bolts attached to a pole base can extend through the apertures 4012 and be secured with nuts, washers, and/or other similar devices, coupling the top plate 4004 and pole base cabinet 4000 to the pole base of the pole 104. The apertures 4012 can have a circular, polygonal, irregular, and/or other shape. The apertures 4012 can be elongate with rounded ends. The apertures 4012 can all be the same or have varying shapes and/or sizes. The apertures 4012 can be arranged in different configurations. For example, the apertures 4012 can cooperate to form a square with each aperture 4012 forming a corner thereof. The apertures 4012 can cooperate to form a circular, polygonal, irregular, and/or other shape depending on the configuration to couple to a corresponding pole base and/or to provide suitable bolting for structural integrity.

The top plate 4004 can include a plurality of slots 4090 (holes, apertures, openings). The top slots 4090 can be used to couple or anchor internal structures of the base cabinet 4000 to the top plate 4004. In some variants, the top slots 4090 extend through the entirety of the top plate 4004. In some variants, the top slots 4090 extend partially through the top plate 4004. In some variants, the top plate 4004 does not include top slots 4090. In some variants, internal structures of the base cabinet 4000 are oriented relative to the top plate 4004 using the top slots 4090, as described herein, and the internal structures are then welded thereto.

The base cabinet 4000 can include a peripheral wall, side, surface 4008, which can also be referred to as a skin and/or wall. The peripheral wall 4008 can extend from and/or be coupled, which can include directly, rigidly, or fixedly connected, to the top plate 2004 and to a bottom plate. The peripheral wall 4008 can extend from and/or be coupled, which can include directly, rigidly, or fixedly connected, to a periphery of the top plate 4004 to and/or proximate a periphery of the bottom plate. The peripheral wall 4008 can extend and/or be coupled, which can include directly, rigidly, or fixedly connected, around the periphery of the top plate 4004 and/or periphery of the bottom plate. The peripheral wall 4008 can define a periphery of the base cabinet 4000, which can be circular, polygonal, irregular, and/or other shapes. The peripheral wall 4008 can define a periphery of the base cabinet 4000 that can be the same as or similar to the shape of the periphery of the top plate 4004 and/or periphery of the bottom plate. The peripheral wall 4008 can define a rounded or circular periphery of the base cabinet 4000, which can be similar to a tube. The peripheral wall 4008 can be welded to the top plate 4004 and/or the bottom plate. In some variants, the base cabinet 4000 does not include a peripheral wall 4008.

The peripheral wall 4008 can define a main opening 4018. The main opening 4018 can provide access into a cavity of the base cabinet 4000. The cavity can be centrally located in the base cabinet 4000. The cavity can house items and/or components, which can include the items and/or components detailed herein. The main opening 4018 can be varying sizes and shapes, which can include circular, polygonal, irregular, and/or others. In a configuration, the main opening 4018 can be rectangular in shape with rounded corners. The main opening 4018 can extend to proximate the top plate 4004 and proximate the bottom plate.

The main opening 4018 can be covered with a door 4002, permanently or temporarily preventing and/or restricting access to the cavity of the base cabinet 4000. The door 4002 can be locked with a lock 4023 to prevent access to the cavity through the main opening 4018 and/or unlocked to allow the door 4002 to be opened to allow access into the cavity through the main opening 4018. A key can be inserted through an aperture 4094 (hole, opening) to access the lock 4023 to lock or unlock the door 4002. The door 4002 can be coupled to the base cabinet 4000 with one or more hinges 4080 (e.g., two) allowing the door 4002 to be swung open and closed while remaining coupled to the base cabinet 4000. The hinges 4080 can be coupled to the peripheral wall 4008 proximate the main opening 4018 and coupled to the door 4002. The door 4002 can have a curvature matching a curvature of the peripheral wall 4008. The door 4002 can have a perimeter or periphery that matches the main opening 4018 such that the door 4002 can cover the main opening 4018. The door 4002 can be a thickness matching that of the peripheral wall 4008.

FIG. 61B illustrates the base cabinet 4000 with the door 4002 removed therefrom, allowing access into the cavity 4020 through the main opening 4018. The base cabinet 4000 can include a seal 4087 (gasket, flange). The seal 4087 can extend inward from a periphery of the main opening 4018 into the main opening 4018 such that the door 4002, when over the main opening 4018, contacts the seal 4087, which can prevent water, dust, and/or other particulate from entering into the cavity 4020 when the door 4002 is over the main opening 4018.

FIG. 61C illustrates the lock 4023 (lock mechanism) of the base cabinet 4000. The lock 4023 can be mounted on a bracket 4098 (support) attached to the door 4002. The lock 4023 can include a tab 4096 (flange) that can be extended or retracted to prevent or allow the door 4002 to be opened (e.g., swung open) about the hinges 4080. FIG. 61C illustrates the lock 4023 in a locked configuration with the tab 4096 extended to contact a flange 4097 (bracket) mounted on an internal structure of the base cabinet 4000 (e.g., first support panel 4034). In an unlocked configuration, the tab 4096 can be retracted to not contact the flange 4097, allowing the door 4002 to be opened. A key can be inserted through the aperture 4094 and engaged with the lock 4023 to extend or retract the tab 4096.

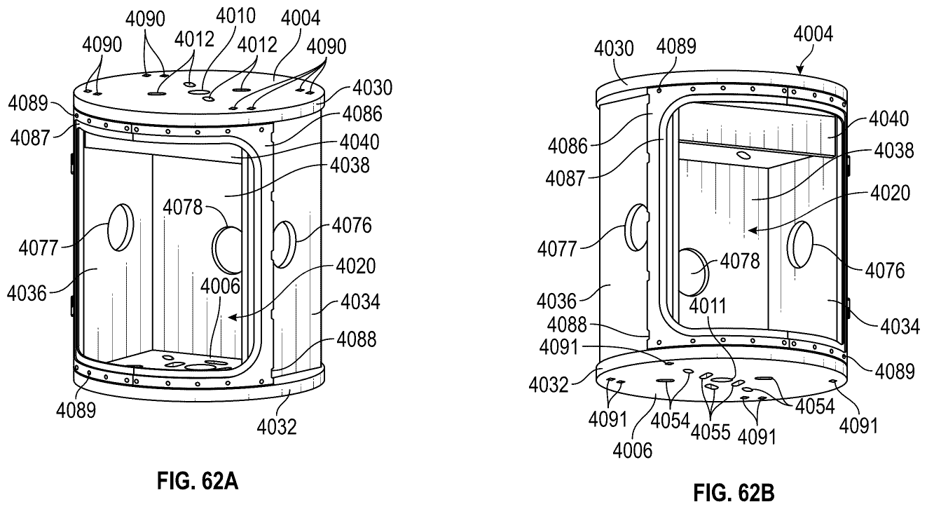

FIGS. 62A and 62B illustrate the base cabinet 4000 with the peripheral wall 4008 removed. As shown, the base cabinet 4000 can include a frame providing structural support and/or integrity, wherein the frame can have a plurality of support panels and one or more internal braces. The peripheral wall 4008 can be coupled, which can include directly, rigidly, or fixedly connected, to portions of the frame, which can include welded.

The pole base cabinet 4000 can have a bottom or second plate, disc, sheet 4006. The bottom plate 4006 can have a periphery 4032 that is circular or oval, polygonal, irregular, and/or others. The periphery 4032 of the bottom plate 4006 can be the same as a periphery 4030 of the top plate 4004. The periphery 4032 of the bottom plate 4006 can be different than the periphery 4030 of the top plate 204.

The bottom plate 4006 can have an opening 4011. The opening 4011 can used to permit wiring, cords, optical fibers, and/or other devices through the bottom plate 4006 and into and/or out of the cavity 4020 of the pole base cabinet 4000. For example, wiring and/or cables can be routed through conduits in a footing or base upon which the base cabinet 4000 is mounted and extend through the opening 4011 and into the cavity 4020. The wiring and/or cables can be used to supply electrical power to components/items stored in the cavity 4020, components/items stored outside the cavity 4020, and/or a light source mounted on a pole 104 that is coupled to the base cabinet 4000. The opening 4011 can be centrally located on the bottom plate 4006. In a configuration, the opening 4011 can be located at any position on the bottom plate 4006. The opening 4011 can have a circular, polygonal, irregular, and/or other shape. In a configuration, a periphery defining the opening 4011 can be rounded to reduce abrasion on devices extending therethrough. In a configuration, a periphery defining the opening 4011 can be coated or covered with a non-abrasive material to reduce abrasion on devices extending therethrough. The opening 4011 can be the same as or different than the opening 4010. In a configuration, the opening 4011 can be larger than the opening 4010.

The bottom plate 4006 can have a plurality of apertures 4054 (e.g., four) and/or apertures 4055 (e.g., three), which can include two, three, four, five, six, or more apertures 4054 and/or apertures 4055. The apertures 4054 and/or apertures 4055 can be used to secure the bottom plate 4006 to a footing or base, such as a concrete base or other support or structure, which can include a footing above grade or below grade. For example, bolts or an anchor attached to the footing and/or rebar can extend through the apertures 4054 and/or apertures 4055 and be secured with nuts, washers, and/or other similar devices, coupling the bottom plate 4006 and the base cabinet 4000 to the footing. The plurality of apertures 4054 can be the same as the plurality of apertures 4012 and/or arranged in a similar configuration. The apertures 4054 and/or apertures 4055 can have a circular, polygonal, irregular, and/or other shape, which can at least include elongate with rounded ends. The apertures 4054 and/or apertures 4055 can all be the same or have varying shapes and/or sizes. The apertures 4054 and/or apertures 4055 can be arranged in different configurations. The apertures 4054 can cooperate to form a square with each aperture 4054 forming a corner thereof. The apertures 4054 can cooperate to form a circular, polygonal, irregular, and/or other shape depending on what configuration is require to couple to a corresponding footing or bolt arrangement. In some variants, the apertures 4054 can be centered around the opening 4011. In some variants, a longitudinal length of the apertures 4054 can be oriented such that a central longitudinal axis along the length of the apertures 4054 can intersect with the opening 4010, which can include a central axis therethrough. In some variants, the apertures 4055 can be spaced inward of the apertures 4054. In some variants, the apertures 4055 can be larger than the apertures 4054. In some variants, the apertures 4055 can be disposed about the opening 4011. In some variants, the apertures 4055 can be oriented such that a longitudinal length of the apertures 4055 is oriented perpendicular relative to the central axis of the opening 4011.

The bottom plate 4006 can include a plurality of bottom slots 4091 (holes, apertures, openings). The bottom slots 4091 can be used to couple or anchor internal structures of the base cabinet 4000 to the bottom plate 4006. For example, protrusions or protuberances of internal panels of the base cabinet 4000 can be inserted into the bottom slots 4091 of the bottom plate 4006. In some variants, the bottom slots 4091 can extend through the entirety of the bottom plate 4006. In some variants, the bottom slots 4091 can extend partially through the bottom plate 4006. In some variants, the bottom plate 4006 does not include bottom slots 4091. In some variants, internal structures of the base cabinet 4000 can be oriented relative to the bottom plate 4006 using the top slots 4090 and the internal structures are then welded thereto.

The top plate 4004 and the bottom plate 4006 can be offset and/or parallel from each other. The top plate 4004 and the bottom plate 4006 can define ends and/or opposing ends of the base cabinet 4000. The top plate 4004 and the bottom plate 4006 can be flat. In a configuration, the top plate 4004 and the bottom plate 4006 can include recesses, curves, and/or contours. The top plate 4004 and the bottom plate 4006 can be positioned on, which can include centered about, a center-longitudinal axis of the base cabinet 4000. The top plate 4004 and the bottom plate 4006 can be centered on a center-longitudinal axis of the base cabinet 4000. In a configuration, the top plate 4004 can be the same as the bottom plate 4006. In a configuration, the top plate 4004 does not have an opening 4010 and/or the bottom plate 4006 does not have an opening 4011.

As shown, the base cabinet 4000 can include a frame 4086 (support, structure). The frame 4086 can include a plurality of apertures 4089 which can facilitate coupling to the seal 4087 and/or peripheral wall 4008. The door 4002 can be positioned, when placed over the main opening 4018, within an inner periphery of the frame 4086 to contact the seal 4087. In some variants, the frame 4086 can be disposed between the seal 4087 and the peripheral wall 4008. In some variants, the seal 4087 can be disposed between the frame 4086 and the peripheral wall 4008. The frame 4086 can include one or more notches 4088 (cut outs).

The plurality of support panels can include a first support panel, plank, girder, joist, pillar, plank, brace, beam 4034, second support panel, plank, girder, joist, pillar, plank, brace, beam 4036, and/or a third support panel, plank, girder, joist, pillar, plank, brace, beam 4038. The first support panel 4034, second support panel 4036, and/or a third support panel 4038 can at least partially define the cavity 4020. The first support panel 4034, second support panel 4036, and/or a third support panel 4038 can extend between and/or be coupled, which can include directly, rigidly, or fixedly connected, to the top plate 4004 and the bottom plate 4006 (e.g., inward faces surfaces of the top plate 4004 and the bottom plate 4006), which can include disposed inside of peripheries of the top plate 4004 and/or bottom plate 4006. The first support panel 4034, second support panel 4036, and/or a third support panel 4038 can form three sides of a rectangular-like structure surrounding or at least partially surrounding the cavity 4020. In some variants, the base cabinet 4000 does not include a third support panel 4038.

The first support panel 4034, second support panel 4036, and/or third support panel 4038 can be the same, similar, or different size and shape. The first support panel 4034, second support panel 4036, and/or a third support panel 4038 can be rectangular. The first support panel 4034, second support panel 4036, and/or a third support panel 4038 can be straight or curved.

The first support panel 4034, second support panel 4036, and/or third support panel 4038 can include openings, which can enable wiring, cables, optical fibers, or the like to be routed therethrough. The openings can have a circular, polygonal, irregular, and/or other shapes. In a configuration, a periphery defining the openings can be rounded to reduce abrasion on devices extending therethrough. In a configuration, a periphery defining the openings can be coated or covered with a non-abrasive material to reduce abrasion on devices extending therethrough. The first support panel 4034 can include a first opening 4076. The first opening 4076 can be centrally disposed. In some variants, the first opening 4076 can be closer to the top plate 4004, bottom plate 4006, or a longitudinal edge of the first support panel 4034. The second support panel 4036 can include a second opening 4077. The second opening 4077 can be centrally disposed. In some variants, the second opening 4077 can be closer to the top plate 4004, bottom plate 4006, or a longitudinal edge of the second support panel 4036. In some variants, the first support panel 4034 and second support panel 4036 can be the same. The third support panel 4038 can include a third opening 4078. The third opening 4078 can be disposed closer to the bottom plate 4006 than the top plate 4004. In some variants, the third opening 4078 can be centrally disposed. In some variants, the third opening 4078 can be closer to the top plate 4004 and/or a longitudinal edge of the third support panel 4038. In some variants, the third opening 4078 can be disposed closer to the bottom plate 4006 than the first opening 4076 and/or second opening 4077. In some variants, the third opening 4078, first opening 4076, and/or second opening 4077 can be equidistantly spaced away from the bottom plate 4006.

The first support panel 4034 can be offset from and/or parallel to the second support panel 4036. The third support panel 4038 can extend between and/or be coupled, which can include directly, rigidly, or fixedly connected, to the first support panel 4034 and the second support panel 4036. The third support panel 4038 can extend between and/or be coupled to, which can include directly, rigidly, or fixedly connected, ends or proximate ends (e.g., longitudinal sides), which can include spaced inward of a longitudinal side) of the first support panel 4034 and second support panel 4036. The third support panel 238 can extend between and/or be coupled, which can include directly, rigidly, or fixedly connected, to ends or proximate ends of the first support panel 4034 and second support panel 4036 that are opposite the main opening 4018. The third support panel 4038 can extend between and/or be coupled, which can include directly, rigidly, or fixedly connected, to inward facing surfaces of the first support panel 4034 and second support panel 4036. The third support panel 4038 can be positioned opposite the main opening 4018. The third support panel 4038 can be perpendicular to the first support panel 4034 and/or second support panel 4036.

The pole base cabinet 4000 can include an internal stiffening panel, plank, girder, joist, pillar, plank, brace, beam 4040. The brace 4040 can be coupled, which can include directly, rigidly, or fixedly connected, to the top plate 4004. The brace 4040 can extend away from the top plate 4004. The brace 4040 can extend to a position between the top plate 4004 and the bottom plate 4006, providing room for items to be store in the cavity 4020. The brace 4040 can extend to a distance that that is less than 1/20, 1/19, 1/18, 1/17, 1/16, 1/15, 1/14, 1/13, 1/12, 1/11, 1/10, 1/9, ⅛, 1/7, ⅙, ⅕, ¼, ⅓, and/or ½ the height of the cavity 4020, distance between the top plate 4004 and the bottom plate 4006, and/or length (e.g., height) of the first support panel 4034, second support panel 4036, and/or third support panel 4038. The brace 4040 can be rectangular, square, and/or other shaped panels. The brace 4040 can be straight or curved. The brace 4040 can extend between and/or be coupled to, which can include directly, rigidly, or fixedly connected, the first support panel 4034 and the second support panel 4036. The brace 4040 can extend between and/or be coupled to, which can include directly, rigidly, or fixedly connected, ends or proximate ends (e.g., lateral sides), which can include inward of longitudinal edges, of the first support panel 4034 and the second support panel 4036. The brace 4040 can be positioned proximate the main opening 4018. The brace 4040 can be positioned opposite the third support panel 4038. The brace 4040 can be offset from and/or parallel to the third support panel 4038. The opening 4010 and/or plurality of apertures 4012 can be positioned between the brace 4040 and the third support panel 4038.

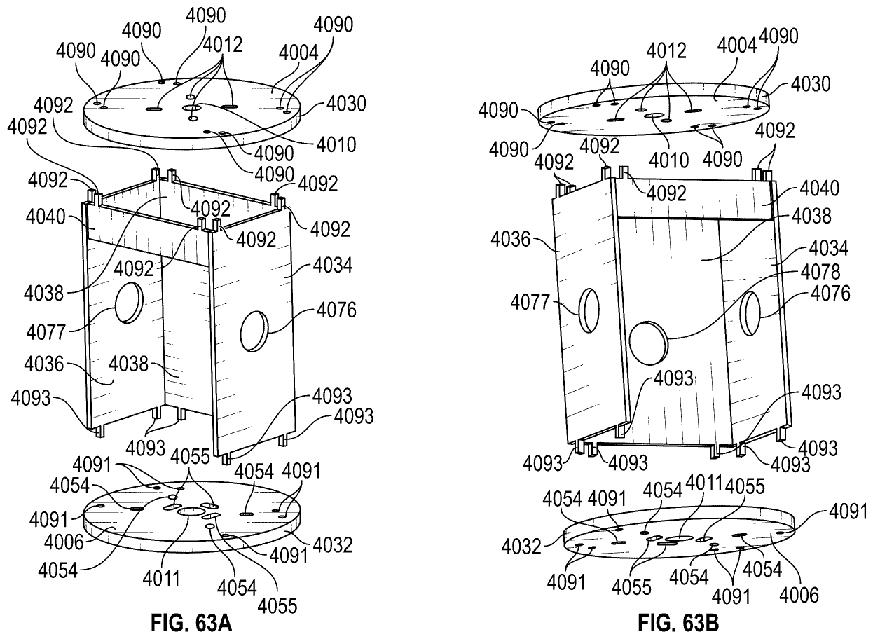

FIGS. 63A and 63B illustrate a partially exploded view of the frame of the base cabinet 4000 with the top plate 4004 and the bottom plate 4006 removed. Each of the first support panel 4034, second support panel 4036, third support panel 4038, and/or brace 4040 can include top protrusions 4092 (protuberances, rods, beams, keys, members) and/or bottom protrusions 4093 (protuberances, rods, beams, keys, members) that extend from and out of a surface or edge of the first support panel 4034, second support panel 4036, third support panel 4038, and/or brace 4040 to which the top protrusion 4092 and/or bottom protrusions 4093 are attached or connected to. The top protrusions 4092 and/or bottom protrusions 4093 can be used to orient the first support panel 4034, second support panel 4036, third support panel 4038, and/or brace 4040 on the top plate 4004 and bottom plate 4006. In some variants, the first support panel 4034, second support panel 4036, third support panel 4038, and/or brace 4040 can be oriented on the top plate 4004 welded in place. In some variants, the first support panel 4034, second support panel 4036, and/or third support panel 4038 can be oriented on the bottom plate 106 and welded in place. The top protrusions 4092 can be inserted into the top slots 4090 of the top plate 4004. The bottom protrusions 4093 can be inserted into the bottom slots 4091 of the bottom plate 4006. In some variants, the insertion of the top protrusions 4092 into the top slots 4090 and/or the insertion of the bottom protrusions 4093 into the bottom slots 4091 can improve the structural integrity and/or rigidity of the base cabinet 4000. In some variants, the first support panel 4034, second support panel 4036, third support panel 4038, and/or brace 4040 do not include top protrusions 4092 and/or bottom protrusions 4093. In some variants, the top plate 4004 and/or bottom plate 4006 can include the protrusions and the first support panel 4034, second support panel 4036, third support panel 4038, and/or brace 4040 can include the slots.

The brace 4040 can include top protrusions 4092 (e.g., two). The top protrusions 4092 can extend from a top periphery of the brace 4040. The brace 4040 can include two top protrusions 4092, which can be spaced apart from each other and proximate sides of the brace 4040. The top protrusions 4092 can be inserted into corresponding top slots 4090 of the top plate 4004.

The first support panel 4034 can include top protrusions 4092 (e.g., two). The top protrusions 4092 can extend from a top periphery of the first support panel 4034. The first support panel 4034 can include two top protrusions 4092, which can be spaced apart from each other and proximate sides of the first support panel 4034. The top protrusions 4092 can be inserted into corresponding top slots 4090 of the top plate 4004. The first support panel 4034 can include bottom protrusions 4093 (e.g., two). The bottom protrusion 4093 can extend from a bottom periphery of the first support panel 4034. The first support panel 4034 can include bottom protrusions 4093, which can be spaced apart from each other and proximate longitudinal sides of the first support panel 4034. The bottom protrusions 4093 can be inserted into corresponding bottom slots 4091 of the bottom plate 4006.

The second support panel 4036 can include top protrusions 4092 (e.g., two). The top protrusions 4092 can extend from a top periphery of the second support panel 4036. The second support panel 4036 can include two top protrusions 4092, which can be spaced apart from each other and proximate longitudinal sides of the second support panel 4036. The top protrusions 4092 can be inserted into corresponding top slots 4090 of the top plate 4004. The second support panel 4036 can include bottom protrusions 4093 (e.g., two). The bottom protrusions 4093 can extend from a bottom periphery of the second support panel 4036. The second support panel 4036 can include bottom protrusions 4093, which can be spaced apart from each other and proximate sides of the second support panel 4036. The bottom protrusions 4093 can be inserted into corresponding bottom slots 4091 of the bottom plate 4006.

The third support panel 4038 can include top protrusions 4092 (e.g., two). The top protrusions 4092 can extend from a top periphery of the third support panel 4038. The third support panel 4038 can include two top protrusions 4092, which can be spaced apart from each other and proximate longitudinal sides of the third support panel 4038. The top protrusions 4092 can be inserted into corresponding top slots 4090 of the top plate 4004. The third support panel 4038 can include bottom protrusions 4093 (e.g., two). The bottom protrusions 4093 can extend from a bottom periphery of the third support panel 4038. The third support panel 4038 can include bottom protrusions 4093, which can be spaced apart from each other and proximate sides of the third support panel 4038. The bottom protrusions 4093 can be inserted into corresponding bottom slots 4091 of the bottom plate 4006.

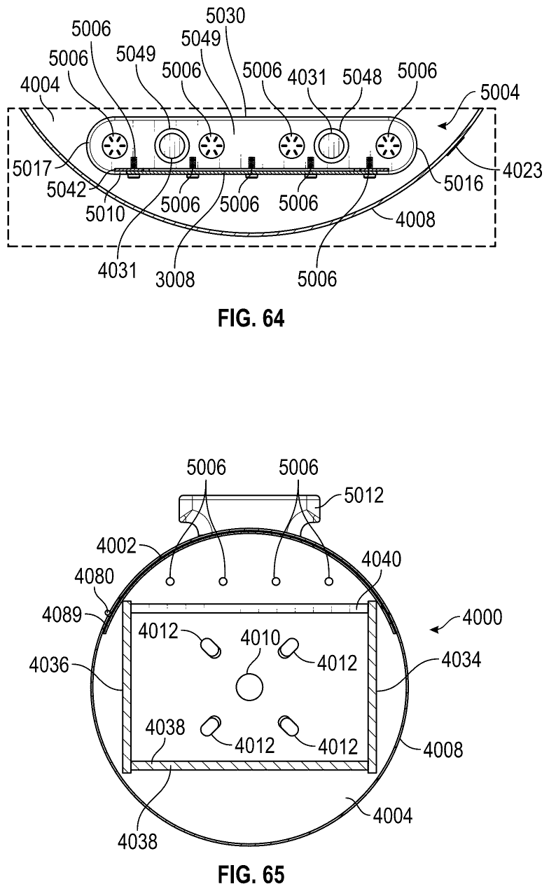

FIG. 64 shows a section view of the housing 5004 coupled to the top plate 4004 of the base cabinet 4000. The bottom panel 5046 can be coupled to the top plate 4004. In some variants, one or more bolts 5006 (e.g., four) can couple the bottom panel 5046 to the top plate 4004. In some variants, the first opening 5048 and/or second opening 5049 can be disposed over corresponding openings 4031 (apertures, holes) in the top plate 4004 to permit the routing of one or more cables, wires, and the like from the cavity 4020 of the base cabinet 4000 into the housing 5004. As illustrated, the first front panel 5008 can be coupled to the frame 5042 with a plurality of bolts 5006.

FIG. 65 shows a section view of the base cabinet 4000 with the housing 5004 coupled to the top plate 4004. As illustrated, the bolts 5006 can extend through the top plate 4004 to facilitate coupling. In some variants, the bolts 5006 can be secured with one or more nuts disposed in the base cabinet 4000. As shown, the entirety of the frame, which can include the first support panel 4034, second support panel 4036, third support panel 4038, and/or brace 4040, can be disposed inside of the peripheral wall 4008 of the base cabinet 4000.

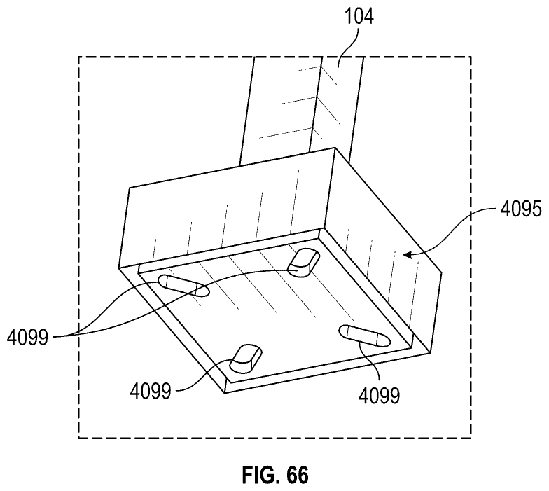

FIG. 66 shows a bottom portion of a pole 104. The pole 104 can include a base 4095 that can be coupled to the base cabinet 4000. The base 4095 can include one or more apertures 4099 (holes, openings) that can correspond in size, shape, and/or configuration to the apertures 4012 of the top plate 4004 to facilitate coupling. A bolt can extend through each of the apertures 4099 and apertures 4012 and secured with a nut disposed inside of the base cabinet 4000 to couple the base 4095 to the base cabinet 4000. In some variants, the base 4095 can include an opening that can correspond in size, shape, and/or configuration to the opening 4010 to permit the routing of wiring, cables, optical fibers, and the like therethrough. The opening in the base 4095 can be modified as the opening 4010.

The base cabinet 4000 can be manufactured via a variety of techniques. In some variants, the top plate 4004, bottom plate 4006, first support panel 4034, second support panel 4036, third support panel 4038, brace 4040, and/or peripheral wall 4008 can be cut from one or more panels or sheets of material. The first support panel 4034, second support panel 4036, third support panel 4038, and/or brace 4040 can be connected to the top plate 4004. In some variants, the first support panel 4034, second support panel 4036, third support panel 4038, and/or brace 4040 can include top protrusions 4092 that can be slid into top slots 4090 of the top plate 4004 to properly orient the first support panel 4034, second support panel 4036, third support panel 4038, brace 4040, and/or top plate 4004 to each other. In some variants, the first support panel 4034, second support panel 4036, third support panel 4038, and/or brace 4040 do not include top protrusions 4092. The first support panel 4034, second support panel 4036, and/or third support panel 4038 can be connected to the bottom plate 4006. In some variants, the first support panel 4034, second support panel 4036, and/or third support panel 4038 can include bottom protrusions 4093 that can be slid into bottom slots 4091 of the bottom plate 4006 to properly orient the first support panel 4034, second support panel 4036, third support panel 4038, and/or bottom plate 4006 to each other. In some variants, the first support panel 4034, second support panel 4036, and/or third support panel 4038 do not include bottom protrusions 4093. The first support panel 4034, second support panel 4036, third support panel 4038, top plate 4004, bottom plate 4006, and/or brace 4040 can be configured relative to each other as described herein and welded in place. The frame 4086 and/or seal 4087 can be coupled to the peripheral wall 4008 around the periphery of the main opening 4018 as described herein. In some variants, the frame 4086 and/or seal 4087 can be coupled to the peripheral wall 4008 with one or more screws or bolts. The flange 4097 can be secured (e.g., welded), adhered, and/or otherwise coupled to the first support panel 4034 to facilitate engagement with the tab 4096 of the lock 4023. The peripheral wall 4008 can be wrapped around and welded to the periphery 4030 of the top plate 4004 and periphery 4032 of the bottom plate 4006. The hinges 4080 can be coupled (e.g., welded, bolted, screwed, adhered, etc.) to the peripheral wall 4008 proximate the main opening 4018. The hinges 4080 can be coupled (e.g., welded, bolted, screwed, adhered, etc.) to the door 4002 to facilitate the door 4002 being swung open and closed to cover the main opening 4018. The bracket 4098 with the lock 4023 can be coupled (e.g., welded, bolted, screwed, adhered, etc.) to the door 4002 such that the lock 4023 is accessible through the aperture 4094 in the door 4002.

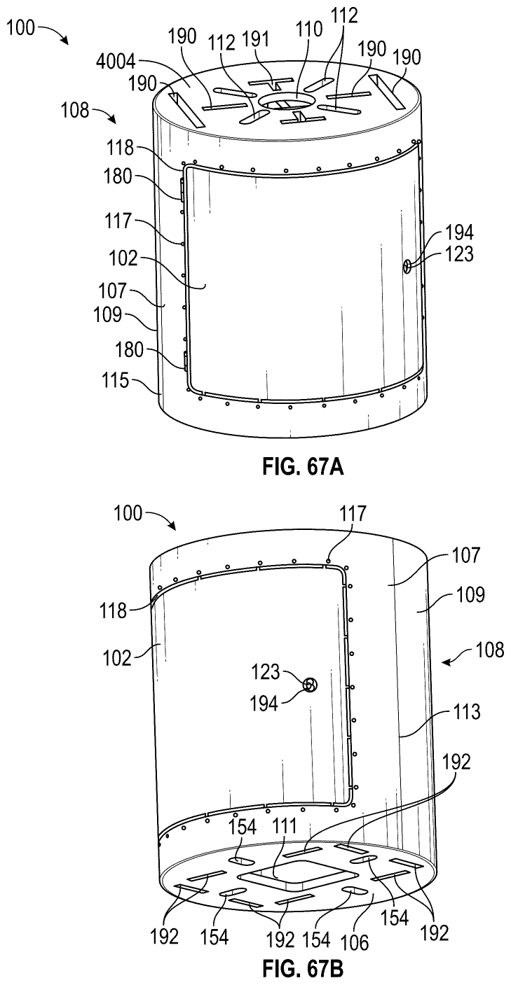

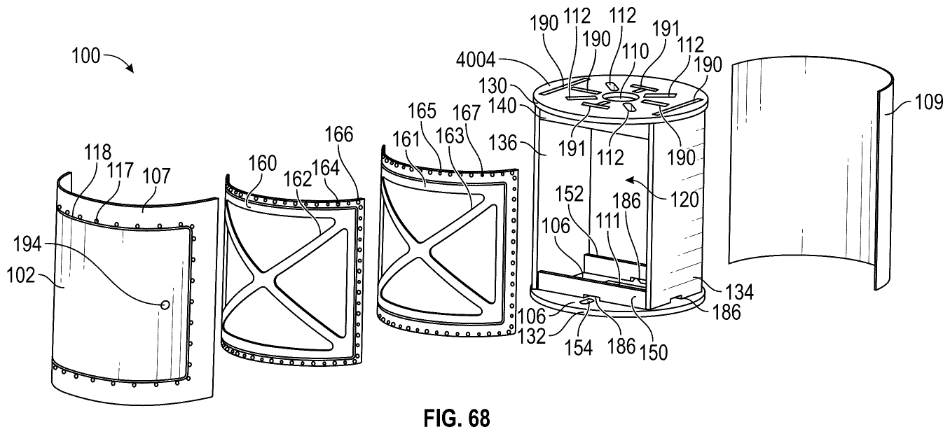

As shown in FIGS. 67A and 67B, the pole base cabinet 100 can have a top or first plate, disc, sheet 4004. The top plate 4004 can have a periphery, perimeter 130 that is circular, as shown in FIG. 68, or polygonal, irregular, and/or others. The top plate 4004 can have a plurality of apertures 112, which can include two, three, four, five, six, or more. The apertures 112 can be used to secure the top plate 4004 to a pole base, such as a pole base plate. For example, bolts attached to a pole base can extend through the apertures 112 and be secured with nuts, washers, and/or other similar devices, coupling the top plate 4004 and pole base cabinet 100 to the pole base and pole. The apertures 112 can have a circular, polygonal, irregular, and/or other shape. The apertures 112 can be elongate with rounded ends. The apertures 112 can all be the same or have varying shapes and/or sizes. The apertures 112 can be arranged in different configurations. For example, the apertures 112 can cooperate to form a square with each aperture 112 forming a corner thereof. The apertures 112 can cooperate to form a circular, polygonal, irregular, and/or other shape depending on what configuration is required or desired to couple to a corresponding pole base and/or is needed for structural integrity. The apertures 112 can be disposed about an opening 110, which can be centrally disposed on the top plate 4004. The apertures 112 can be oriented such that at central axis extending along the longitudinal length of the apertures 112 intersect a central axis of the base cabinet 100.

The top plate 4004 can have an opening 110. The opening 110 can used to allow wiring, cords, optical fibers, and/or other devices through the top plate 4004 and into and/or out of a cavity of the base cabinet 100. The opening 110 can be centrally located. In a configuration, the opening 110 can be located at any position on the top plate 4004. The opening 110 can have a circular, polygonal, irregular, and/or other shape. In a configuration, a periphery defining the opening 110 can be rounded to reduce abrasion on devices extending therethrough. In a configuration, a periphery defining the opening 110 can be coated or covered with a non-abrasive material to reduce abrasion on devices extending therethrough. In a configuration, the apertures 112 can be distributed around the opening 110, which can include circumferentially or radially distributed. In a configuration, the opening 110 can be located centrally relative to the plurality of apertures 112. The opening 110 can be larger than each of the apertures 112.

The top plate 4004 can have a plurality (e.g., four) of slots 190 (apertures, openings) and/or a plurality (e.g., two) of slots 191 (apertures, openings). The slots 190 and/or slots 191 can be disposed through the top plate 4004. The slots 190 and/or slots 191 can be disposed about the opening 110. The slots 190 and/or slots 191 can receive tabs of one or more panels, braces, or the like, which can be structural features, disposed inside of the base cabinet 100. In some variants, a pair of slots 190 and/or a pair of slots 191 can be disposed in an alternating pattern with the apertures 112. The slots 190 and/or slots 191 can be a variety of shapes, which can at least include circular, oval, polygonal (e.g., rectangular, square, etc.), irregular, and/or others. In some variants, the slots 190 can be elongate and have a rectangular periphery. A first pair of the slots 190 can be disposed on opposing sides of the opening 110 and/or oriented such that a longitudinal axis of each of the first pair of slots 190 intersects with an axis of the opening 110 and/or extends through the other of the pair of slots 190. A second pair of slots 190, which can be longer than the first pair of slots 190, can be disposed on opposing sides of the opening 110 and/or oriented such that a longitudinal axis of each of the second pair of slots 190 is perpendicular to the longitudinal axis of each of the first pair of slots 190. In some variants, the slots 191 can be T-shaped, which can include a first portion of the slot 191 oriented such that a longitudinal axis thereof intersects with an axis of the opening 110 and/or intersects through the other of the slots 191 and a second portion of the slot 191 that is perpendicular to the first portion of the slot 191.

The base cabinet 100 can have a bottom or second plate, disc, sheet 106. The bottom plate 106 can have a periphery 132 that is circular, as shown in FIG. 68, or polygonal, irregular, and/or others. The periphery 132 of the bottom plate 106 can be the same as the periphery 130 of the top plate 4004. The periphery 132 of the bottom plate 106 can be different than the periphery 130 of the top plate 4004. The bottom plate 106 can have a plurality of apertures 154, which can include two, three, four, five, six, or more apertures 154. The apertures 154 can be used to secure the bottom plate 106 to a footing or base, such as a concrete base or other support or structure, which can include a footing above grade or below grade. For example, bolts or an anchor attached to the footing and/or rebar can extend through the apertures 154 and be secured with nuts, washers, and/or other similar devices, coupling the bottom plate 106 and the base cabinet 100 to the footing. The plurality of apertures 154 can be the same as or similar to the plurality of apertures 112. The apertures 154 can have a circular, polygonal, irregular, and/or other shape. The apertures 154 can be elongate with rounded ends. The apertures 154 can all be the same or have varying shapes and/or sizes. The apertures 154 can be arranged in different configurations. The apertures 154 can cooperate to form a square shape with each aperture 154 forming a corner thereof. Longitudinal axes of the apertures 154 can be oriented to intersect a central axis of the opening 111. The apertures 154 can cooperate to form a circular, polygonal, irregular, and/or other shape depending on the configuration of a corresponding footing or bolt arrangement. In a configuration, the top plate 4004 can be the same as the bottom plate 106.

The bottom plate 106 can have an opening 111. The opening 111 can used to allow wiring, cords, optical fibers, and/or other devices through the bottom plate 106 and into and/or out of the cavity of the base cabinet 100. For example, wiring and/or cables can be routed through conduits in a footing or base upon which the base cabinet 100 is mounted and extend through the opening 111 and into the cavity of the base cabinet 100. The wiring and/or cables can be used to supply electrical power to components/items stored in the cavity, components/items stored outside the cavity, and/or a light source mounted on a pole that is coupled to the base cabinet 100. The opening 111 can be centrally located. In a configuration, the opening 111 can be located at any position on the bottom plate 106. The opening 111 can have a circular, polygonal, irregular, and/or other shape. The opening 111 can be rectangular or square with rounded corners. In a configuration, a periphery defining the opening 111 can be rounded to reduce abrasion on devices extending therethrough. In a configuration, a periphery defining the opening 111 can be coated or covered with a non-abrasive material to reduce abrasion on devices extending therethrough. In a configuration, the apertures 154 can be distributed around the opening 111, which can include circumferentially or radially distributed. In a configuration, the opening 111 can be located centered relative to the plurality of apertures 154. The opening 111 can be larger than each of the apertures 254. The opening 211 can be the same as or different (e.g., larger or smaller) than the opening 110.

The bottom plate 106 can include a plurality (e.g., eight) slots 192 (apertures, openings). The slots 192 can be disposed through the bottom plate 106. The slots 192 can be disposed about the opening 111. The slots 192 can receive tabs of one or more panels, braces, or the like, which can be structural features, disposed inside of the base cabinet 100. In some variants, the slots 192 can be distributed about the opening 111. In some variants, a pair of slots 192 can be disposed between adjacent apertures 154. In some variants, the slots 192 can be arranged to form a square or rectangle with a pair of slots 192 defining corners thereof. The slots 192 can be a variety of shapes, which can at least include circular, oval, polygonal (e.g., rectangular, square, etc.), irregular, and/or others. In some variants, the slots 192 can be elongate and have a rectangular periphery.

The top plate 4004 and the bottom plate 106 can be offset and/or parallel from each other. The top plate 4004 and the bottom plate 106 can define ends and/or opposing ends of the base cabinet 100. The top plate 4004 and the bottom plate 106 can be flat. In a configuration, the top plate 4004 and the bottom plate 106 can include recesses, curves, and/or contours. The top plate 4004 and the bottom plate 106 can be positioned on a center-longitudinal axis of the base cabinet 100. The top plate 4004 and the bottom plate 106 can be centered on a center-longitudinal axis of the base cabinet 100. In a configuration, the top plate 4004 can be the same as the bottom plate 106. In a configuration, the top plate 4004 does not have an opening 110 and/or the bottom plate 106 does not have an opening 111.

The base cabinet 100 can have a peripheral wall, side, surface 108, which can also be referred to as a skin and/or wall 108. The peripheral wall 108 can extend from and/or be coupled, which can include directly, rigidly, or fixedly connected, to the top plate 4004 to the bottom plate 106. The peripheral wall 108 can extend from and/or be coupled, which can include directly, rigidly, or fixedly connected, to the periphery 130 of the top plate 204 to and/or proximate a periphery 132 of the bottom plate 106. The peripheral wall 108 can extend and/or be coupled, which can include directly, rigidly, or fixedly connected, around the periphery 130 of the top plate 4004 and/or periphery 132 of the bottom plate 106. The peripheral wall 108 can define a periphery of the pole base cabinet 100, which can be circular, polygonal, irregular, and/or other shapes. The peripheral wall 108 can define a periphery of the base cabinet 100 that can be the same as or similar to the shape of the periphery 130 of the top plate 4004 and/or periphery 132 of the bottom plate 106. The peripheral wall 108 can define a rounded or circular periphery of the pole base cabinet 100, which can be similar to a tube. In some variants, the peripheral wall 108 can be formed from at least two sections (portions, pieces), which can include a first section 107 and a back section 109. The first section 107 and back section 109 can each form half of the peripheral wall 108. The first section and back section 109 can be joined together at a seam 115 on one side of the base cabinet 100 and at a seam 113 on another side of the base cabinet 100.

The peripheral wall 108 can define a main opening 118. The main opening 118 can provide access into a cavity of the base cabinet 100. The cavity can be centrally located in the base cabinet 100. The cavity can house items and/or components, which can include the items and/or components detailed herein. The main opening 118 can be varying sizes and shapes, which can include circular, polygonal, irregular, and/or others. In a configuration, the main opening 118 can be rectangular in shape with rounded corners. The main opening 118 can extend to proximate the top plate 4004 and proximate the bottom plate 106.

The main opening 118 can be covered with a door 102, which can inhibit access into the cavity. The main opening 118 can be uncovered with the door 102 removed to allow access to the cavity of the base cabinet 100. The door 102 can be locked and/or unlocked. The door 102 can include vents. In a configuration, the peripheral wall 108 can include vents. In a configuration, the door 102 can be coupled to the pole base cabinet 100 with hinges 180, allowing the door 102 to be swung open and closed while remaining coupled to the base cabinet 100. The hinges 180 can be coupled to the peripheral wall 108 and the door 102. The door 102 can have a curvature matching a curvature of the peripheral wall 108. The door 102 can have a perimeter or periphery that matches or is similar to the main opening 118 such that the door 102 can cover the main opening 118. The door 102 can be a thickness matching that of the peripheral wall 108. In some variants, an outer surface of the door 102 can be flush with an outer surface of the peripheral wall 108. One or more frames can be coupled to the peripheral wall 108 about the periphery of the main opening 118, which can include coupling with rivets, bolts, screws, fasteners, or the like through the holes 117. In some variants, the frames can be welded or adhered to the peripheral wall 108.

The base cabinet 100 can include a lock 123 (lock mechanism) that can unlock and lock the door 102. The lock 123 can be accessed through an aperture 194 (hole, opening) in the door 102.

FIG. 68 shows the base cabinet 100 with the peripheral wall 108 removed and a first frame 164 (structure) and a second frame 165 (structure) separated from the peripheral wall 108 (e.g., the first section 107 of the peripheral wall 108). The first frame 164 and the second frame 165 can be coupled to the peripheral wall 108 (e.g., the first section 107 of the peripheral wall 108) about a periphery of the main opening 118. The first frame 164 can be disposed between the second frame 165 and the peripheral wall 108. The first frame 164 can space away the second frame 165 from the inside of the peripheral wall 108 to provide space for a gasket, seal, or the like to be disposed (e.g., adhered) to a portion of the second frame 165 extending into the main opening 118 such that the door 102 contacts the gasket, seal, or the like, which can help to prevent dust, liquid, and/or other particulate from entering into the base cabinet 100.

The first frame 164 can be cut from a sheet of material with a support structure 160 having an x-shaped support 162 forming triangular openings with the support 162 providing structural integrity similar to a truss structure. The first frame 164 can be rolled and/or bent to have a curved shape. The support structure 160 can help to avoid warping, distortion, and/or other abnormalities. After rolling and/or bending, the support structure 160 can be removed. The frame 160 can be coupled to the peripheral wall 108 (e.g., first section 107) around a periphery of the main opening 118, which can include being coupled with one or more bolts, screws, fasteners, or the like by way of the apertures 166. The inner periphery of the first frame 164 can be disposed around the periphery of the main opening 118.

The second frame 165 can be cut from a sheet of material with a support structure 161 having an x-shaped support 163 forming triangular openings with the support 162 providing structural integrity similar to a truss structure. The second frame 165 can be rolled and/or bent to have a curved shape. The support structure 161 can help to avoid warping, distortion, and/or abnormalities. After rolling and/or bending, the support structure 161 can be removed. The second frame 165 can be coupled to the first frame 164 and peripheral wall 108 (e.g., first section 107) around a periphery of the main opening 118, which can include being coupled with one or more bolts, screws, fasteners, or the like by way of the apertures 167. The inner periphery of the second frame 165 can be disposed around the periphery of the main opening 118.

The base cabinet 100 can include a frame providing structural support and/or integrity, wherein the frame can have a plurality of support panels and/or a plurality of braces. The peripheral wall 108 can be coupled, which can include directly, rigidly, or fixedly connected, to portions of the frame, top plate 4004, and/or bottom plate 106, which can include welded.

The plurality of support panels can include a first support panel, plank, girder, joist, pillar, plank, brace, beam 134, and/or a second support panel, plank, girder, joist, pillar, plank, brace, beam 136. The first support panel 134, second support panel 136, top plate 4004, and/or bottom plate 106 can at least partially define the cavity 120. The cavity 120, as described herein, can house one or more items therein. The cavity 120 can be disposed between the top plate 4004, bottom plate 106, first support panel 134, and/or second support panel 136. The cavity 120 can be disposed on an inside of the base cabinet 100.

The first support panel 134 and/or second support panel 136 can extend between and/or be coupled, which can include directly, rigidly, or fixedly connected, to the top plate 4004 and the bottom plate 106. The first support panel 134 and/or second support panel 136 can be the same, similar, or different size and shape. The first support panel 134 and/or second support panel 136 can be rectangular in shape. The first support panel 134 and/or second support panel 136 can be straight or curved. The first support panel 134 can be offset from and/or parallel to the second support panel 136. In some variants, a third support panel can be coupled, which can include directly, rigidly, or fixedly connected, to the first support panel 134 and second support panel 136, which can include inward facing surfaces thereof. The third support panel can be oriented perpendicular relative to the first support panel 134 and second support panel 136. The first support panel 134 and/or second support panel 136 can include one or more notches 186 (recess, cutout, gap) disposed on bottom peripheries of the first support panel 134 and/or second support panel 136. The notches 186 can accommodate (e.g., provide space for) bolts extending through one of the apertures 154 to couple the bottom plate 106 to a base. The notches 186 can be central disposed on the first support panel 134 and/or second support panel 136.

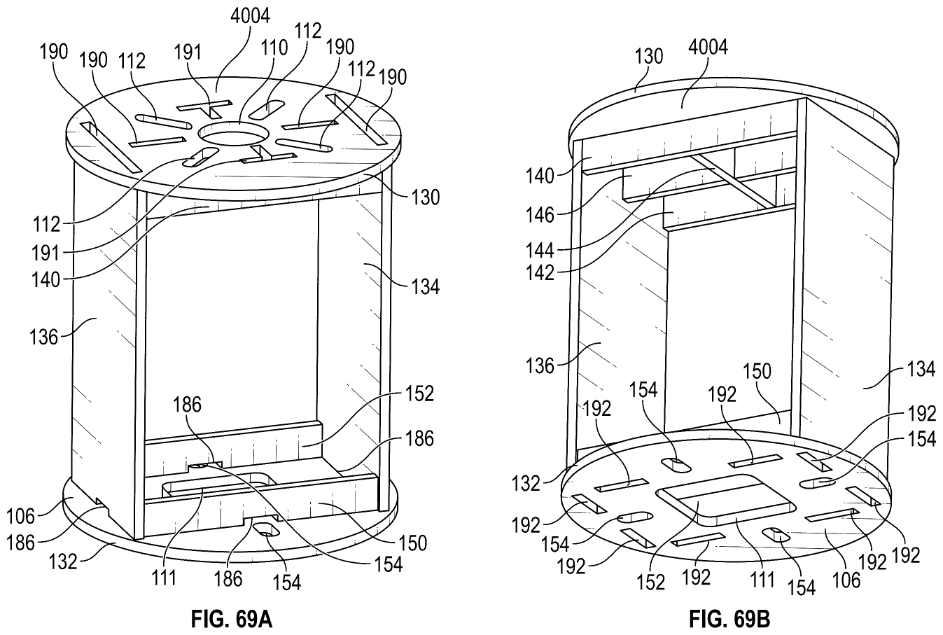

FIGS. 69A and 69B illustrate the base cabinet without the peripheral wall 108. As shown, the base cabinet 100 can include a plurality of internal stiffening panels, planks, girders, joists, pillars, planks, braces, beams, which can at least include the first brace 140 (first top brace), second brace 142 (second top brace), third brace 144 (third top brace), fourth brace 146 (fourth top brace), fifth brace 150 (first bottom brace), and/or sixth brace 152 (second bottom brace).

The first brace 140, second brace 142, third brace 144, and/or fourth brace 146 can be coupled, which can include directly, rigidly, or fixedly connected, to the top plate 4004. The first brace 140, second brace 142, third brace 144, and/or fourth brace 146 can extend equidistantly or to different distances away from the top plate 4004. The first brace 140, second brace 142, third brace 144, and/or fourth brace 146 can extend a distance to a position between the top plate 4004 and the bottom plate 106, providing room for items to be stored in the cavity 120, which can include a distance that that is at and/or less than 1/20, 1/19, 1/18, 1/17, 1/16, 1/15, 1/14, 1/13, 1/12, 1/11, 1/10, 1/9, ⅛, 1/7, ⅙, ⅕, ¼, ⅓, and/or ½ the height of the cavity 120, distance between the top plate 4004 and the bottom plate 106, and/or length (e.g., height) of the first support panel 134 and second support panel 136. The first brace 140, second brace 142, third brace 144, and/or fourth brace 146 can be rectangular, square, and/or other shaped panels. The first brace 140, second brace 142, third brace 144, and/or fourth brace 146 can be straight or curved.

The fifth brace 150 and/or sixth brace 152 can be coupled, which can include directly, rigidly, or fixedly connected, to the bottom plate 106. The fifth brace 150 and/or sixth brace 152 can extend equidistantly or to different distances away from the bottom plate 106. The fifth brace 150 and/or sixth brace 152 can extend a distance to a position between the bottom plate 106 and the top plate 4004, providing room for items to be stored in the cavity 120, which can include a distance that that is at and/or less than 1/20, 1/19, 1/18, 1/17, 1/16, 1/15, 1/14, 1/13, 1/12, 1/11, 1/10, 1/9, ⅛, 1/7, ⅙, ⅕, ¼, ⅓, and/or ½ the height of the cavity 120, distance between the bottom plate 106 and the top plate 4004, and/or length (e.g., height) of the first support panel 134 and second support panel 136. The fifth brace 150 and/or sixth brace 152 can be rectangular, square, and/or other shaped panels. The fifth brace 150 and/or sixth brace 152 can be straight or curved.

The first brace 140 can extend between and/or be coupled to, which can include directly, rigidly, or fixedly connected, the first support panel 134 and the second support panel 136. The first brace 140 can extend between and/or be coupled to, which can include directly, rigidly, or fixedly connected, ends or proximate ends (e.g., longitudinal sides or edges) of the first support panel 134 and the second support panel 136, which can include inward facing surfaces of the firsts support panel 134 and the second support panel 136. The first brace 140 can be positioned proximate the main opening 118. The first brace 140 can be perpendicularly oriented relative to the first support panel 134 and/or the second support panel 136. The first brace 140 can be parallel to and offset from the second brace 142 and/or fourth brace 146. The first brace 140 can be oriented perpendicular relative to the third brace 144.

The second brace 142 can extend between and/or be coupled to, which can include directly, rigidly, or fixedly connected, the first support panel 134 and the second support panel 136. The second brace 142 can extend between and/or be coupled to, which can include directly, rigidly, or fixedly connected, ends or proximate ends (e.g., longitudinal sides or edges) of the first support panel 134 and the second support panel 136, which can include inward facing surfaces of the firsts support panel 134 and the second support panel 136. The second brace 142 can be positioned proximate sides (e.g., longitudinal sides or edges) of the first support panel 134 and the second support panel 136 that are away from the main opening 118. The second brace 142 can be perpendicularly oriented relative to the first support panel 134 and/or the second support panel 136. The second brace 142 can be parallel to and offset from first brace 140 and/or fourth brace 146. The second brace 142 can be oriented perpendicular relative to the third brace 144.

The fourth brace 146 can extend between and/or be coupled to, which can include directly, rigidly, or fixedly connected, the first support panel 134 and the second support panel 136. The fourth brace 146 can extend between and/or be coupled to, which can include directly, rigidly, or fixedly connected, middle portions (e.g., equidistantly spaced from the longitudinal sides or edges) of the first support panel 134 and the second support panel 136, which can include inward facing surfaces of the first support panel 134 and the second support panel 136. The fourth brace 146 can be perpendicularly oriented relative to the first support panel 134 and/or the second support panel 136. The fourth brace 146 can be parallel to and offset from first brace 140 and/or second brace 142. The fourth brace 146 can be positioned between the first brace 140 and/or second brace 142. The fourth brace 146 can be positioned equidistantly away from the first brace 140 and/or second brace 142. The fourth brace 146 can be oriented perpendicular relative to the third brace 144.

The third brace 144 can extend between and/or be coupled to, which can include directly, rigidly, or fixedly connected, the first brace 140 and the second brace 142. The third brace 144 can extend between and/or be coupled to, which can include directly, rigidly, or fixedly connected, middle portions (e.g., equidistantly spaced from the longitudinal sides or edges) of the first brace 140 and the second brace 142, which can include inward facing surfaces of the first brace 140 and the second brace 142. The third brace 144 can be perpendicularly oriented relative to the first brace 140, second brace 142, and/or fourth brace 146. The third brace 144 can be parallel to and offset from the first support panel 134 and/or second support panel 136. The third brace 144 can be disposed between the first support panel 134 and/or second support panel 136. The third brace 144 can be equidistantly spaced relative to the first support panel 134 and the second support panel 136. The third brace 144 and fourth brace 146 can include complementary notches, described, herein that can permit the third brace 144 and fourth brace 146 to cross and under each other. In some variants, the third brace 144 and fourth brace 146 can cross over each other under the opening 110.

The fifth brace 150 can extend between and/or be coupled to, which can include directly, rigidly, or fixedly connected, the first support panel 134 and the second support panel 136. The fifth brace 150 can extend between and/or be coupled to, which can include directly, rigidly, or fixedly connected, ends or proximate ends (e.g., longitudinal sides or edges) of the first support panel 134 and the second support panel 136, which can include inward facing surfaces of the firsts support panel 134 and the second support panel 136. The fifth brace 150 can be positioned proximate the main opening 118. The fifth brace 150 can be perpendicularly oriented relative to the first support panel 134 and/or the second support panel 136. The fifth brace 150 can be parallel to and offset from the sixth brace 152. The fifth brace 150 can be disposed under the first brace 140. In some variants, the fifth brace 150 and first brace 150 can be disposed the same distance from the longitudinal edges or sides of the first support panel 134 and the second support panel 136. The fifth brace 150 can include a notch 186 (recess, cutout, gap) disposed on a bottom periphery of the fifth brace 150. The notch 186 can accommodate (e.g., provide space for) bolts extending through one of the apertures 154 to couple the bottom plate 106 to a base. The notch 186 can be central disposed on the fifth brace 150.

The sixth brace 152 can extend between and/or be coupled to, which can include directly, rigidly, or fixedly connected, the first support panel 134 and the second support panel 136. The sixth brace 152 can extend between and/or be coupled to, which can include directly, rigidly, or fixedly connected, ends or proximate ends (e.g., longitudinal sides or edges) of the first support panel 134 and the second support panel 136, which can include inward facing surfaces of the firsts support panel 134 and the second support panel 136. The sixth brace 152 can be positioned proximate sides (e.g., longitudinal sides or edges) of the first support panel 134 and the second support panel 136 that are away from the main opening 118. The sixth brace 152 can be perpendicularly oriented relative to the first support panel 134 and/or the second support panel 136. The sixth brace 152 can be parallel to and offset from fifth brace 150. The fifth brace 150 and sixth brace 152 can be disposed on opposing sides of the opening 111. The sixth brace 152 can include a notch 186 (recess, cutout, gap) disposed on a bottom periphery of the sixth brace 152. The notch 186 can accommodate (e.g., provide space for) bolts extending through one of the apertures 154 to couple the bottom plate 106 to a base. The notch 186 can be central disposed on the sixth brace 152.

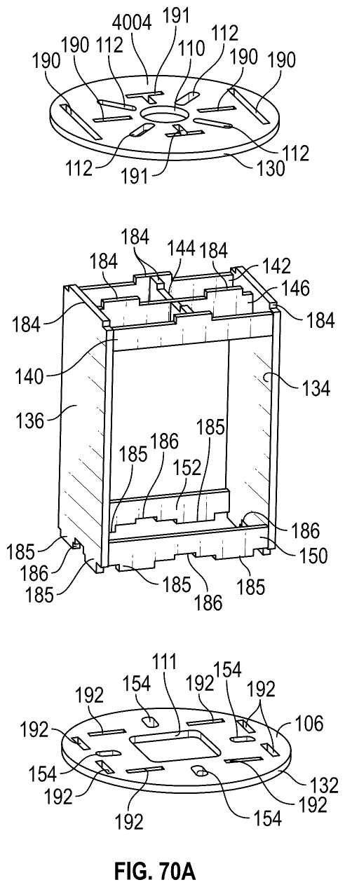

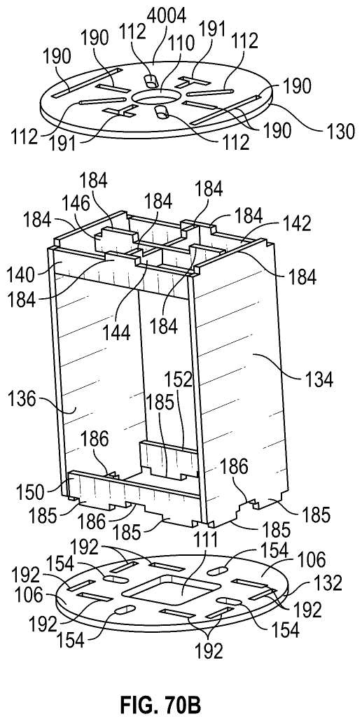

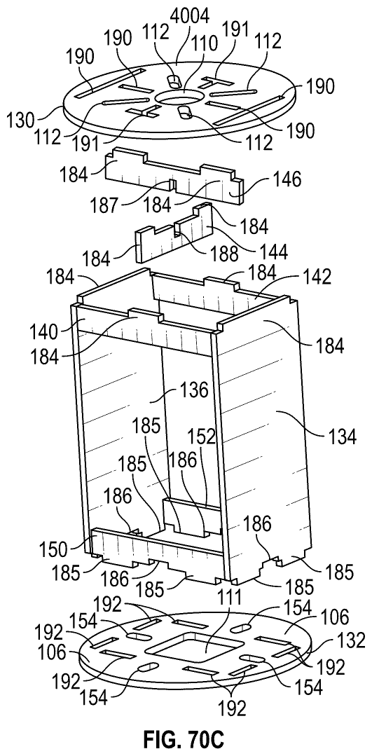

FIGS. 70A and 70B illustrate the frame of the base cabinet 100 with the top plate 4004 and bottom plate 106 removed. The first support panel 134, second support panel 136, first brace 140, second brace 142, third brace 144, and/or fourth brace 146 can include top protrusions 184 (protuberances, rods, beams, keys, members, tabs) that extend from and out of a surface or edge of the first support panel 134, second support panel 136, first brace 140, second brace 142, third brace 144, and/or fourth brace 146 to which the top protrusion 184 are attached or connected to. The first support panel 134, second support panel 136, fifth brace 150, and/or sixth brace 152 can include bottom protrusions 185 (protuberances, rods, beams, keys, members, tabs) that extend from and out of a surface or edge of the first support panel 134, second support panel 136, fifth brace 150, and/or sixth brace 152 to which the bottom protrusions 185 are attached or connected to.

The top protrusions 184 and/or bottom protrusions 185 can be used to orient the first support panel 134, second support panel 136, first brace 140, second brace 142, third brace 144, fourth brace 146, fifth brace 150, and/or sixth brace 152 on or relative to the top plate 4004 and/or bottom plate 106. In some variants, the first support panel 134, second support panel 136, first brace 140, second brace 142, third brace 144, and/or fourth brace 146 can be oriented on or relative to the top plate 4004 and welded in place. In some variants, the first support panel 134, second support panel 136, fifth brace 150, and/or sixth brace 152 can be oriented on or relative to the bottom plate 106 and welded in place. The top protrusions 184 can be inserted into the slots 190 and/or slots 191 of the top plate 4004. The bottom protrusions 185 can be inserted into the bottom slots 192 of the bottom plate 106. In some variants, the insertion of the top protrusions 184 into the slots 190 and/or slots 191 and/or the insertion of the bottom protrusions 185 into the slots 192 can improve the structural integrity and/or rigidity of the base cabinet 100 as well as increase accuracy and precision of manufacture for assembling the various components of the base cabinet 100 discussed herein such that variance and manufacturing tolerances are reduced of the base cabinets. In some variants, the first support panel 134, second support panel 136, first brace 140, second brace 142, third brace 144, fourth brace 146, fifth brace 150, and/or sixth brace 152 do not include top protrusions 184 and/or bottom protrusions 185. In some variants, the top plate 4004 and/or bottom plate 106 can include the protrusions and the first support panel 134, second support panel 136, first brace 140, second brace 142, third brace 144, fourth brace 146, fifth brace 150, and/or sixth brace 152 can include the slots.

The first support panel 134 can include one or more (e.g., one) protrusions 184. The top protrusion 184 can extend from a top periphery of the first support panel 134. The top protrusion 184 can be centrally disposed on the top periphery of the first support panel 134. The top protrusion 184 can be inserted into a corresponding slot 190 of the top plate 4004. The first support panel 134 can include bottom protrusions 185 (e.g., two). The bottom protrusions 185 can extend from a bottom periphery of the first support panel 134. The first support panel 134 can include two bottom protrusions 185, which can be spaced apart from each other (e.g., on opposing sides of the notch 186) and proximate longitudinal sides or edges of the first support panel 134. The bottom protrusions 185 can be inserted into corresponding bottom slots 192 of the bottom plate 106.

The second support panel 136 can include one or more (e.g., one) protrusions 184. The top protrusion 184 can extend from a top periphery of the second support panel 136. The top protrusion 184 can be centrally disposed on the top periphery of the second support panel 136. The top protrusion 184 can be inserted into a corresponding slot 190 of the top plate 4004. The second support panel 136 can include bottom protrusions 185 (e.g., two). The bottom protrusions 185 can extend from a bottom periphery of the second support panel 136. The second support panel 136 can include two bottom protrusions 185, which can be spaced apart from each other (e.g., on opposing sides of the notch 186) and proximate longitudinal sides or edges of the second support panel 136. The bottom protrusions 185 can be inserted into corresponding bottom slots 192 of the bottom plate 106.

The first brace 140 can include one or more (e.g., one) protrusions 184. The top protrusion 184 can extend from a top periphery of the first brace 140. The top protrusion 184 can be centrally disposed on the top periphery of the first brace 140. The top protrusion 184 can be inserted into a portion of the corresponding slot 191 of the top plate 4004.

The second brace 142 can include one or more (e.g., one) protrusions 184. The top protrusion 184 can extend from a top periphery of the second brace 142. The top protrusion 184 can be centrally disposed on the top periphery of the second brace 142. The top protrusion 184 can be inserted into a portion of the corresponding slot 191 of the top plate 4004.

The third brace 144 can include one or more (e.g., two) protrusions 184. The top protrusions 184 can extend from a top periphery of the third brace 144. One of the top protrusions 184 can be disposed at a first end of the third brace 144 and another of the top protrusions 184 can be disposed at a second end of the third brace 144, opposite the first. The top protrusions 184 can inserted into portions of the slots 191 of the top plate 4004. The protrusions 184 of the third brace 144 can be inserted into the portions of the slots 191 with a central axis in a longitudinal length direction that intersects with a central axis of the base cabinet 100.

The fourth brace 146 can include one or more (e.g., two) protrusions 184. The top protrusions 184 can extend from a top periphery of the fourth brace 146. One of the top protrusions 184 can be disposed proximate a first end of the fourth brace 146 and another of the top protrusions 184 can be disposed proximate a second end of the fourth brace 146, opposite the first. The top protrusions 184 can inserted into the corresponding slots 190 of the top plate 4004.

The fifth brace 150 can include one or more (e.g., two) protrusions 185. The bottom protrusions 185 can extend from a bottom periphery of the fifth brace 150. One of the bottom protrusions 185 can be disposed proximate a first end of the fifth brace 150 and another of the bottom protrusions 185 can be disposed proximate a second end of the fifth brace 150, opposite the first. The bottom protrusions 185 can inserted into the corresponding slots 192 of the bottom plate 106. The bottom protrusions 185 can be disposed on opposite sides of the notch 186.

The sixth brace 152 can include one or more (e.g., two) protrusions 185. The bottom protrusions 185 can extend from a bottom periphery of the sixth brace 152. One of the bottom protrusions 185 can be disposed proximate a first end of the sixth brace 152 and another of the bottom protrusions 185 can be disposed proximate a second end of the sixth brace 152, opposite the first. The bottom protrusions 185 can inserted into the corresponding slots 192 of the bottom plate 106. The bottom protrusions 185 can be disposed on opposite sides of the notch 186.

FIG. 70C illustrates the base cabinet 100 with the top plate 4004 and bottom plate 106 removed and the third brace 144 and fourth brace 146 decoupled from each other. The third brace 144 can include a notch 188 (recess, cutout, gap) on an upper periphery (edge) of the third brace 144. The notch 188 can be centrally disposed along the length of the third brace 144. The notch 188 can extend from a top periphery of the third brace 144 to halfway between the top periphery and bottom periphery. The fourth brace 146 can include a notch 187 (recess, cutout, gap) on a lower periphery (edge) of the fourth brace 146. The notch 187 can be centrally disposed along the length of the fourth brace 146. The notch 187 can extend from a bottom periphery of the fourth brace 146 to halfway between the bottom periphery and the top periphery. The notch 187 can be disposed over the notch 188 such that the third brace 144 and fourth brace 146 can cross over and under each other (e.g., intersect). When the notch 187 and notch 188 are joined, coupled, and/or connected, the third brace 144 and fourth brace 146 can be oriented relative to each other in a desired pattern for assembly. For example, the third brace 144 and fourth brace 146 form an x-shape or cross-shape with the notch 187 and notch 188 are joined, coupled, and/or connected to position the third brace 144 and 146 to join, couple, and/or connect to the top plate 4004 (e.g., orient for insertion of protrusions into slots as discussed herein). In some variants, the first brace 150 and sixth brace 152 can have similar notches to orient the first brace 150 and sixth brace 152 (e.g., in an x-shape or cross-shape) to join, couple, and/or connect to the bottom plate 106 (e.g., orient for insertion of protrusions into slots as discussed herein).

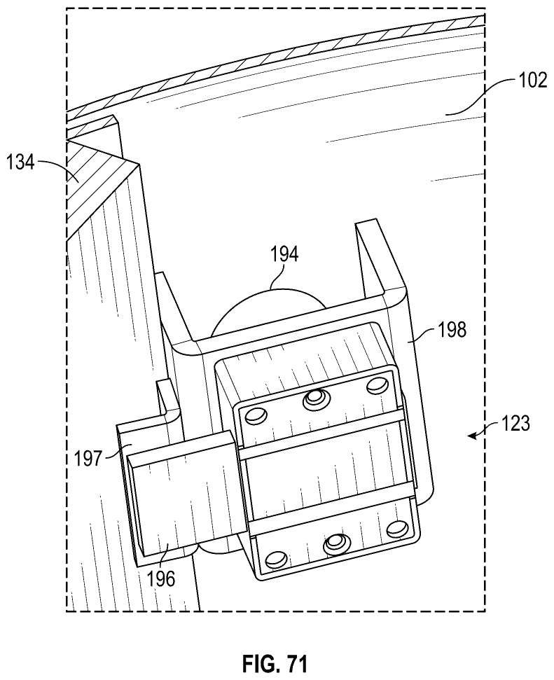

FIG. 71 illustrates the lock 123 (lock mechanism) of the base cabinet 100. The lock 123 can be mounted on a bracket 198 (support) attached to the door 102. The lock 123 can include a tab 196 (flange) that can be extended or retracted to prevent or allow the door 102 to be opened (e.g., swung open) about the hinges 180. FIG. 71 illustrates the lock 123 in a locked configuration with the tab 196 extended to contact a flange 197 (bracket) mounted on an internal structure of the base cabinet 100 (e.g., first support panel 134). In an unlocked configuration, the tab 196 can be retracted to not contact the flange 197, allowing the door 102 to be opened. A key can be inserted through the aperture 194 and engaged with the lock 123 to extend or retract the tab 196.

The base cabinet 100 can be manufactured via a variety of techniques. In some variants, the top plate 4004, bottom plate 106, first support panel 134, second support panel 136, first brace 140, second brace 142, third brace 144, fourth brace 146, fifth brace 150, sixth brace 152, peripheral wall 108, door 102, first frame 164, and/or second frame 165 can be cut from one or more panels or sheets of material. The peripheral wall 108, first frame 164, second frame 165, door 102, can be rolled and/or bent to have a curved periphery. The support structure 160 of the first frame 164 and the support structure 161 of the second frame 165 can be removed. The notch 187 of the fourth brace 146 can be disposed in and over the notch 188 in the third brace 144. The first support panel 134, second support panel 136, first brace 140, second brace 142, third brace 144, and/or fourth brace 146 can be connected to the top plate 4004. In some variants, the first support panel 134, second support panel 136, first brace 140, second brace 142, third brace 144, and/or fourth brace 146 can include top protrusions 184 that can be slid into top slots 190 and/or slots 191 of the top plate 4004 to properly orient the first support panel 134, second support panel 136, first brace 140, second brace 142, third brace 144, fourth brace 146, and/or top plate 4004 to each other. In some variants, the first support panel 134, second support panel 136, first brace 140, second brace 142, third brace 144, and/or fourth brace 146 do not include top protrusions 184. The first support panel 134, second support panel 136, fifth brace 150, and/or sixth brace 152 can be connected to the bottom plate 106. In some variants, the first support panel 134, second support panel 136, fifth brace 150, and/or sixth brace 152 can include bottom protrusions 185 that can be slid into bottom slots 192 of the bottom plate 106 to properly orient the first support panel 134, second support panel 136, fifth brace 150, sixth brace 152, and/or bottom plate 106 to each other. In some variants, the first support panel 134, second support panel 136, fifth brace 150, and/or sixth brace 152 do not include bottom protrusions 185. The top plate 4004, bottom plate 106, first support panel 134, second support panel 136, first brace 140, second brace 142, third brace 144, fourth brace 146, fifth brace 150, and sixth brace 152 can be configured relative to each other as described herein and welded in place. The first frame 164 and the second frame 165 can be coupled to the peripheral wall 108 around the periphery of the main opening 118 as described herein such that a portion of the second frame 165 extends into the main opening 118, which can receive a gasket, seal, etc. thereon. In some variants, the first frame 164 and the second frame 165 can be coupled to the peripheral wall 108 with one or more screws or bolts. The flange 197 can be secured (e.g., welded), adhered, and/or otherwise coupled to the first support panel 134 to facilitate engagement with the tab 196 of the lock 123. The peripheral wall 108 can be wrapped around and welded to the periphery 130 of the top plate 4004 and periphery 132 of the bottom plate 106. The hinges 180 can be coupled (e.g., welded, bolted, screwed, adhered, etc.) to the peripheral wall 108 proximate the main opening 118. The hinges 180 can be coupled (e.g., welded, bolted, screwed, adhered, etc.) to the door 102 to facilitate the door 102 being swung open and closed to cover the main opening 118. The bracket 198 with the lock 123 can be coupled (e.g., welded, bolted, screwed, adhered, etc.) to the door 102 such that the lock 123 is accessible through the aperture 194 in the door 102. The housing 5000 can be mounted onto the base cabinet 100 and an EV charger 5012 can be mounted onto a face of the housing 5000.

The thickness and/or material of the varying components of the base cabinet 4000, base cabinet 100, and/or housing 5000 can vary depending on the desired structural integrity. For example, materials such as metals (such as steel, high strength steel, aluminum, and/or others), metal alloys, polymers (such as plastic), ceramics, and/or others can be used. For example, each of the plurality of support panels and/or bottom panel of the housing can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The braces can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The peripheral wall can have a thickness of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. The top plate and/or bottom plate can have thicknesses of less than 1/16, 1/16-¼, ¼-½, ½-¾, ¾-1, 1-1¼, 1¼-1½, 1½-1¾, 1¾-2, 2-2¼, 2¼-2½, 2½-2¾, 2¾-3, 3-3¼, 3¼-3½, 3½-3¾, 3¾-4, and/or greater than 4 inches. Relatedly, the components listed above can have varying widths, heights, and/or lengths to provide a desired size. For example, the base cabinet 4000 can have an overall diameter or width of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches and/or height or length of less than 6, 6-12, 12-18, 18-24, 24-30, 30-36, 36-42, 42-48, 48-54, 54-60, 60-66, 66-72, 72-78, 78-84, 84-90, 90-96, or greater than 96 inches. These are example ranges, such that other dimensions can be employed that are not explicitly listed herein.

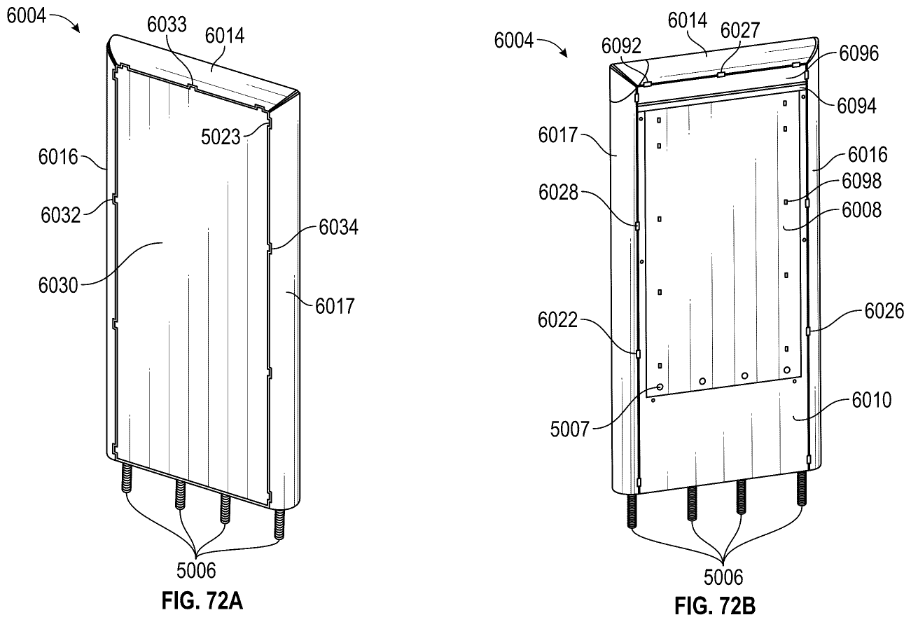

FIGS. 72A-79 illustrate various views of a housing 6004, which can also be referred to as an EV charging housing, stand, EV charging stand, support structure, frame, mount, and/or EV charging mount. The housing 6004 can include any of the features of the housing 5004 described herein. The housing 6004 can be the same as or similar to the housing 5004 but different as described and/or illustrated. The housing 6004 can be mounted on a base cabinet as described herein in reference to housing 5004, which can include by way of bolts 5006. The housing 6004 can have one or more EV chargers mounted on a face thereof. The housing 6004 can be a variety of shapes and/or sizes as described in reference to housing 5004. The housing 6004 can house one or more items therein as described in reference to housing 5004.

As shown in FIGS. 72A and 72B, The housing 6004 can include a top panel 6014 which can be the same as or similar to top panel 5014. The top panel 6014 can include notches 6033 and/or notches 6027, which can be the same as or similar to notches 5033 and/or notches 5027. The housing 6004 can include a first side panel 6016, which can be the same as or similar to first side panel 5016. The first side panel 6016 can include notches 6032 and/or notches 6026, which can be the same as or similar to notches 5032 and/or notches 5026. The housing 6004 can include a second side panel 6017, which can be the same as or similar to second side panel 5017. The second side panel 6017 can include notches 6034 and/or notches 6028, which can be the same as or similar to notches 5034 and/or notches 5028. The housing 6004 can include a first panel 6030 (front panel, rear panel) which can be the same as or similar to the panel 5030. The first panel 6030 can include tabs 5023, which can be the same as or similar to the tabs 5034. An EV charger 5012 can be mounted on the first panel 6030. The housing 6004 can include a second panel 6010, which can be similar to the panel 5010 but different as described herein. The second panel 6010 can include tabs 6022, which can be the same as or similar to the tabs 5022. The housing 5004 can include a removable panel 6008, which can be the same as or similar to the panel 5008. The panel 6008 can be removed to allow access into a cavity of the housing 5004. The removable panel 6008 can include one or more apertures 6098 into which ribs or struts can be mounted to provide rigidity to the removable panel 6008.

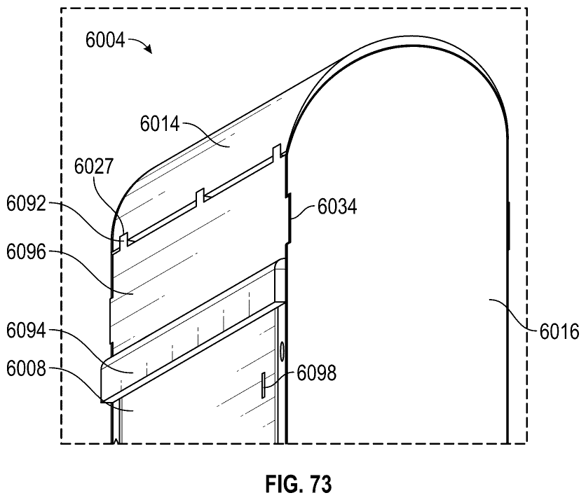

The housing 6004 can include a upper panel 6096. The upper panel 6096 can include tabs 6092 that can be inserted into notches 6027. The upper panel 6096 can include a lip 6094 (overhang) that can cover a portion of the removable panel 6008 when assembled to the housing 6004, as shown in FIG. 73. The removable panel 6008 can be coupled to a frame within the housing by one or more screws 5007. The frame can extend around a periphery of an opening providing access into the cavity. The tabs and notches described in reference to housing 6004 can be used as described in reference to housing 5004. The housing 6004 can be manufactured as described in reference to housing 5004 with differences described herein. In some variants, tabs can be disposed on the top panel 6014, first side panel 6016, and/or second side panel 6017 and notches can be disposed in the panel 6010 and panel 6030.

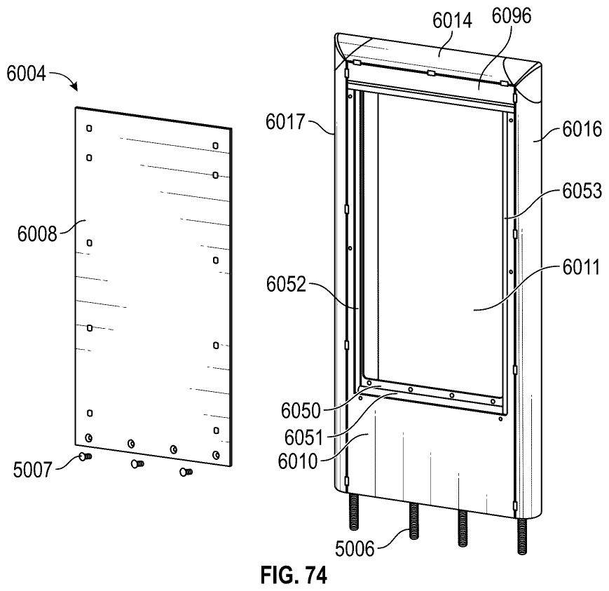

FIG. 74 illustrates the housing 6004 with the removable panel 6008 removed. The housing 6004 can include an opening 6011 providing access into an interior cavity of the housing 6004. A frame 6050 (support structure, gasket support, removable panel support) can be disposed around a portion of the second panel 6010 extending around the opening 6011 such that the frame 6050 extends into the opening 6010. One or more gaskets (e.g., a first gasket 6051, second gasket 6052, and/or third gasket 6053) can be disposed on the portion of the frame 6050 extending into the opening 6011 such that the removable panel 6008, when placed over the opening 6011, contacts the one or more gaskets, which can help to prevent particulate from entering the housing 6004. The lip 6094 of the upper panel 6096 can cover a top portion of the panel 6008 to prevent particulate form entering the cavity. The one or more gaskets can be adhered to the frame 6050. The panel 6008 can be removed by removing the bolts 5007 and sliding the panel 6008 downward and out from under the lip 6094 of the upper panel 6096. The panel 6008 can be installed by sliding the panel 6008 under the lip 6094 of the upper panel 6096 and bolting the bottom portion of the panel 6008 to the frame 6050, which may compress the gaskets.

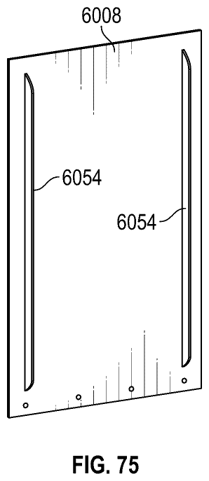

FIG. 75 illustrates a rear (interior facing) surface of the removable panel 6008. The panel 6008 may include one or more (e.g., two) ribs, struts, or the like 6054 that can increase the rigidity of the panel 6008. The ribs 6054 can be connected to the panel 6008 and extend in a parallel pattern or a crosshatch pattern for example.

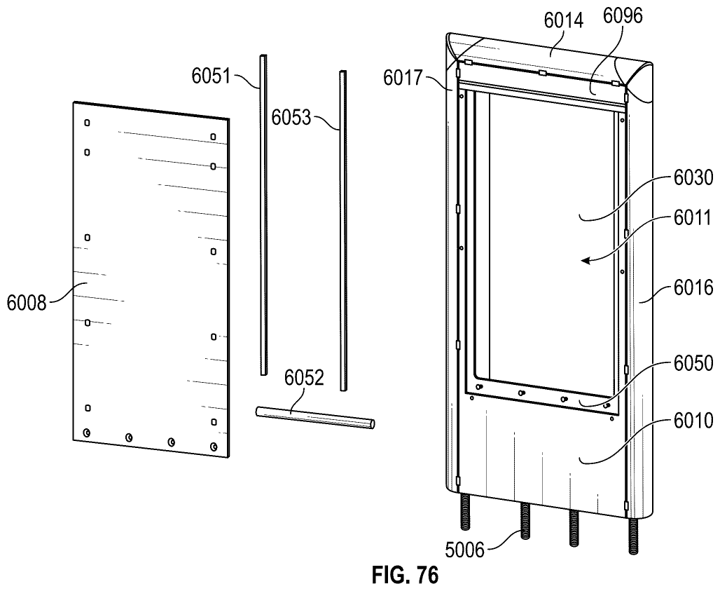

FIG. 76 illustrates the housing 6004 with the one or more gaskets removed, exposing the portion of the frame 6050 extending into the opening 6011 of the housing 5004.

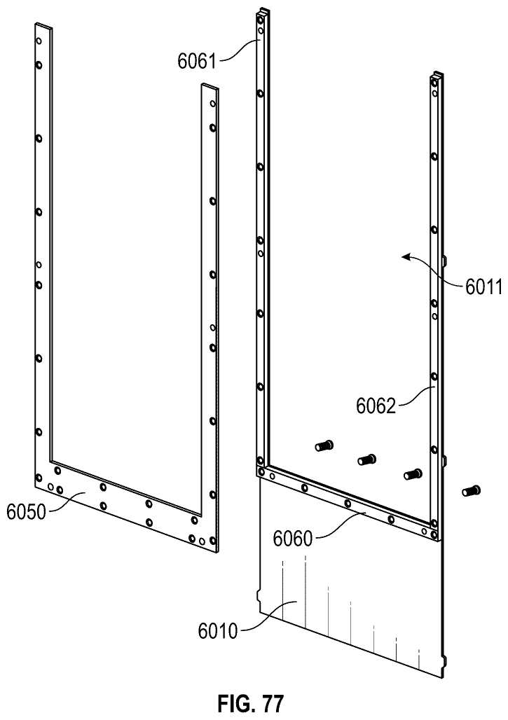

FIG. 77 illustrates an interior facing surface (rear) of the second panel 6010 (rear panel) with the frame 6050 decoupled therefrom. One or more spacers (e.g., a first spacer 6060, second spacer 6061, and/or third spacer 6062) can be disposed around the portion of the second panel 6010 defining the opening 6011. The plurality of spacers can space the frame 6050 away from the inward facing surface of the second panel 6010 to provide space for the gaskets on the frame 6050 such that an outer surface of the panel 6008 can be substantially flush with the outer surface of the second panel 6010 when the panel 6008 is covering the opening 6011.

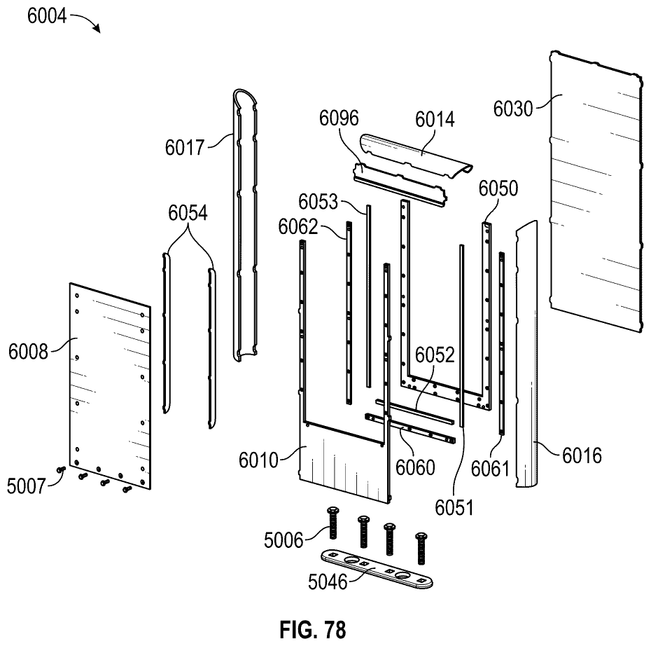

FIG. 78 illustrates an exploded view of the housing 6004. The housing 6004 can include the bottom plate 5046 as described herein. The first panel 6030, second panel 6010, first side panel 6016, and/or second side panel 6017 can extend around the periphery of the bottom plate 5046 as described in reference to housing 5004.

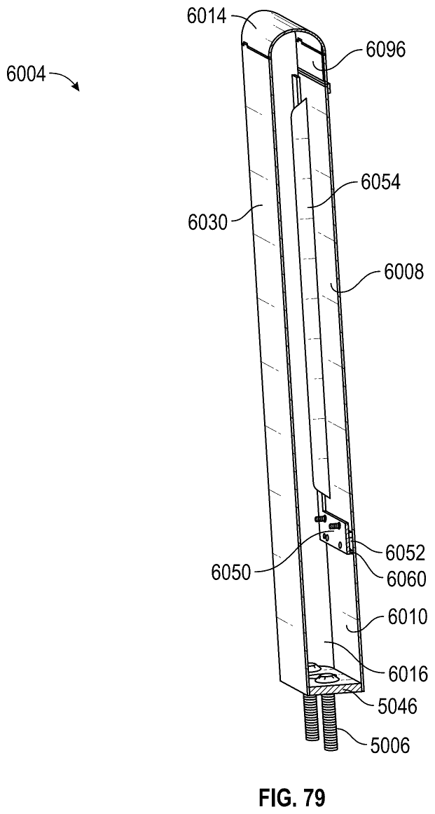

FIG. 79 illustrates a sectioned view of the housing 6004 with the panel 6008 coupled to the frame 6050 to cover the opening 6011 into the cavity of the housing 6004. The gaskets are disposed between the frame 6050 and the panel 6008 (e.g., door). The spacers are disposed between the frame 6050 and the second panel 6010.

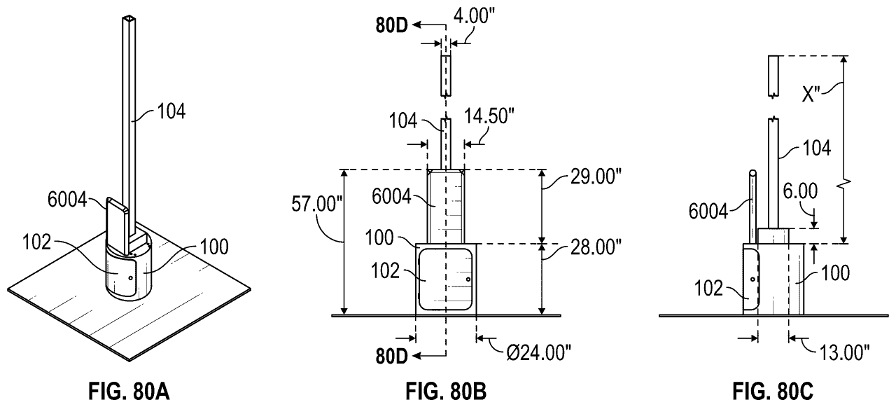

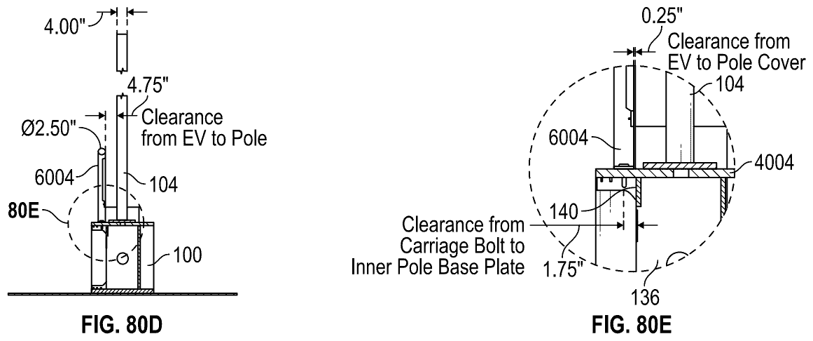

FIGS. 80A-80E illustrate various views with example dimensions of the housing 6004, base cabinet 100, and/or pole 104, which should not be considered limiting.

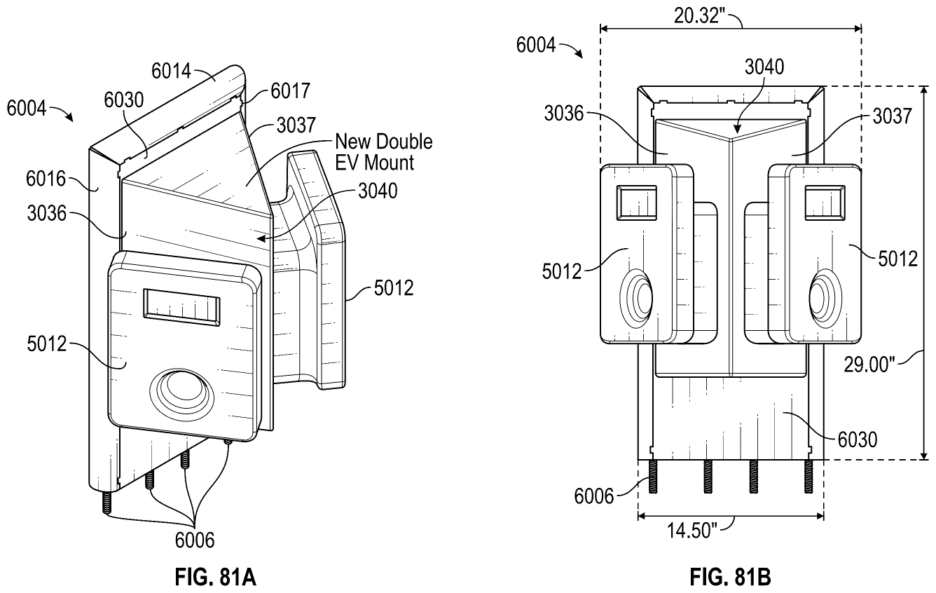

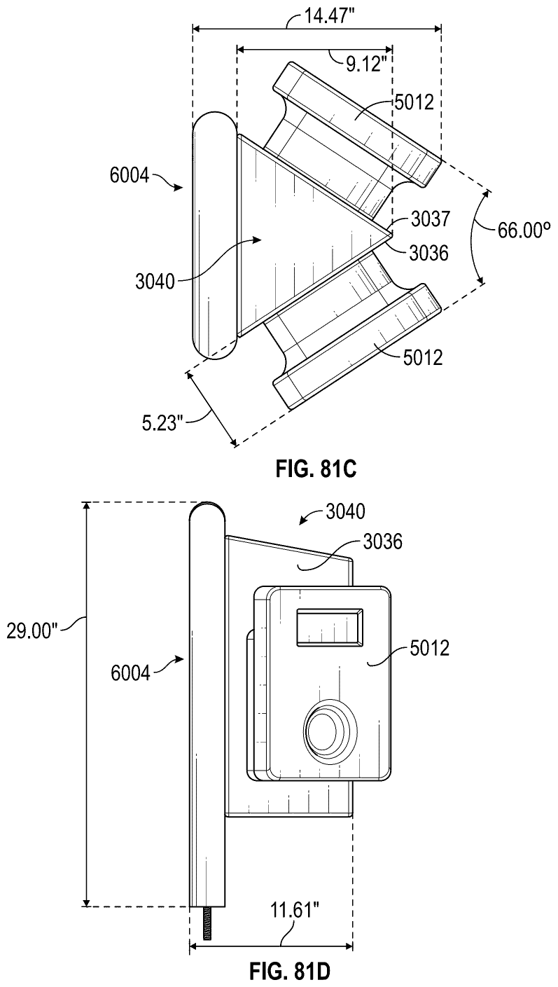

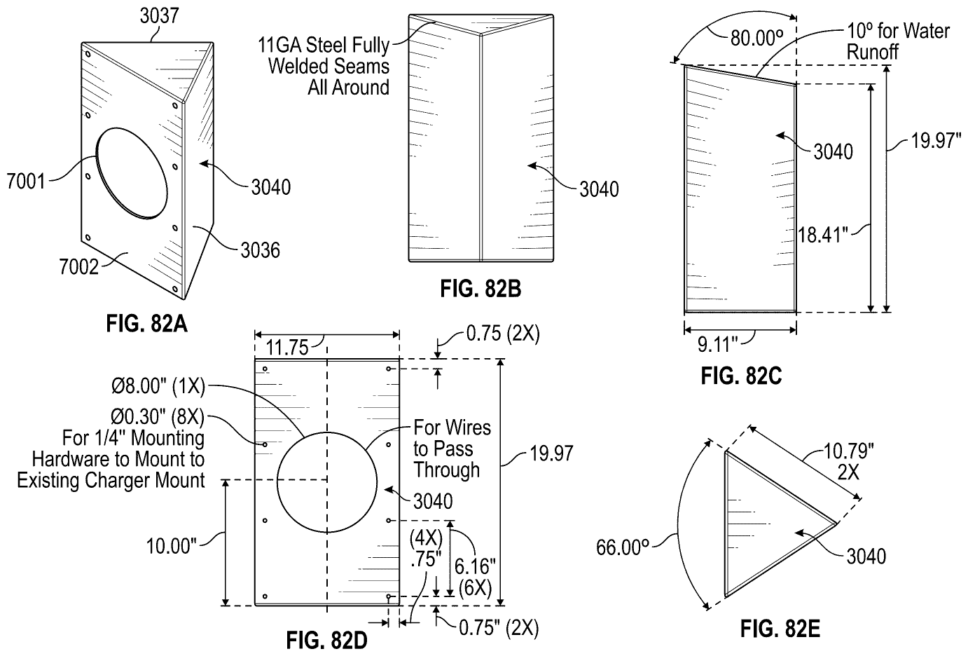

FIGS. 81A-82E illustrate some example dimensions for the mount 3040, housing 6004, and EV chargers 5012 described herein, which should not be considered limiting. Similar to bolts 5006, one or more bolts 6006 (fasteners, screws) can be used to couple the housing 6004 to a base cabinet, which can include four bolts. The one or more bolts 6006 can extend from a bottom of the housing 6004. The mount 3040 can have a first angled surface 3036 and a second angled surface 3036 upon each of which one or more EV chargers 3012 can be disposed. The mount 3040 can be mounted on a surface of the housing 6004, which can include a forward facing surface and/or a rear facing surface. The mount 3040 can be mounted on the panel 6030 or the panel 6008. In some variants, more than one (e.g., two, three) mounts 3040 can be disposed on a housing 6004. As shown in FIG. 82A, the mount 3040 can have a surface 7002 that mounts to a surface (panel) of the housing 6004 (e.g., first panel 6030). The surface 7002 can include an opening 7001, which can be a variety of shapes, through which cables, wires, and the like can be routed to connect with the EV chargers 5012. Cables or the like can be routed from a base cabinet, through the housing 6004, through the mount 3040, and to the EV chargers 5012. A top surface of the mount 3040 can be angled downward (e.g., 80 degrees relative to an axis extending through the longitudinal junction between the first angled surface 3036 and the second angled surface 3036, 10 degrees downward from a top edge of the surface 7002, etc.) which can help water flow off the top surface. The top surface can slope downward from a top edge of the surface 7002. The top surface can be triangle shaped. The bottom surface can be triangle shaped.

The base cabinets, housing, brackets, and/or components thereof can be made of a variety of materials such metals (such as steel, aluminum, and/or others), metal alloys, polymers (such as plastic), ceramics, and/or other suitable materials. The base cabinets and/or housings can be galvanized, pained, zinc coated, powder coated, vinyl coated, plastic dripped, or finished with other materials or methods.

Although the systems and methods have been disclosed in the context of certain embodiments and examples, it will be understood by those skilled in the art that the systems and methods extend beyond the specifically disclosed embodiments to other alternative embodiments and/or uses of the embodiments and certain modifications and equivalents thereof. Various features and aspects of the disclosed embodiments can be combined with or substituted for one another in order to form varying modes of the conveyor. The scope of this disclosure should not be limited by the particular disclosed embodiments described herein.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Some embodiments have been described in connection with the accompanying drawings. Components can be added, removed, and/or rearranged. Orientation references such as, for example, “top” and “bottom” are for ease of discussion and may be rearranged such that top features are proximate the bottom and bottom features are proximate the top. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

In summary, various embodiments and examples of juicing devices and methods have been disclosed. Although the systems and methods have been disclosed in the context of those embodiments and examples, it will be understood by those skilled in the art that this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow.

What is claimed is:

1. A housing configured to be coupled to a pole base cabinet, the housing comprising:
a first end configured to be coupled to a pole base cabinet, the first end comprising an opening configured to receive one or more cables therethrough;
a second end that is closed;
a wall extending between the first and the second ends and enclosing a cavity, the cavity being accessible by way of the opening;
one or more vertical supports disposed in the cavity; and
a mounting area whereon an EV charger is configured to be mounted.

2. The housing of claim 1, further comprising a front surface having a first angled surface and a second angled surface, wherein the mounting area is disposed on the first angled surface and another mounting area for a second EV charger is disposed on the second angled surface.

3. The housing of claim 1, further comprising a front surface and a protrusion extending away from the front surface, the protrusion having a first angled surface and a second angled surface, wherein the mounting area is disposed on the first angled surface and another mounting area for a second EV charger is disposed on the second angled surface.

4. The housing of claim 3, wherein a top surface of the protrusion is angled downward to facilitate water runoff.

5. The housing of claim 1, wherein the housing is elongate.

6. The housing of claim 1, wherein the housing comprises opposing front and back surfaces that are parallel to each other and rounded sides extend between the front and back surfaces.

7. The housing of claim 1, wherein the second end is rounded.

8. A pole base cabinet system, the system comprising:
a pole base cabinet having a cavity and a power connection disposed within the cavity;
a housing comprising an interior cavity, a first end configured to be coupled to the pole base cabinet, and a second end, the first end comprising an opening providing access into the interior cavity;
an electric vehicle (EV) charger, the EV charger configured to be mounted to the housing; and
one or more cables routed from the power connection within the cavity of the pole base cabinet, through the opening in the first end of the housing and into the interior cavity therein, and to the EV charger to supply power.

9. The system of claim 8, wherein the housing is elongate.

10. The system of claim 8, wherein the housing comprises opposing front and back surfaces that are parallel to each other and rounded sides extending between the front and back surfaces.

11. The system of claim 8, wherein the second end is rounded.

12. The system of claim 8, wherein the housing comprises one or more vertical supports therein.

13. The system of claim 8, wherein the housing is coupled to the pole base cabinet by way of bolts or screws inserted from within the cavity and through a top surface of the pole base cabinet and the first end.

14. The system of claim 8, wherein the housing comprises a front face having two angled surfaces, and wherein the EV charger is mounted on one of the two angled surfaces and another EV charger is mounted on the other of the two angled surfaces.

15. The system of claim 8, wherein the housing comprises a protrusion extending from a front face, the protrusion having two angled surfaces, and wherein the EV charger is mounted on one of the two angled surfaces and another EV charger is mounted on the other of the two angled surfaces.

16. The system of claim 8, wherein the housing comprises a mounting bracket that is configured to facilitate coupling to the pole base cabinet, the mounting bracket comprising an opening therethrough and two opposing vertical plates, wherein the housing is configured to be disposed over the opposing vertical plates and secured thereto, and wherein the one or more cables are configured to be routed through the opening of the mounting bracket.

17. A housing configured to be coupled to a pole base cabinet, the housing comprising:
a first end configured to be coupled to a pole base cabinet, the first end comprising an opening;
a second end opposite the first end that is closed;
a wall extending between the first and the seconds ends and comprising a front face, the wall surrounding a cavity, the cavity being accessible by way of the opening; and
a protrusion disposed on the front face, the protrusion comprising two angled surfaces for EV chargers.

18. The housing of claim 17, wherein the protrusion comprises a top surface that is sloped downward.

19. The housing of claim 17, wherein the protrusion comprises a bottom surface that is positioned higher than the first end.

20. The housing of claim 17, wherein the second end is rounded.
